(19) United States
(12) Patent Application Publication
(10) Pub. No.: US 2011/0054229 A1
(43) Pub. Date: Mar. 3, 2011

(54) LUMINESCENT COMPOUNDS AND ELECTROLUMINESCENT DEVICE USING THE SAME

(75) Inventors: Il-Won Choi, Seoul (KR); Chi-Sik Kim, Seoul (KR); Hyuk-Joo Kwon, Seoul (KR); Young-Jun Kwon, Seoul (KR); Bong-Ok Kim, Seoul (KR); Sung-Min Kim, Seoul (KR); Seung Soo Yoon, Seoul (KR)

(73) Assignee: GRACEL DISPLAY INC., SEOUL (KR)

(21) Appl. No.: 12/743,198

(22) PCT Filed: Nov. 23, 2007
(86) PCT No.: PCT/KR07/05944

§ 371 Date: Nov. 8, 2010

(51) Int. Cl. C07C 13/567

(52) U.S. Cl. 585/27

(57) ABSTRACT

The present invention relates to organic electroluminescent compounds and organic electroluminescent devices employing the same. More specifically, the invention relates to organic electroluminescent compounds containing an anthracenyl group or an aryl group having an anthracenyl substituent m the aryl ring of fluorene or indenofluorene, as a blue electroluminescent material in an organic electroluminescent layer. The electroluminescent compounds according to the invention exhibit high luminous efficiency and excellent life property, so that an OLED device having very good operation lifetime can be prepared therefrom.

### TECHNICAL FIELD

The present invention relates to organic electroluminescent (EL) compounds and organic electroluminescent devices using the same, more particularly to organic EL compounds containing fluorenyl group and anthracenyl group as blue electroluminescent material of an organic EL layer, and organic EL devices comprising the same.

### BACKGROUND ART

Eastman Kodak firstly developed an organic EL device employing low molecular aromatic diamine and aluminum complex as a substance for forming an electroluminescent layer, in 1987 [Appl. Phys. Lett. 51, 913, 1987].

In the meanwhile, as a blue EL material, diphenylanthracene, tetraphenylbutadiene, distyrylbenzene derivatives and the like have been developed, but the compounds have been known to have low stability of thin film so that they tend to be readily crystallized. Diphenyldistyryl type blue electroluminescent materials having improved stability of thin film wherein the phenyl group of side chain inhibits crystallization have been developed by Idemitsu [H. Tokailin, H. Higashi, C. Hosokawa, EP 388,768 (1990)].

Distyrylanthracene derivatives having improved stability of thin film due to electron withdrawers and electron donors have been developed by Kyushu University [Pro. SPIE, 1910, 180 (1993)].

In addition, arylethylene derivatives such as DPVBi and DPVDPAN, as disclosed in EP 1063869 (Idemitsu Kosan Company Limited), Korean Patent Laid-Open No. 2000-0048006 (Eastman Kodak Company, USA) and Japanese Patent Laid-Open 1996-333569, have been widely used as blue EL materials.

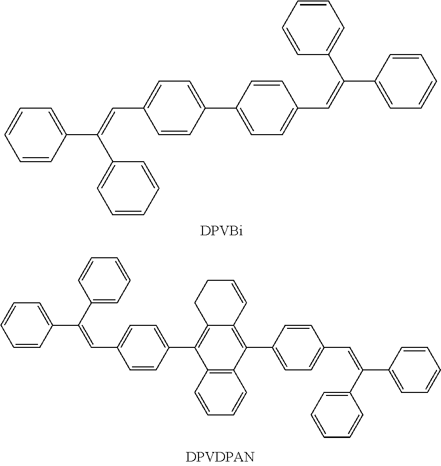

Since DPVBi involves problem of thermal stability having low glass transition temperature of 100° C. or lower, DPVDPAN of the chemical formula wherein anthracene is incorporated inside the biphenyl of said DPVBi has improved thermal stability by raising the glass transition temperature to 105° C.

However, DPVDPAN with enhanced thermal stability showed the color coordinate (x,y) (demonstrating color purity) of (0.166, 0.176), which is similar to that of DPVBi. Since the smaller the y value of color coordinate is, the closer the color is to pure blue, the y value (0.176) is insufficient as a blue EL material. In general, a number of OLED panels require not more than 0.15 of y value as the standard of pure blue color, and it is preferable that the luminous efficiency and life time are maintained at this level.

Particularly, as the color purity becomes closer to pure blue, it is common phenomenon occurred that the lifetime of the device is abruptly reduced. Thus, maintaining the lifetime of the device while improving the color purity is a very significant issue to realize an OLED with high performance.

In the meanwhile, U.S. Pat. No. 6,479,172 claims fluorene EL compounds wherein 9-position of fluorene is substituted by aryl group, and R represents hydrogen, alkyl, alicyclic alkyl, halogen or cyano group.

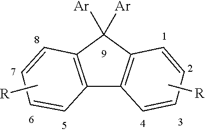

As a specific compound, U.S. Pat. No. 6,479,172 discloses 9,9-[bis(4-(9-anthryl)phenyl)fluorene (BAPF) and 9,9-bis[4-(10-phenyl-9-anthryl)phenyl]fluorene (BPAPF), and the brightness of the disclosed compounds at 25 mA/cm² was approximately from 350 to 414 cd/m², so that they are limited to practical use.

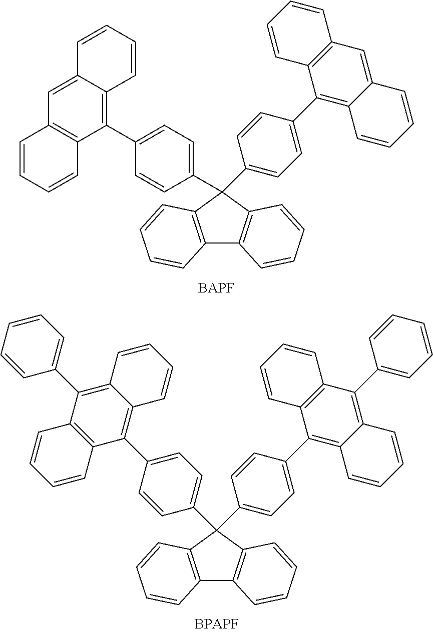

The inventors surprisingly confirmed that an EL compound with improved luminous efficiency and luminescent color, which can provide a device with enhanced stability, as compared to conventional fluorene EL compounds (including those disclosed by U.S. Pat. No. 6,479,172) can be obtained, if an alkyl group is incorporated to 9-position of fluorene; 4-(9-anthryl)phenyl or 4-(9-anthryl)naphthyl is incorporated to 2-position carbon of fluorene; and 9-anthryl, 4-(9-anthryl)phenyl or 4-(9-anthryl)naphthyl group is incorporated to 7-position carbon of fluorene. Further, the inventors confirmed that an EL compound wherein an aryl group, instead of alkyl group, is substituted at 9-position of fluorene exhibits prominently improved luminous efficiency and luminescent color, as compared to the compound disclosed by U.S. Pat. No. 6,479,172, and that the compound can provide a device with noticeably enhanced stability, and completed the invention. The fact that an organic EL compound with noticeably enhanced luminous properties and device stability can be obtained by incorporating 4-(9-anthryl)phenyl or 4-(9-anthryl)naphthyl group at 2-position carbon of fluorene, and 9-anthryl, 4-(9-anthryl)phenyl or 4-(9-anthryl)naphthyl group at 7-position carbon has not been recognized by conventional arts including U.S. Pat. No. 6,479,172.

### DISCLOSURE

### Technical Problem

The object of the invention is to provide the problems described above, and to provide a blue organic EL device with improved luminous efficiency and luminescent color, and enhanced stability, as compared to that from conventional EL compounds. Another object of the invention is to provide blue organic EL compounds implying significance of selection, with prominently enhanced luminous properties and device stability as compared to conventional fluorene compounds.

Still another object of the invention is to provide organic EL devices comprising the blue organic EL compounds according to the present invention.

### Technical Solution

The present invention provides blue organic EL compounds with noticeably enhanced EL properties and device stability by incorporating a 4-(9-anthryl)phenyl or 4-(9-anthryl)naphthyl derivative at 2-position of carbon in fluorene; and a 9-anthryl, 4-(9-anthryl)phenyl or 4-(9-anthryl)naphthyl derivative at 7-position of carbon; and organic EL devices comprising the blue organic EL compounds according to the invention.

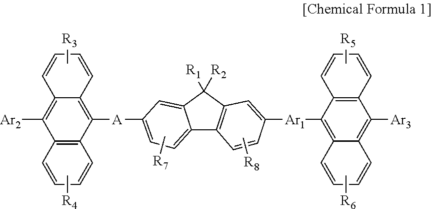

In Chemical Formula (1), Ar₁ represents phenylene or naphthylene, Ar₂ and Ar₃ independently represent an aryl group;

A represents a chemical bond or arylene; R₁ and R₂ independently represent hydrogen, C₁₋₂₀ alkyl, or an aryl; or R₁ and R₂ may form a spiro-ring by being connected as C₄₋₆ alkylene or C₄₋₆ alkylene having an aryl group fused; R₃ through R₈ independently represent hydrogen, C₁₋₂₀ alkyl, C₁₋₂₀ alkoxy, aryl, halogen, C₁₋₂₀ alkylsilyl or dicyanoethylene group; and said Ar₁ through Ar₃, A, R₁ through R₈ may be further substituted by one or more group selected from C₁₋₂₀ alkyl, aryl and halogen.

If Ar₁ of Chemical Formula (1) is phenylene, 1,4-phenylene is preferable, while if it is naphthylene, 1,4-naphthylene or 1,5-naphthylene is preferable. In Chemical Formula (1), A preferably is a chemical bond, or 1,4-phenylene, 1,4-naphthylene or 1,5-naphthylene.

It is preferable that Ar₂ and Ar₃ independently represent phenyl, 2-, 3- or 4-tolyl, 2-, 3- or 4-ethylphenyl, 2-, 3- or 4-(i-propyl)phenyl, 2-, 3- or 4-(1-naphthyl)phenyl, 2-, 3- or 4-phenylphenyl, 2-, 3- or 4-(4-tolyl)phenyl, 2-, 3- or 4-(3-tolyl)phenyl, 2-, 3- or 4-(2-tolyl)phenyl, 2-, 3- or 4-(1-naphthyl)phenyl, 2-, 3- or 4-(2-naphthyl)phenyl, 1- or 2-naphthyl, 1- or 2-(methylnaphthyl), 1- or 2-(ethylnaphthyl), 1- or 2-(phenylnaphthyl).

It is preferable that R₁ and R₂ independently represent hydrogen, or an alkyl group such as methyl, ethyl, i-propyl and t-butyl, or R₁ and R₂ independently represent phenyl, 2-, 3- or 4-tolyl, or 1- or 2-naphthyl.

The organic EL compounds according to the present invention include those represented by one of the following Chemical Formulas:

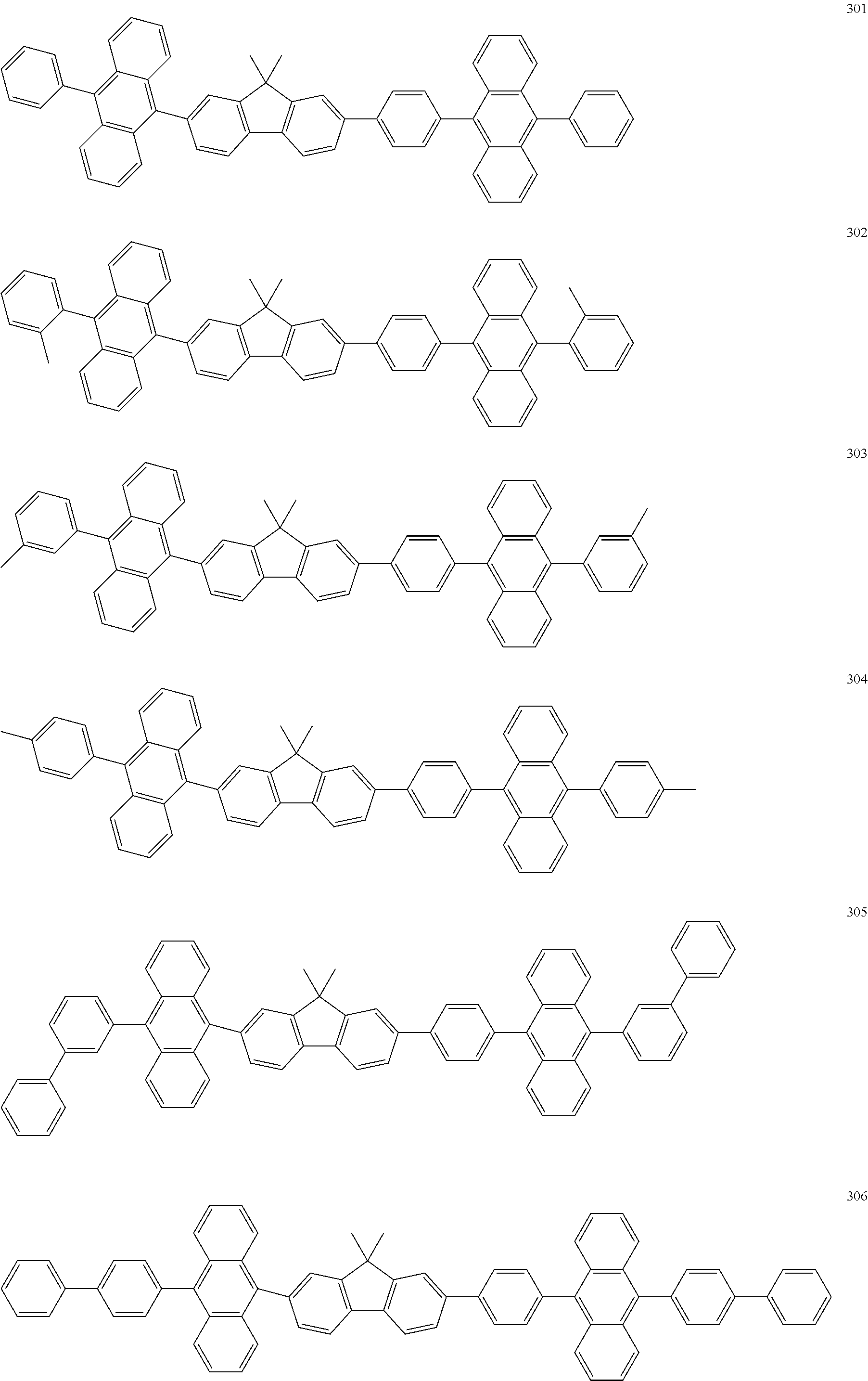

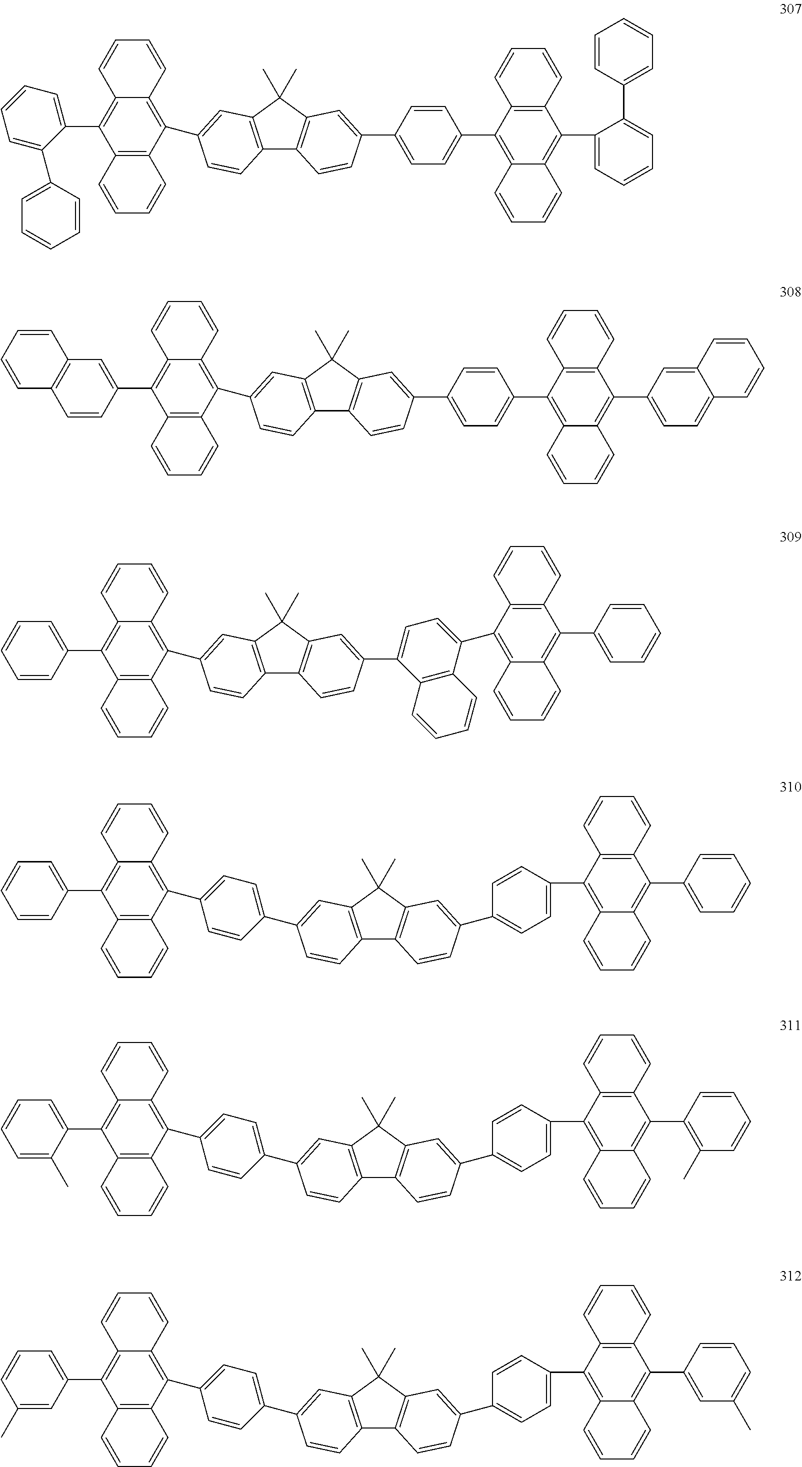

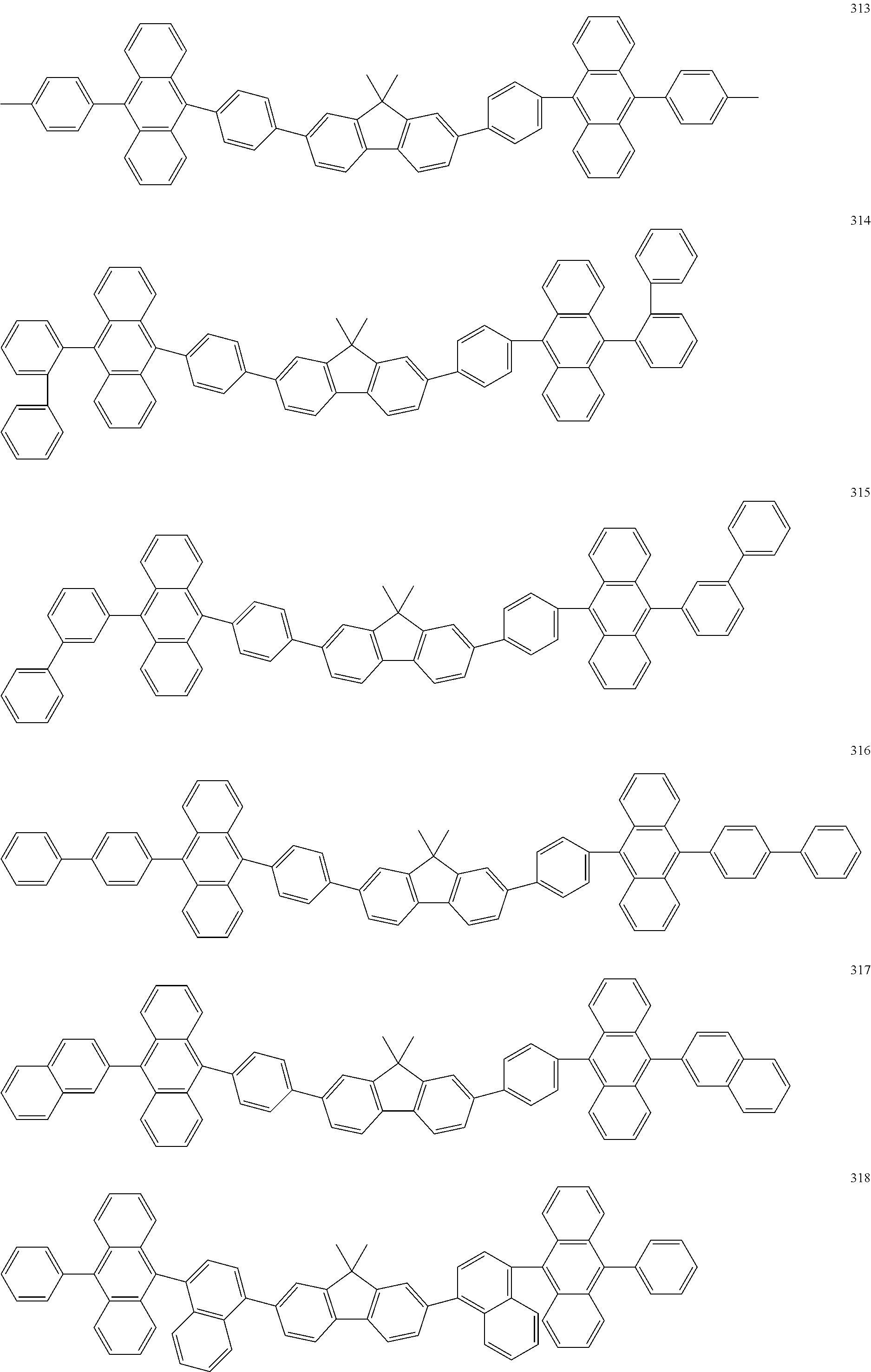

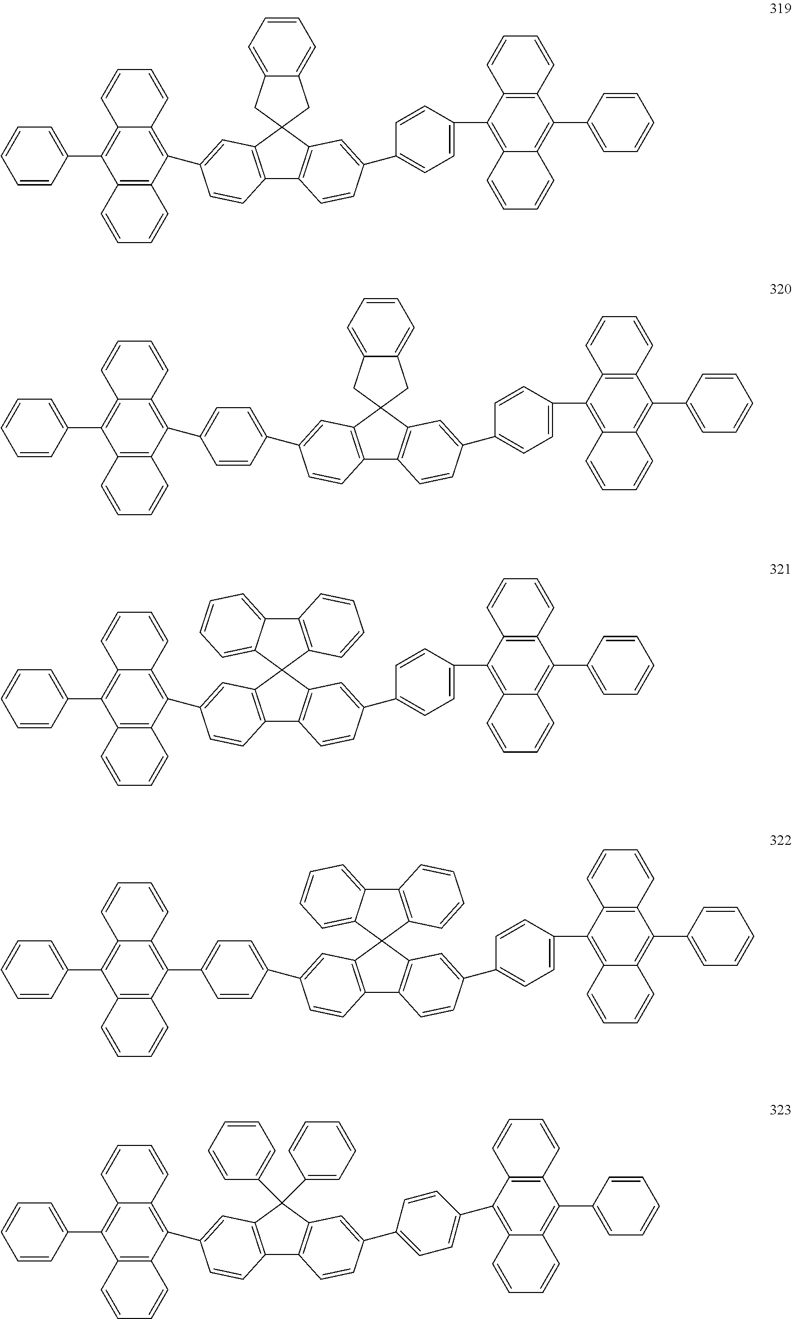

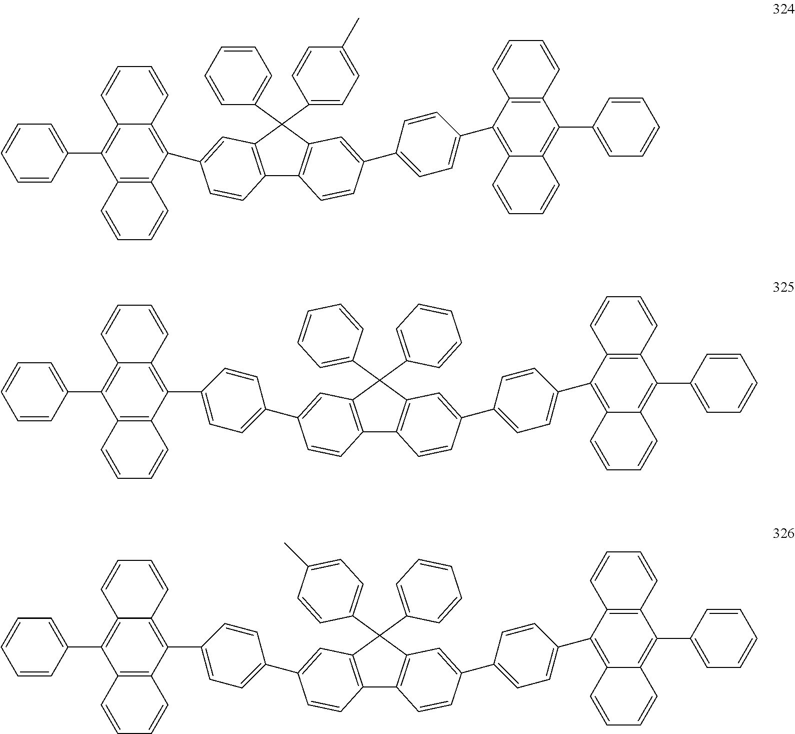

The organic EL compound represented by Chemical Formula (1) according to the invention can be prepared by a process shown in Reaction Scheme (1). A fluorene compound (7) having a halogen substituent is converted to a dioxyborane compound (5), which was then reacted with an anthracene compound having a halogen substituent to obtain Compound (4). Compound (4) was converted to dioxyborane compound (3), which was then reacted with another anthracene compound having a halogen substituent to provide an organic EL compound represented by Chemical Formula (1). The process shown in Reaction Scheme (1) illustrates one exemplary process, while the dioxyborane compound (3) may be first prepared with the order of reaction being altered.

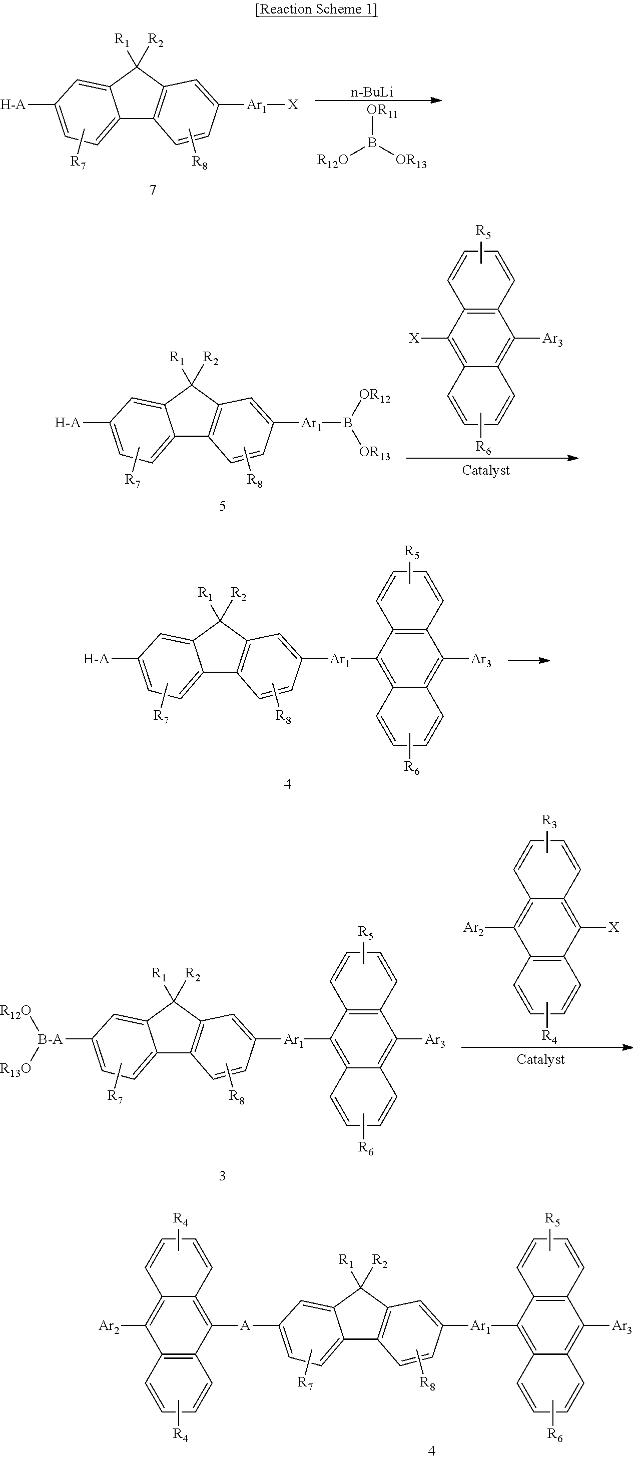

The organic EL compounds represented by Chemical Formula (1) according to the invention, wherein Ar₂ and Ar₃ are identical, R₃ and R₅ are identical and R₄ and R₆ are identical, can be prepared by reacting a dihalogen compound (8) with alkyl borate to give Compound (6), which was then reacted with 2 molar amount of halogen-substituted anthracene compound based on 1 mole of Compound (6), as shown in Reaction Scheme (2):

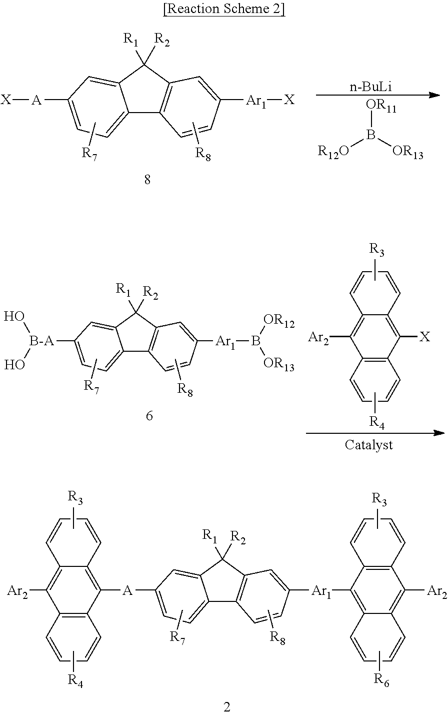

wherein, Ar₁ through Ar₃, A, and R₁ through R₈ are defined as above, X is Cl, Br or I, R₁₁ through R₁₃ represent C₁₋₅ alkyl group, or R₁₂ and R₁₃ may form a ring linked via alkylene group.

The present invention is not restricted to the process for preparing the organic EL compounds according to the invention and intermediates thereof, which is described in the Reaction Schemes illustrated above, but a person having ordinary skill in the art can prepare the compounds by applying conventional reactions in organic chemistry.

Further, the present invention provides an EL device comprising the organic EL compound represented by Chemical Formula (1) in the EL layer, more specifically an EL device employing the organic EL compound represented by Chemical Formula (1) according to the invention as host material together with a conventionally known dopant material in the EL layer.

### DESCRIPTION OF DRAWINGS

FIG. 1 is a cross-sectional view of an OLED,

FIG. 2 illustrates EL spectrums of the EL material (326) according to the invention and that of Comparative Example 1,

FIG. 3 shows current density versus voltage property of an OLED comprising the EL material (326) according to the invention,

FIG. 4 shows luminance versus voltage property of an OLED comprising the EL material (326) according to the invention,

FIG. 5 shows luminous efficiency versus current density property of an OLED comprising the EL material (326) according to the invention,

FIG. 6 shows current density versus voltage property of an OLED comprising the EL material (314) according to the invention,

FIG. 7 shows luminance versus voltage property of an OLED comprising the EL material (314) according to the invention,

FIG. 8 shows luminous efficiency versus current density property of an OLED comprising the EL material (314) according to the invention.

### DESCRIPTION OF SYMBOLS OF SIGNIFICANT PARTS OF THE DRAWINGS

1: Glass for OLED
2: ITO thin film
3: Hole injection layer
4: Hole transportation layer
5: EL layer
6: Electron transportation layer
7: Electron injection layer
8: Al cathode

Other and further objects, features and advantages of the invention will appear more fully from the following description.

### BEST MODE

The present invention is further described with respect to the electroluminescent compounds according to the invention, a process for preparing the same and the electroluminescent properties of the device employing the same, by referring to representative compounds according to the present invention, which are provided for illustration only but are not intended to be limiting in any way.

### Synthetic Example 1

### Synthesis of Compound (301)

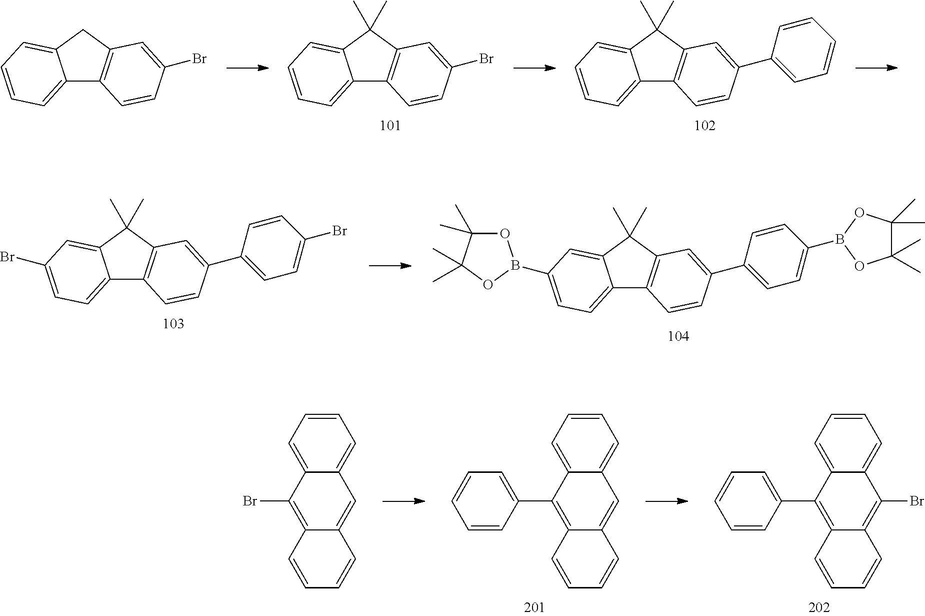

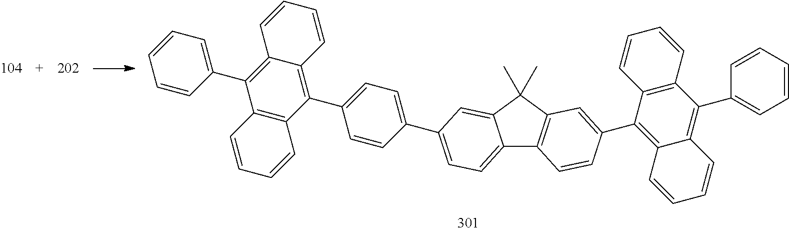

In dimethylsulfoxide (150 mL), 2-bromofluorene (15.0 g, 61 mmol), potassium iodide (KI) (1.0 g, 6 mmol) and potassium hydroxide (15.5 g, 0.3 mol) were mixed, and iodomethane (8.7 mL, 139 mmol) was added thereto at 10° C. After stirring at 30° C. for 12 hours, the reaction mixture was poured to distilled water (200 mL), and extracted with dichloromethane (300 mL).

The organic layer was dried over magnesium sulfate (MgSO₄), and distilled under reduced pressure to obtain Compound (101) (16 g, 58 mmol).

A reaction vessel was charged with Compound (101) (16 g, 58 mmol), phenyl boronic acid (10.6 g, 87 mmol), PdCl₂(PPh₃)₂ (4.1 g, 5.8 mmol), aqueous 2 M sodium carbonate solution (150 mL), toluene (300 mL) and ethanol (100 mL), and the mixture was stirred at 100° C. for 12 hours. The reaction mixture was extracted with dichloromethane (200 mL), and the organic layer was washed with distilled water (150 mL), dried over magnesium sulfate and distilled under reduced pressure. Purification via silica column chromatography (n-hexane: dichloromethane=20:1) gave Compound (102) (7.5 g, 27.7 mmol).

Compound (102) (3.4 g, 12 mmol) was dissolved in dichloromethane (50 mL), and solution of bromine (1.42 mL, 27 mmol) dissolved in dichloromethane (12 mL) was slowly added dropwise thereto at −5° C. The mixture was stirred at 0° C. for 2 hours, and then at 25° C. for 12 hours. After neutralization by using aqueous potassium hydroxide (KOH) solution (20 mL), the reaction mixture was extracted with dichloromethane (300 mL).

The extract was dried over magnesium sulfate and distilled under reduced pressure. Washing with n-hexane gave Compound (103) (4.8 g, 11 mmol).

Compound (103) (8.5 g, 19.8 mmol) was dissolved in tetrahydrofuran (100 mL), and n-BuLi (1.6 M in hexane) (32.26 mL, 51.6 mmol) was slowly added dropwise thereto at −78° C.

After stirring for 30 minutes, 2-isopropoxy-4,4,5,5-tetramethyl-1,3,2-dioxyborolane (12.2 mL, 59 mmol) was added to the mixture at −78° C. The resultant mixture was stirred at 25° C. for 24 hours, after slowly raising the temperature. The organic layer was extracted with dichloromethane (200 mL), and the extract was washed with distilled water (300 mL), dried over magnesium sulfate and distilled under reduced pressure.

The oily product was dissolved in hexane (50 mL), and the solution was distilled under reduced pressure several times to obtain solid. Filtration under reduced pressure and drying under reduced pressure of the solid gave Compound (104) (7.2 g, 13.8 mmol, 63%).

A reaction vessel was charged with 9-bromoanthracene (15 g, 58 mmol), phenylboronic acid (8.5 g, 70 mmol), PdCl₂(PPh₃)₂ (4 g, 5 mmol), aqueous 2.0 M sodium carbonate solution (290 mL), toluene (300 mL) and ethanol (150 mL), and the mixture was stirred under reflux for 12 hours. After cooling to 25° C. the reaction mixture was extracted with dichloromethane (150 mL), and the extract was washed with distilled water (200 mL), dried over magnesium sulfate and distilled under reduced pressure. The solid obtained was washed with methanol (250 mL) to provide Compound (201) (14 g, 55 mmol).

Compound (201) (14 g, 55 mmol) and N-bromosuccinimide (NES) (9.8 g, 55 mmol) were dissolved in dichloromethane (200 mL), and the solution was stirred at room temperature for 12 hours. After distillation of dichloromethane under reduced pressure, the solid was washed with methanol (40 mL) to obtain Compound (202) (13.8 g, 41 mmol).

In toluene (80 mL), dissolved were Compound (104) (2.7 g, 5.2 mmol), Compound (202) (5.2 g, 15.5 mmol), tetrakis(triphenylphosphine)palladium (Pd(PPh₃)₄) (0.6 g, 0.5 mmol), aqueous 1.0 M potassium carbonate solution (26 mL) and Aliquat 336 (0.6 mL, 1 mmol). After stirring at 100° C. for 4 hours, the mixture was cooled to 25° C. The organic layer was extracted with dichloromethane (300 mL) and washed with distilled water (260 mL). Drying over magnesium sulfate, distillation under reduced pressure, recrystallization from acetone (50 mL) and tetrahydrofuran (50 mL) and drying under reduced pressure gave Compound (301) (1.6 g, 2.6 mmol, yield: 50%).

¹H NMR (200 MHz, CDCl₃): δ=1.65 (s, 6H), 7.27 (m, 2H), 7.36-7.44 (m, 12H), 7.54-7.58 (m, 4H), 7.60-7.64 (d, 4H), 7.67 (m, 2H), 7.70-7.74 (m, 8H), 7.84 (d, 2H), 7.90-7.93 (m, 2H)

MS/FAB: 824 (found), 825.04 (calculated).

### Synthetic Example 2

### Synthesis of Compound (302)

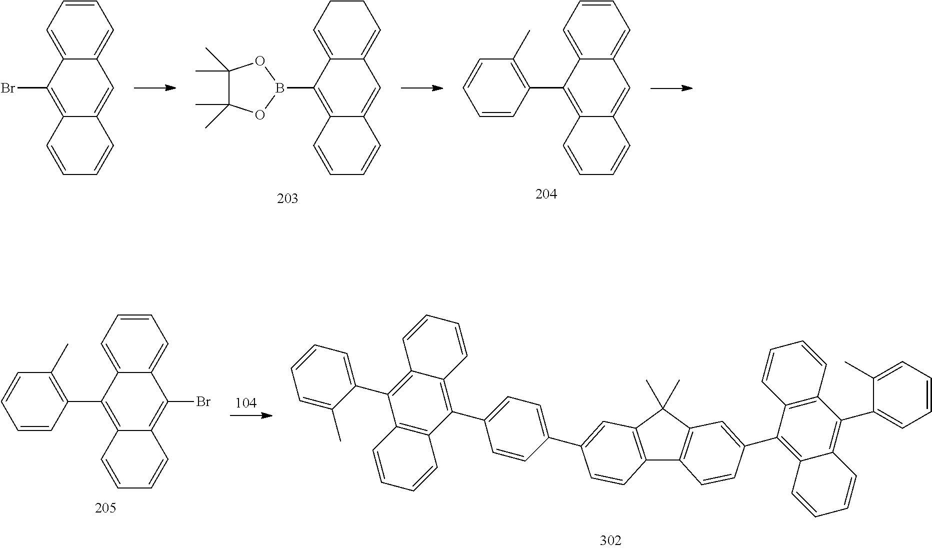

In tetrahydrofuran (200 mL), dissolved was 9-bromoanthracene (20 g, 77 mmol), and n-BuLi (2.5 M in hexane) (40 mL, 100 mmol) was slowly added dropwise thereto at −78° C.

After stirring for 30 minutes, 2-isopropoxy-4,4,5,5-tetramethyl-1,3,2-dioxyborolane (31.7 mL, 155 mmol) was added to the mixture at −78° C. The resultant mixture was stirred at ambient temperature for 24 hours, after slowly raising the temperature. The organic layer was extracted with dichloromethane (290 mL), washed with distilled water (400 mL), dried over magnesium sulfate and distilled under reduced pressure. The solid obtained was washed with methanol (50 mL) and hexane (30 mL) to provide Compound (203) (13 g, 42 mmol, 55%).

A reaction vessel was charged with Compound (203) (13 g, mmol), 2-bromotoluene (11 g, 64 mmol), tetrakis(triphenylphosphine)palladium (Pd(PPh₃)₄) (4.9 g, 4 mmol), aqueous 1.0 M potassium carbonate solution (210 mL), Aliquat 336 (4.2 g, 8.5 mmol) and toluene (300 mL). After stirring at 90° C. for 7 hours, the mixture was cooled to ambient temperature. The reaction mixture was extracted with dichloromethane (400 mL), and the extract was washed with distilled water (500 mL). Drying over magnesium sulfate and distillation under reduced pressure gave solid, which was then recrystallized from methanol (100 mL) to obtain Compound (204) (10.7 g, 38 mmol, yield: 91%).

Compound (204) (10.7 g, 38 mmol) and N-bromosuccinimide (NBS) (7.8 g) (43 mmol) were dissolved in dichloromethane (300 mL), and the solution was stirred at ambient temperature for 5 hours. After distillation of dichloromethane under reduced pressure, the residue was purified by using silica gel column chromatography (n-hexane: dichloromethane=10:1) to obtain Compound (205) (7 g, 20 mmol, yield: 52.6%).

A reaction vessel was charged with Compound (104) (3.0 g, 5.74 mmol), Compound (205) (5 g, 14.4 mmol), tetrakis(triphenylphosphine)palladium (Pd(PPh₃)₄) (0.6 g, 0.5 mmol), aqueous 1.0 M potassium carbonate solution (26 mL), Aliquat 336 (0.6 mL, 1.1 mmol) and toluene (80 mL). After stirring at 100° C. for 5 hours, the mixture was cooled to ambient temperature. The reaction mixture was extracted with dichloromethane (250 mL), and the extract was washed with distilled water (200 mL). Drying over magnesium sulfate, distillation under reduced pressure, and recrystallization from acetone (50 mL), ethyl acetate (50 mL) and tetrahydrofuran (50 mL) gave Compound (302) (1.5 g, 1.9 mmol, yield: 33%).

¹H NMR (200 MHz, CDCl₃): δ=1.65 (s, 6H), 2.37 (s, 6H), 7.20-7.23 (m, 4H), 7.39-7.47 (m, 12H), 7.62-7.65 (d, 4H), 7.67 (m, 2H), 7.70-7.74 (m, 8H), 7.84 (d, 2H), 7.90-7.93 (m, 2H)

MS/FAB: 803.57 (found), 803.03 (calculated).

### Synthetic Example 3

### Synthesis of Compound (303)

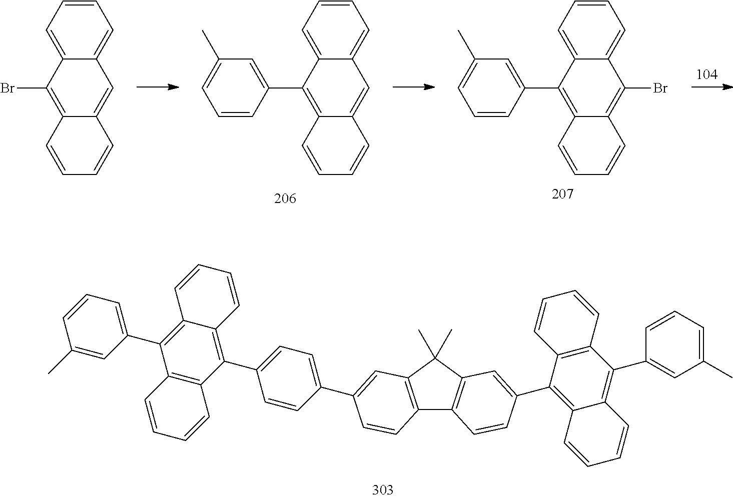

A reaction vessel was charged with 9-bromoanthracene (10 g, 38 mmol), m-tolyl boronic acid (5.8 g, 42 mmol), tetrakis(triphenylphosphine)palladium (Pd(PPh₃)₄) (4.5 g, 3.8 mmol), aqueous 2.0 M sodium carbonate solution (190 mL), toluene (200 mL) and ethanol (100 mL). After stirring under reflux for 12 hours, the reaction mixture was worked up according to the same procedure for Compound (201), to obtain Compound (206) (10 g, 37 mmol).

Compound (206) (10 g, 37 mmol) and N-bromosuccinimide (NBS) (7.2 g, 40 mmol) were dissolved in dichloromethane (200 mL), and the solution was stirred at ambient temperature for 12 hours. Distillation of dichloromethane under reduced pressure gave oily material, which was then recrystallized from methanol (30 mL) and dried under reduced pressure to obtain Compound (207) (8.2 g, 23 mmol) as yellow powder.

A reaction vessel was charged with Compound (207) (5 g, 14.4 mmol), Compound (104) (2.5 g, 4.8 mmol), tetrakis(triphenylphosphine)palladium (Pd(PPh₃)₄) (0.6 g, 0.5 mmol), aqueous 2.0 M potassium carbonate solution (28 mL), Aliquat 336 (0.53 mL, 1 mmol) and toluene (80 mL). After stirring at 100° C. for 5 hours, the mixture was cooled to 25° C.

The organic layer was extracted with dichloromethane (200 mL) and washed with distilled water (200 mL). After drying over magnesium sulfate, and distillation of dichloromethane under reduced pressure, the solid was recrystallized from methanol (40 mL). Purification via silica gel column chromatography (n-hexane: dichloromethane=15:1), recrystallization from acetone (100 mL) and drying under reduced pressure gave Compound (303) (1.2 g, 1.5 mmol, yield: 31%) as white powder.

¹H NMR (200 MHz, CDCl₃): δ=1.65 (s, 6H), 2.37 (s, 6H), 7.08 (m, 2H), 7.21-28 (m, 6H), 7.42-7.45 (m, 8H), 7.61-7.64 (d, 4H), 7.67 (m, 2H), 7.70-7.74 (m, 8H), 7.87 (d, 2H), 7.90-7.93 (m, 2H)

ME/FAB: 803.34 (found), 803.03 (calculated).

### Synthetic Example 4

### Synthesis of Compound (304)

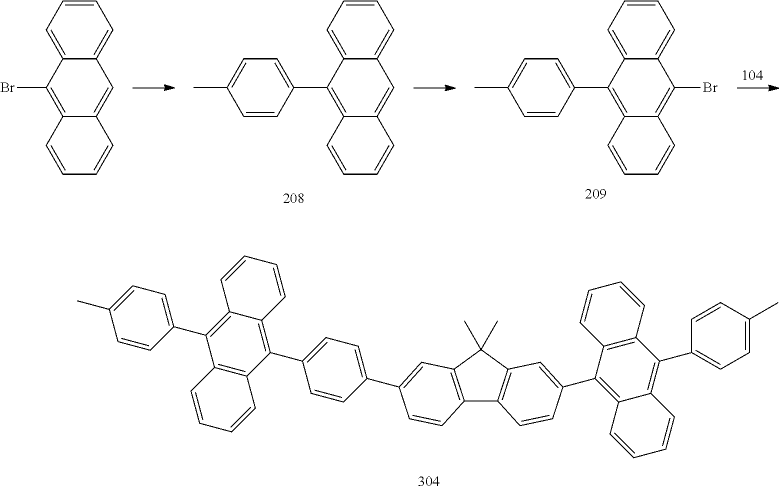

A reaction vessel was charged with 9-bromoanthracene (10 g, 38 mmol), o-tolylboronic acid (5.8 g, 42 mmol), tetrakis(triphenylphosphine)palladium (Pd(PPh₃)₄) (4.5 g, 3.8 mmol), aqueous 2.0 M sodium carbonate solution (190 mL), toluene (200 mL) and ethanol (100 mL), and the mixture was stirred under reflux for 12 hours. The reaction mixture was worked up according to the same procedure for Compound (201) to obtain Compound (208) (9.4 g, 35 mmol) as yellow solid.

Compound (208) (9.4 g, 35 mmol) and N-bromosuccinimide (NBS) (6.8 g, 38 mmol) were dissolved in dichloromethane (200 mL), and the solution was stirred at 25° C. for 12 hours.

Distillation of dichloromethane under reduced pressure gave solid, which was then washed with methanol (60 mL) to obtain Compound (209) (8.7 g, 25 mmol) as yellow powder.

A reaction vessel was charged with Compound (209) (5 g, 14.4 mmol), Compound (104) (2.5 g, 4.8 mmol), tetrakis(triphenylphosphine)palladium (Pd(PPh₃)₄) (0.6 g, 0.5 mmol), aqueous 2.0 M potassium carbonate solution (28 mL), Aliquat 336 (0.5 mL, 1 mmol) and toluene (80 mL). After stirring at 100° C. for 5 hours, the mixture was cooled to 25° C.

The organic layer was extracted with dichloromethane (500 mL) and washed with distilled water (140 mL). After drying over magnesium sulfate, and distillation of dichloromethane under reduced pressure, the solid was recrystallized from methanol (20 mL), acetone (40 mL) and tetrahydrofuran (60 mL), and dried under reduced pressure to obtain Compound (304) (0.9 g, 1.1 mmol, yield: 23%) as ivory solid.

¹H NMR (200 MHz, CDCl₃): δ=1.65 (s, 6H), 2.37 (s, 6H), 7.14-7.22 (m, 6H), 7.35-7.41 (m, 10H), 7.60-7.64 (d, 4H), 7.66-7.68 (m, 2H), 7.70-7.74 (m, 8H), 7.87 (d, 2H), 7.90-7.98 (m, 2H)

MS/FAB: 802 (found), 803.03 (calculated).

### Synthetic Example 5

### Synthesis of Compound (305)

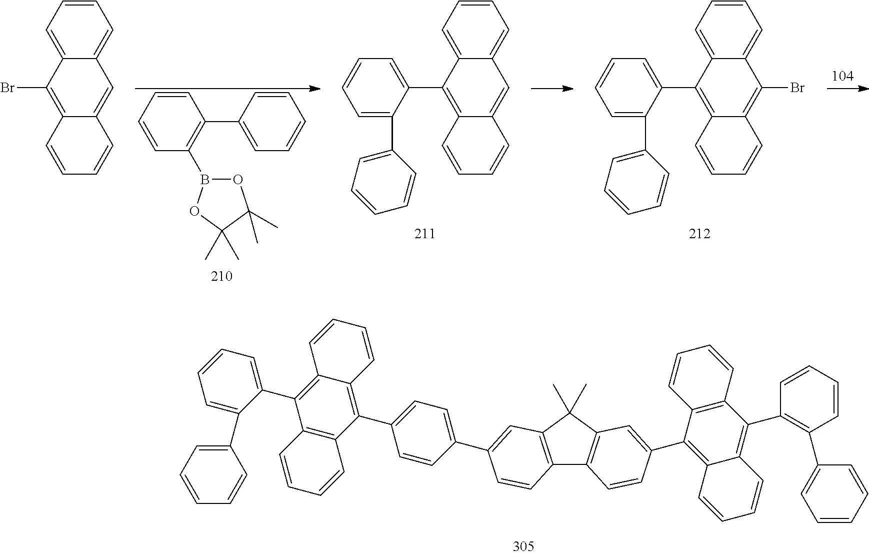

In tetrahydrofuran (150 mL), dissolved was 2-bromobiphenyl (20 g, 85 mmol), and n-BuLi (1.6 M in n-hexane) (62.5 mL, 0.1 mol) was slowly added thereto at −78° C. After stirring the mixture for 30 minutes, added was 2-isopropoxy-4,4,5,5-tetramethyl-1,3,2-dioxyborolane (24.5 mL, 0.1 mol) at −78° C. The temperature was slowly raised, and the reaction mixture was stirred at ambient temperature for one day. The mixture was extracted with dichloromethane (600 mL), and the extract was washed with distilled water (500 mL) and dried over magnesium sulfate. After distillation under reduced pressure, the solid obtained was washed with n-hexane (55 mL) to obtain Compound (210) (12.5 g, 44 mmol) as white powder.

A reaction vessel was charged with Compound (210) (13.3 g, 67 mmol), 9-bromoanthracene (15 g, 58.3 mmol), tetrakis(triphenylphosphine)palladium (Pd(PPh₃)₄) (6.7 g, 5.8 mmol), aqueous 2 M sodium carbonate solution (290 mL) and toluene (500 mL), and the mixture was stirred at 100° C. for 3 hours. After cooling to 25° C. the reaction mixture was worked up according to the same procedure for Compound (201), to obtain Compound (211) (16.3 g, 49 mmol) as orange powder.

To Compound (211) (16.3 g, 49 mmol), added was N-bromosuccinimide (NBS) (13.5 g, 54 mmol). With light shielded, dichloromethane (1 L) was added thereto, and the mixture was stirred at ambient temperature for 2 hours. Distillation of dichloromethane under reduced pressure and recrystallization from tetrahydrofuran (160 mL) and methanol (240 mL) gave solid, which was then dried under reduced pressure to obtain Compound (212) (15.2 g, 37 mmol) as yellow powder.

A reaction vessel was charged with Compound (212) (5.9 g, 14.4 mmol), Compound (104) (2.5 g, 4.8 mmol), tetrakis(triphenylphosphine)palladium (Pd(PPh₃)₄) (0.6 g, 0.5 mmol), aqueous 2.0 M potassium carbonate solution (16 mL), Aliquat 336 (0.5 mL, 1 mmol) and toluene (80 mL). After stirring at 100° C. for 5 hours, the mixture was cooled to 25° C.

The reaction mixture was extracted with dichloromethane (200 mL), and the extract was washed with distilled water (150 mL). After drying over magnesium sulfate, and distillation of dichloromethane (100 mL) under reduced pressure, the solid was recrystallized from methanol (100 mL), acetone (110 mL) and tetrahydrofuran (60 mL) to obtain Compound (305) (1.5 g, 1.6 mmol, yield: 33%) as yellow powder.

¹H NMR (200 MHz, CDCl₃): δ=1.65 (s, 6H), 7.22-7.24 (m. 2H), 7.28-7.34 (m, 4H), 7.38-7.43 (m, 12H), 7.51-7.62 (m, 12H), 7.65-7.67 (m, 2H), 7.70-7.74 (m, 8H), 7.87 (d, 2H), 7.90-7.93 (m, 2H)

MS/FAB: 926 (found), 927.17 (calculated).

### Synthetic Example 6

### Synthesis of Compound (306)

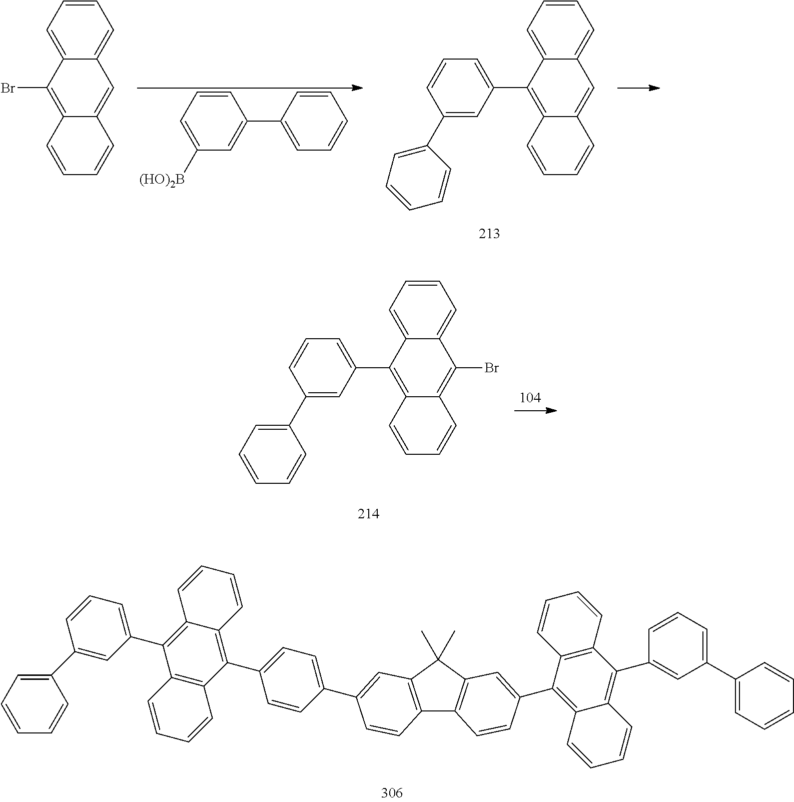

A reaction vessel was charged with 3-bromobiphenylboronic acid (13.3 g, 67 mmol), 9-bromoanthracene (15 g, 58.4 mmol), tetrakis(triphenylphosphine)palladium (Pd(PPh₃)₄) (6.7 g, 5.8 mmol), aqueous 2 M sodium carbonate solution (290 mL) and toluene (500 mL), and the mixture was stirred at 100° C. for 3 hours. After cooling to 25° C. the reaction mixture was worked up according to the same procedure for Compound (201), to obtain Compound (213) (20.3 g, 61.4 mmol) as orange powder.

To Compound (213) (20.3 g, 61 mmol), added was N-bromosuccinimide (NES) (12 g, 67 mmol). With light shielded, dichloromethane (1 L) was added thereto, and the mixture was stirred for 12 hours. Then, dichloromethane was distilled under reduced pressure, and the residue was recrystallized from tetrahydrofuran (300 mL) and methanol (130 mL). Drying under reduced pressure gave Compound (214) (20.0 g, 48 mmol) as yellow powder.

A reaction vessel was charged with Compound (214) (5.9 g, 14.4 mmol), Compound (104) (2.5 g, 4.8 mmol), tetrakis(triphenylphosphine)palladium (Pd(PPh₃)₄) (0.6 g, 0.5 mmol), aqueous 2.0 M potassium carbonate solution (16 mL), Aliquat 336 (0.5 mL, 1 mmol) and toluene (80 mL). After stirring at 100° C. for 5 hours, the mixture was cooled to 25° C.

The reaction mixture was extracted with dichloromethane (140 mL), and the extract was washed with distilled water (200 mL). After drying over magnesium sulfate, and distillation of dichloromethane under reduced pressure, the solid obtained was recrystallized from methanol (170 mL), acetone (270 mL) and tetrahydrofuran (300 mL), and dried under reduced pressure to obtain Compound (306) (1.8 g, 1.9 mmol, yield: 40%) as yellow powder.

¹H NMR (200 MHz, CDCl₃): δ=1.65 (s, 6H), 7.21-7.24 (m, 2H), 7.34-7.37 (m, 4H), 7.40-7.51 (m, 18H), 7.57-7.63 (m, 4H), 7.64-7.67 (m, 2H), 7.70-7.74 (m, 8H), 7.80 (s, 2H), 7.84-7.87 (d, 2H), 7.90-7.93 (m, 8H)

MS/FAB: 926 (found), 927.17 (calculated).

### Synthetic Example 7

### Synthesis of Compound (307)

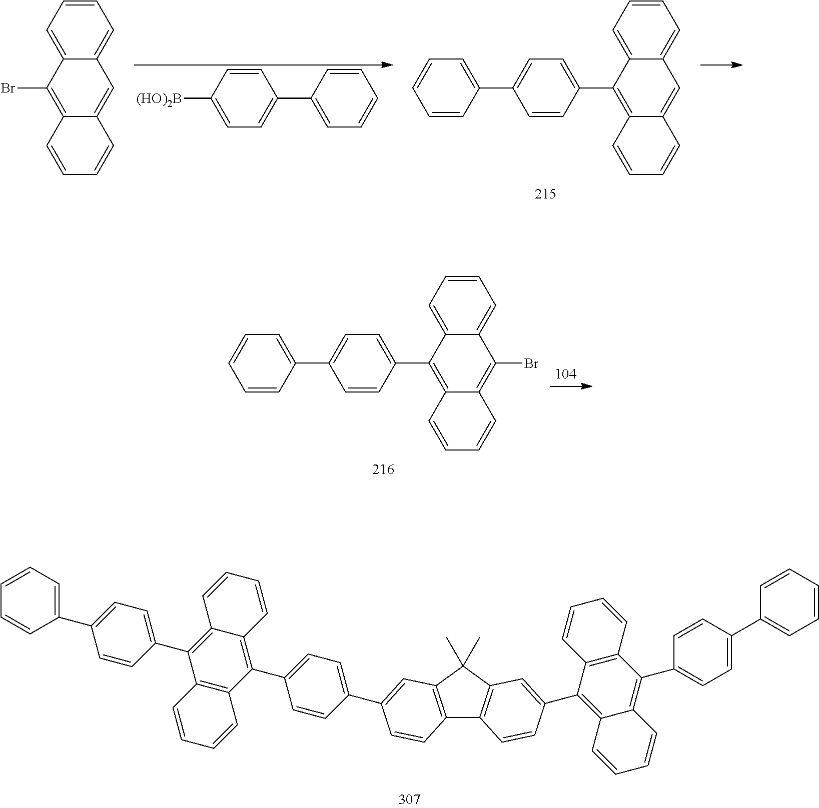

A reaction vessel was charged with 4-bromobiphenylboronic acid (13.3 g, 67 mmol), 9-bromoanthracene (15 g, 58.3 mmol), tetrakis(triphenylphosphine)palladium (Pd(PPh₃)₄) (6.7 g, 5.8 mmol), aqueous 2 M sodium carbonate solution (290 mL) and toluene (500 mL), and the mixture was stirred at 100° C. for 5 hours. After cooling to 25° C. the reaction mixture was worked up according to the same procedure for Compound (201), to obtain Compound (215) (22.7 g, 68.7 mmol) as yellow powder.

To Compound (215) (22.7 g, 68 mmol), added was N-bromosuccinimide (NBS) (13.5 g, 75 mmol). With light shielded, dichloromethane (1 L) was added thereto, and the mixture was stirred for 4 hours. Then, dichloromethane was distilled under reduced pressure, and the residue was recrystallized from tetrahydrofuran-methanol (1/1) (200 mL), to obtain Compound (216) (23.2 g, 56 mmol) as yellow powder.

A reaction vessel was charged with Compound (216) (5.9 g, 14.4 mmol), Compound (104) (2.5 g, 4.8 mmol), tetrakis(triphenylphosphine)palladium (Pd(PPh₃)₄) (0.6 g, 0.5 mmol), aqueous 2.0 M potassium carbonate solution (16 mL), Aliquat 336 (0.5 mL, 1 mmol) and toluene (80 mL). After stirring at 100° C. for 5 hours, the mixture was cooled to 25° C.

The reaction mixture was extracted with dichloromethane (80 mL), and the extract was washed with distilled water (50 mL). After drying over magnesium sulfate, and distillation of dichloromethane under reduced pressure, the solid obtained was recrystallized from methanol (300 mL), acetone (200 mL) and tetrahydrofuran (120 mL), and dried under reduced pressure to obtain Compound (307) (1.5 g, 1.7 mmol, yield: 35%) as ivory powder.

¹H NMR (200 MHz, CDCl₃): δ=1.65 (s, 6H), 7.21-7.24 (m, 2H), 7.35-7.42 (m, 12H), 7.56-7.59 (m, 4H), 7.62-7.68 (m, 12H), 7.64-7.67 (m, 2H), 7.70-7.74 (m, 8H), 7.84-7.87 (d, 2H), 7.90-7.93 (m, 2H)

MS/FAB: 926 (found), 927.17 (calculated).

### Synthetic Example 8

### Synthesis of Compound (308)

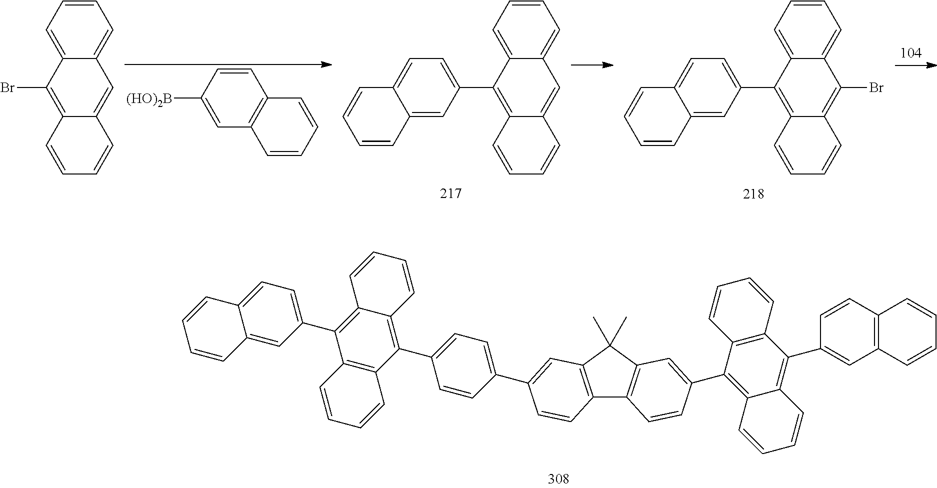

A reaction vessel was charged with 2-bromonaphthaleneboronic acid (12 g, 70 mmol), 9-bromoanthracene (15 g, 58.3 mmol), PdCl₂(PPh₃)₂ (4.1 g, 5.8 mmol), aqueous 2 M sodium carbonate solution (290 mL), toluene (400 mL) and ethanol (150 mL), and the mixture was stirred at 100° C. for 5 hours. After cooling to 25° C. the reaction mixture was worked up according to the same procedure for Compound (201), to obtain Compound (217) (17 g, 55.9 mmol) as yellow powder.

To Compound (217) (17 g, 55 mmol), added was N-bromosuccinimide (NES) (10.9 g, 61 mmol). With light shielded, dichloromethane (1 L) was added thereto, and the mixture was stirred for 12 hours. Then, dichloromethane was distilled under reduced pressure, and the residue was recrystallized from tetrahydrofuran-methanol (1/1) (300 mL), to obtain Compound (218) (18 g, 47 mmol) as yellow powder.

A reaction vessel was charged with Compound (218) (5.9 g, 15.5 mmol), Compound (104) (3.0 g, 5.7 mmol), PdCl₂(PPh₃)₂ (0.4 g, 0.6 mmol), aqueous 2.0 M potassium carbonate solution (14 mL), Aliquat 336 (0.6 mL, 1.1 mmol) and toluene (80 mL). After stirring at 100° C. for 12 hours, the mixture was cooled to 25° C.

The reaction mixture was extracted with dichloromethane (250 mL), and the extract was washed with distilled water (600 mL). After drying over magnesium sulfate, and distillation of dichloromethane under reduced pressure, the solid obtained was recrystallized from methanol (230 mL), acetone (320 mL) and tetrahydrofuran (70 mL), and dried under reduced pressure to obtain Compound (308) (3.3 g, 3.8 mmol, yield: 67%) as ivory powder.

¹H NMR (200 MHz, CDCl₃): δ=1.65 (s, 6H), 7.30-7.33 (m, 12H), 7.52-7.54 (m, 6H), 7.59-7.61 (m, 2H), 7.65-7.69 (m, 12H), 7.72-7.74 (m, 2H), 7.77 (m, 2H), 7.89-7.91 (m, 4H)

MS/FAB: 874 (found), 875.10 (calculated).

### Synthetic Example 9

### Synthesis of Compound (309)

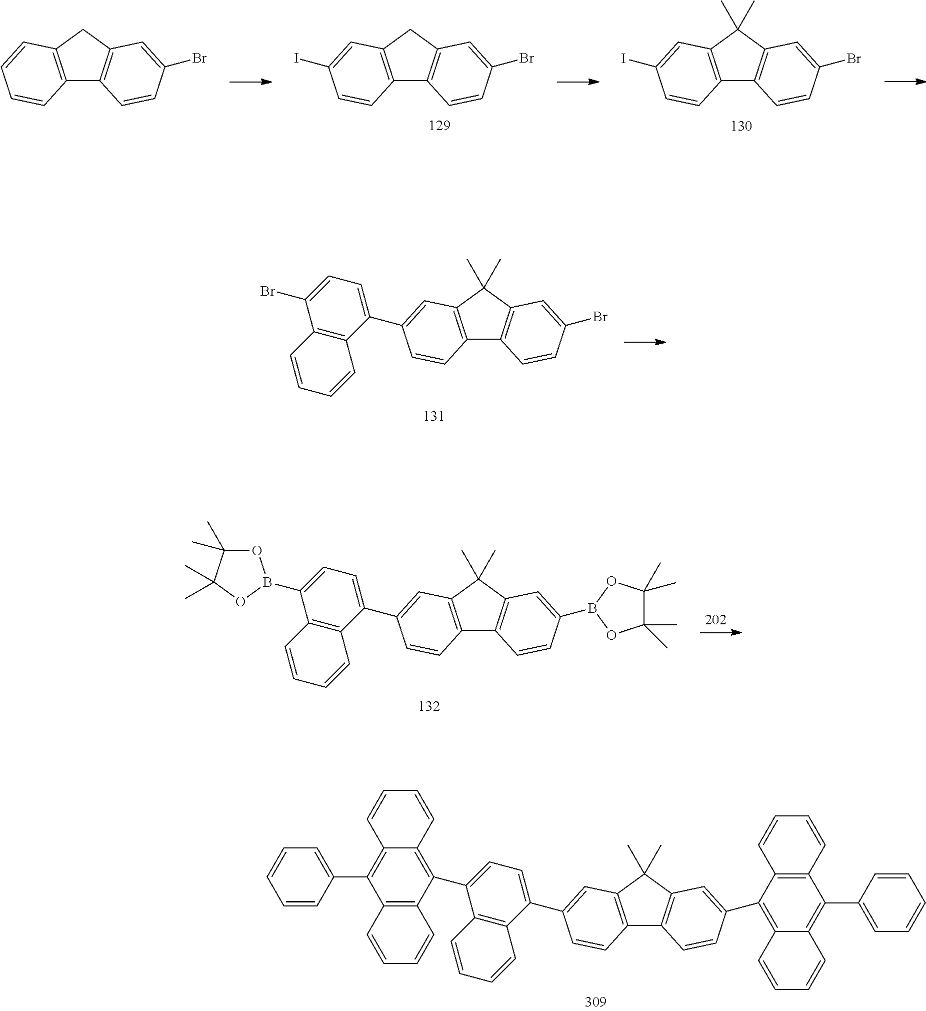

In acetic acid (250 mL), dissolved were 2,7-dibromofluorene (20 g, 810 mmol), iodine (9.3 g, 360 mmol) and iodic acid (3.58 g, 20 mmol). To the solution, distilled water (15 mL) and sulfuric acid (7.5 mL) were added, and the mixture was stirred at 85° C. under reflux for 12 hours. After cooling to ambient temperature, the solid was filtered under reduced pressure, and washed subsequently with distilled water (300 mL), saturated aqueous potassium carbonate solution (300 mL), methanol (300 mL) and hexane (400 mL). Drying the solid under reduced pressure gave Compound (129) (19 g, 530 mmol).

Compound (129) (19 g, 530 mmol), potassium iodide (0.85 g, 5.1 mmol) and potassium hydroxide (12.9 g, 230 mmol) were dissolved in DMSO (150 mL), and iodomethane (7.97 mL, 128 mmol) was added thereto at 10° C. The mixture was stirred at ambient temperature for 24 hours, and distilled water (200 mL) was added thereto. Filtering the solid under reduced pressure and washing with methanol (200 mL) gave Compound (130) (15 g, 370 mmol).

Compound (130) (15.0 g, 370 mmol), 1-bromo-4-naphthalene boronic acid (9.43 g, 370 mmol), tetrakis(triphenylphosphine)palladium (Pd(PPh₃)₄) (4.34 g, 3.7 mmol) and aqueous 1.0 M potassium carbonate solution (187 mL) were dissolved in diethyleneglycol (DME), and the solution was stirred at 80° C. for 12 hours. After cooling to ambient temperature, the organic layer was extracted with dichloromethane (500 mL). The extract was washed with distilled water (200 mL) and dried over magnesium sulfate.

Drying the organic layer under reduced pressure and purification via silica gel column chromatography (n-hexane:dichloromethane=10:1) gave Compound (131) (6.2 g, 12.9 mmol).

Compound (131) (6.2 g, 12.9 mmol) was dissolved in tetrahydrofuran (50 mL), and n-BuLi (1.6 M in hexane) (20.2 mL, 32 mmol) was slowly added thereto at −78° C. After stirring for 30 minutes, 2-isopropoxy-4,4,5,5-tetramethyl-1,3,2-dioxyborolane (7.93 mL, 38 mmol) was added to the mixture at −78° C. The temperature was slowly raised, and the reaction mixture was stirred at ambient temperature for one day. Then, the mixture was extracted with dichloromethane (500 mL), and the extract was washed with distilled water (300 mL). Drying over magnesium sulfate and distillation under reduced pressure gave solid, which was then washed with methanol (200 mL) and n-hexane (300 mL). Purification via silica column chromatography (n-hexane:ethyl acetate=2:1) gave Compound (132) (3.6 g, 6.3 mmol).

Compound (132) (3.6 g, 6.3 mmol), Compound (202) (5.24 g, 15.7 mmol), tetrakis(triphenylphosphine)palladium (Pd(PPh₃)₄) (0.7 g, 0.6 mmol), aqueous 1.0 M potassium carbonate solution (30 mL), Aliquat 336 (0.7 mL, 1.3 mmol) and toluene (60 mL) were mixed together, and the mixture was stirred at 100° C. for 12 hours. After cooling to ambient temperature, the reaction mixture was extracted with dichloromethane (300 mL), and the extract was washed with distilled water (200 mL), dried over magnesium sulfate, and distilled under reduced pressure.

Recrystallization from acetone (40 mL), ethyl acetate (40 mL) and tetrahydrofuran (20 mL) gave Compound (309) (1.4 g, 1.7 mmol, yield: 27%).

¹H NMR (200 MHz, CDCl₃): δ=1.67 (s, 6H), 7.20-7.22 (m, 2H), 7.26-7.38 (m, 14H), 7.47-7.49 (m, 4H), 7.58-7.62 (m, 4H), 7.64-7.70 (m, 10H), 7.77 (d, 2H), 7.90-7.92 (d, 2H)

MS/FAB: 824 (found), 825.04 (calculated).

### Synthetic Example 10

### Synthesis of Compound (310)

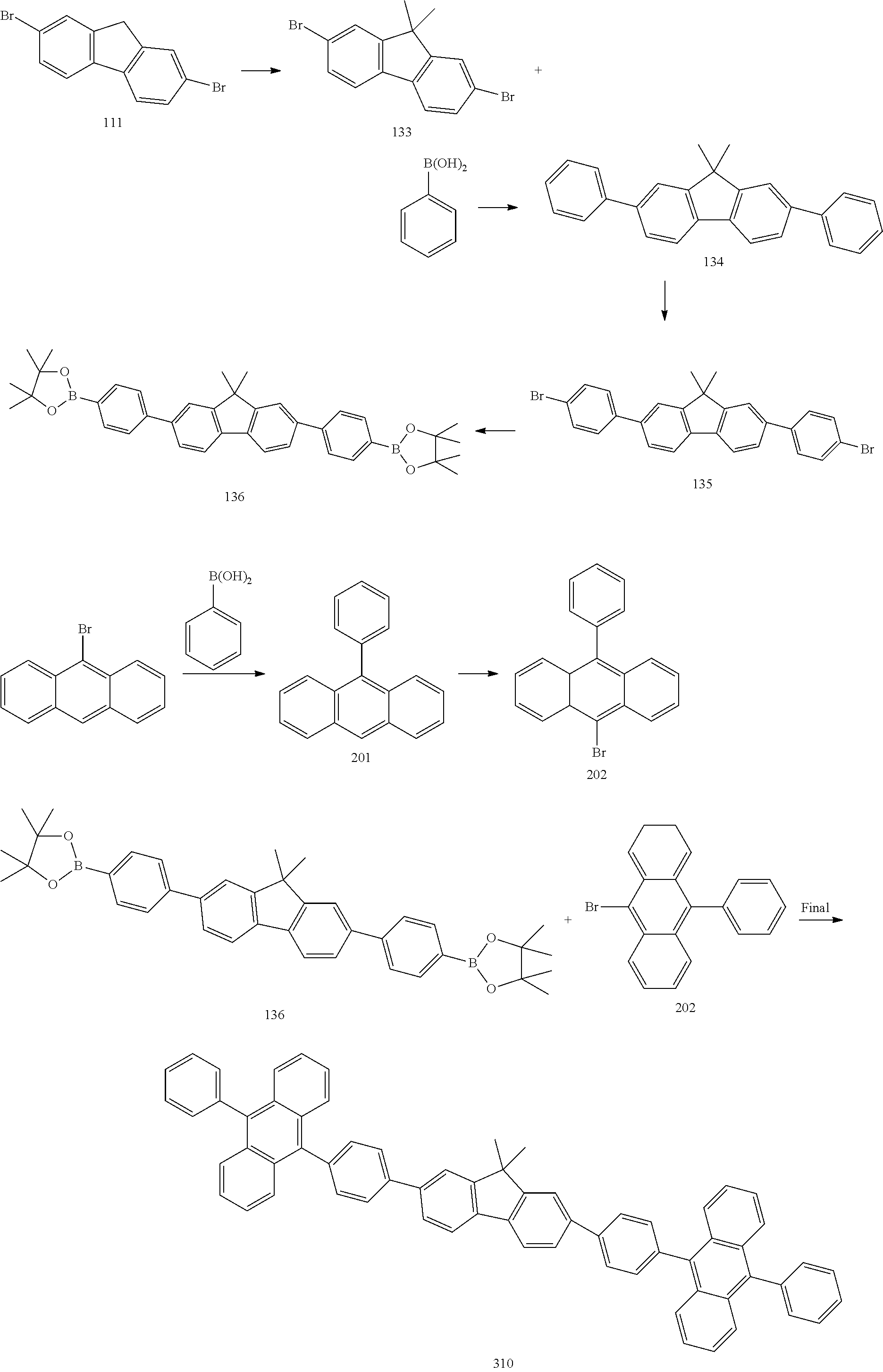

Compound (111) (2,7-dibromofluorene) (20 g, 61.7 mmol) and potassium hydroxide (27.7 g, 370 mmol) were dissolved in N,N-dimethylsulfoxide (250 mL) at 10° C. and distilled water (45 mL) was added thereto. After stirring for 1 hour, iodomethane (35.0 g, 144.6 mmol) was slowly added thereto. The mixture was stirred at 0° C. for 20 minutes and then at ambient temperature for 10 hours, and neutralized by using 2M HCl. The solid was filtered under reduced pressure and dissolved in dichloromethane (500 mL). Methanol (500 mL) was added to form crystals, which was then filtered to obtain Compound (133) (19.6 g, 55.6 mmol).

Under nitrogen atmosphere, a reaction vessel was charged with Compound (133) (30 g, 85.2 mmol), phenyl boronic acid (22.8 g, 187.4 mmol), tetrakis(triphenylphosphine) palladium (Pd(PPh₃)₄) (4.9 g, 4.3 mmol), toluene (500 mL) and ethanol (300 mL), and then aqueous 2 M potassium carbonate solution (341 mL, 681 mmol) was added thereto. After stirring at 120° C. for 3 hours, the mixture was neutralized by using saturated aqueous ammonium chloride solution (100 mL), extracted with ethyl acetate (1000 mL), and the extract was washed with water (500 mL). The organic substance was distilled under reduced pressure, dried, and washed with methanol (200 mL). The mixture was purified via silica gel column chromatography (hexane) and recrystallized from methanol (200 mL) to obtain Compound (134) (14 g, 40.4 mmol).

Compound (134) (3.2 g, 9.2 mmol) was dissolved in 70 mL of dichloromethane, and the solution was chilled to −5° C. Bromine (3.1 g, 19.4 mmol) dissolved in dichloromethane (20 mL) was then slowly added thereto. The temperature was raised to ambient temperature, and the mixture was stirred for one day. After pouring aqueous 20% potassium hydroxide solution (100 mL), the organic layer was extracted with dichloromethane (500 mL). The extract was washed with water (100 mL), and dried under reduced pressure. Recrystallization from n-hexane (100 mL) gave solid, which was then filtered to obtain Compound (135) (3.91 g, 7.7 mmol).

A round bottomed flask was charged with Compound (135) (3.9 g, 7.75 mmol) and tetrahydrofuran (100 mL) under nitrogen atmosphere, and 2.5 M n-BuLi (8.6 mL, 20.1 mmol) was slowly added thereto at −78° C. After stirring at the same temperature for 30 minutes, added was 2-isopropoxy-4,4,5,5-tetramethyl-1,3,2-dioxaborolane (6.42 mL, 31 mmol) at −78° C. and the mixture was stirred for 24 hours while raising the temperature to ambient temperature. The reaction mixture was extracted with ethyl acetate (300 mL), and the extract was recrystallized from methanol and dried to obtain Compound (135) (2.7 g, 4.5 mmol).

In toluene (300 mL), dissolved were 9-bromoanthracene (15.0 g, 58.3 mmol), phenylboronic acid (9.3 g, 75.8 mmol) and tetrakis(triphenylphosphine)palladium (Pd(PPh₃)₄) (6.74 g, 5.8 mmol), and ethanol (150 mL) and aqueous 2 M sodium carbonate solution (486 mL) were added thereto. After stirring at 120° C. under reflux for 5 hours, the reaction temperature was lowered to ambient temperature. The reaction was quenched by adding distilled water (100 mL), and the mixture was extracted with ethyl acetate (600 mL). The organic layer obtained was dried over anhydrous magnesium sulfate, filtered and concentrated under reduced pressure. Recrystallization from tetrahydrofuran (300 mL) gave Compound (201) (11.7 g, 46.0 mmol).

In a reaction vessel, Compound (201) (11.7 g, 46.0 mmol) and N-bromosuccinimide (NBS) (9.0 g, 50.6 mmol) were dissolved) in dichloromethane (360 mL), and the solution was stirred at ambient temperature for 5 hours. After quenching the reaction by adding distilled water, the reaction mixture was extracted with dichloromethane (200 mL). The organic layer was dried over anhydrous magnesium sulfate, filtered and concentrated under reduced pressure. Recrystallization from tetrahydrofuran (300 mL) gave Compound (202) (13.0 g, yield: 85%).

A reaction vessel was charged with Compound (136) (5.0 g, 8.3 mmol), Compound (202) (8.3 g, 24.9 mmol), tetrakis(triphenylphosphine)palladium (Pd(PPh₃)₄) (0.96 g, 0.83 5 mmol), Aliquat 336 (0.4 mL, 0.83 mmol) and toluene (100 mL), and aqueous 2 M potassium carbonate solution (30 mL, 66 mmol) was added thereto. After stirring at 120° C. under reflux for 6 hours, the mixture was neutralized by using saturated aqueous ammonium chloride solution (100 mL), and the solid was filtered under reduced pressure. The dried solid was recrystallized from methanol (200 mL). Recrystallization from N,N-dimethylformamide (10 mL) gave Compound (310) (4.5 g, 5.3 mmol, yield: 64%).

¹H NMR (CDCl₃, 200 MHz): δ=1.65 (s, 6H), 7.30 (t, 2H), 7.35 (m, 12H), 7.45 (dd, 4H), 7.54 (dd, 8H), 7.60 (d, 12H), 7.65 (m, 8H), 7.71 (d, 2H), 7.92 (dd, 2H)

MS/FAB: 851.36 (found), 851.08 (calculated).

### Synthetic Example 11

### Synthesis of Compound (311)

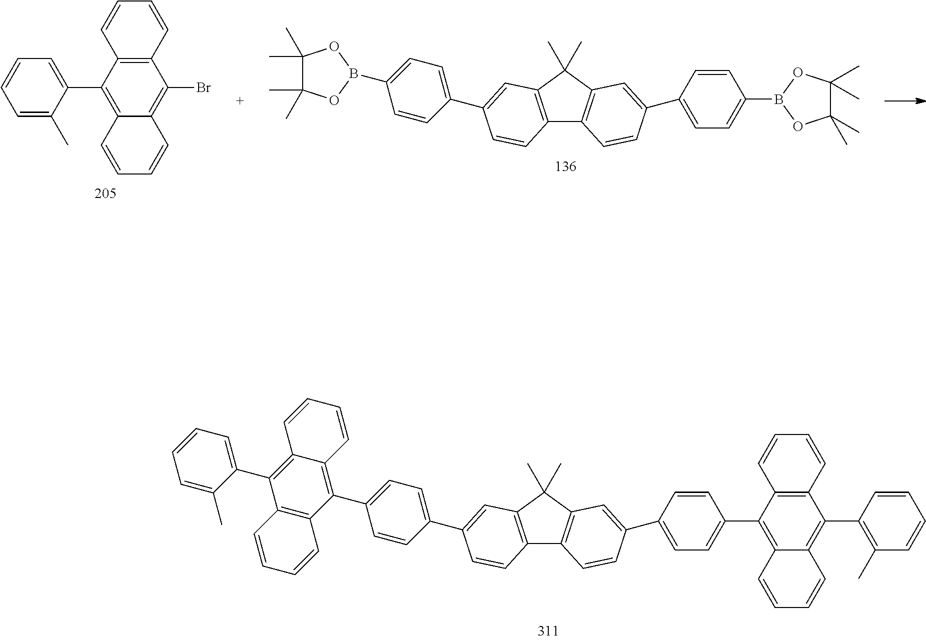

A reaction vessel was charged with Compound (205) (8.7 g, 24.9 mmol), Compound (136) (5 g, 8.3 mmol), tetrakis(triphenylphosphine)palladium (Pd(PPh₃)₄) (0.96 g, 0.8 mmol), aqueous 2.0 M potassium carbonate solution (24 mL), Aliquat 336 (0.46 mL, 0.83 mmol) and toluene (80 mL), and the mixture was stirred at 100° C. for 5 hours. The reaction mixture was cooled to ambient temperature, and extracted with dichloromethane (300 mL). The extract was washed with distilled water (100 mL), and dried over magnesium sulfate.

After distillation of dichloromethane under reduced pressure, the residue was recrystallized from methanol (100 mL). The solid was added to acetone (30 mL), and the mixture was boiled and then filtered under reduced pressure. The procedure was further repeated twice to obtain Compound (311) (4.2 g, 4.8 mmol, yield: 58%) as white powder.

¹H NMR (CDCl₃, 200 MHz): δ=1.65 (s, 6H), 2.30 (s, 6H), 7.10-7.13 (m, 6H), 7.32-7.36 (m, 10H), 7.54 (dd, 8H), 7.60 (d, 2H), 7.65-7.68 (m, 8H), 7.78 (d, 2H), 7.91 (d, 2H)

MS/FAB: 851.36 (found), 851.08 (calculated).

### Synthetic Example 12

### Synthesis of Compound (312)

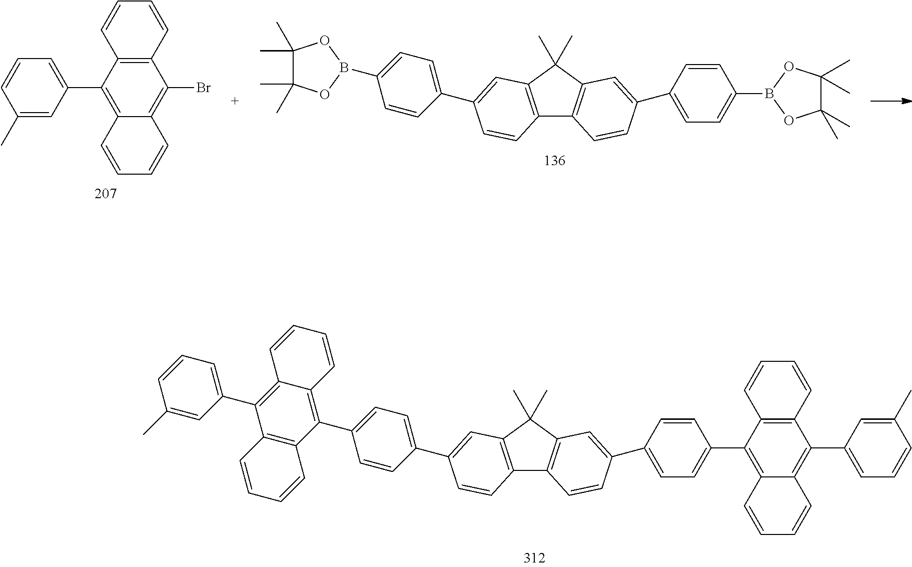

A reaction vessel was charged with Compound (207) (8.7 g, 24.9 mmol), Compound (136) (5 g, 8.3 mmol), tetrakis(triphenylphosphine)palladium (Pd(PPh₃)₄) (0.96 g, 0.8 mmol), aqueous 2.0 M potassium carbonate solution (24 mL), Aliquat 336 (0.5 mL, 0.8 mmol) and toluene (80 mL), and the mixture was stirred at 100° C. for 5 hours. The reaction mixture was cooled to ambient temperature, and extracted with dichloromethane (300 mL). The extract was washed with distilled water (100 mL), and dried over magnesium sulfate.

After distillation of dichloromethane under reduced pressure, the residue was recrystallized from methanol (100 mL). The solid was added to acetone (30 mL), and the mixture was boiled and then filtered under reduced pressure. The procedure was further repeated twice to obtain Compound (312) (4.6 g, 5.2 mmol, yield: 63%) as white powder.

¹H NMR (CDCl₃, 200 MHz): δ=1.65 (s, 6H), 2.35 (s, 6H), 7.01 (m, 2H), 7.11 (m, 2H), 7.28-7.32 (m, 12H), 7.54 (dd, 8H), 7.60 (dd, 2H), 7.66-7.68 (m, 8H), 7.76 (dd, 2H), 7.91 (dd, 2H)

MS/FAB: 851.36 (found), 851.08 (calculated).

### Synthetic Example 13

### Synthesis of Compound (313)

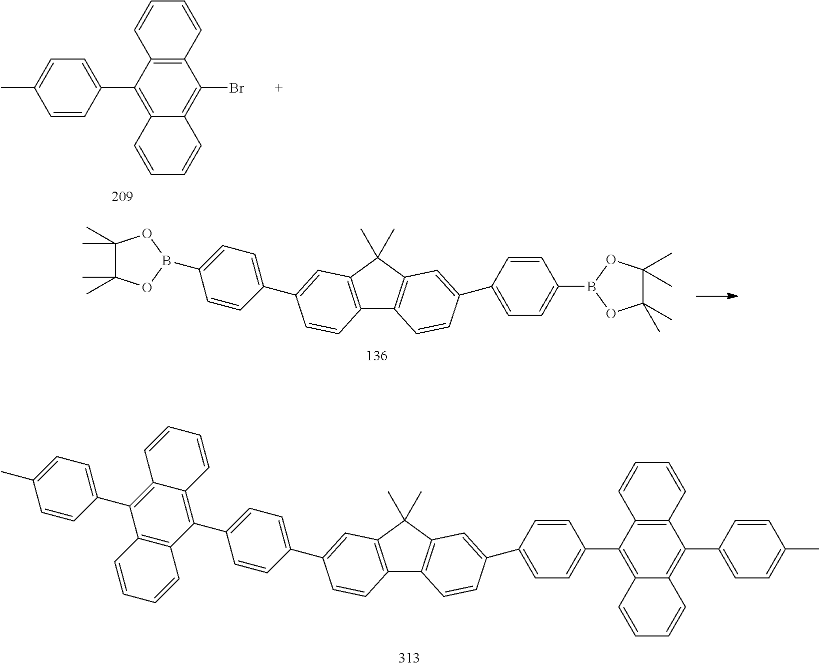

A reaction vessel was charged with Compound (209) (8.7 g, 24.9 mmol), Compound (136) (5 g, 8.3 mmol), tetrakis(triphenylphosphine)palladium (Pd(PPh₃)₄) (0.96 g, 0.8 mmol), aqueous 2.0 M potassium carbonate solution (24 mL), Aliquat 336 (0.5 mL, 0.8 mmol) and toluene (80 mL), and the mixture was stirred at 100° C. for 5 hours. The reaction mixture was cooled to ambient temperature, and extracted with dichloromethane (300 mL). The extract was washed with distilled water (200 mL), and dried over magnesium sulfate.

After distillation of dichloromethane under reduced pressure, the residue was recrystallized from methanol (200 mL). The solid was added to acetone (50 mL), and the mixture was boiled and then filtered, to obtain Compound (313) (4.7 g, 5.30 mmol, yield: 64%) as white powder.

¹H NMR (CDCl₃, 200 MHz): δ=1.65 (s, 6H), 2.35 (s, 6H) 7.12 (dd, 4H), 7.32-7.36 (m, 12H), 7.54 (dd, 8H), 7.60 (d, 2H), 7.63-7.65 (m, 8H), 7.75 (d, 2H), 7.89 (dd, 2H)

MS/FAB: 851.36 (found), 851.08 (calculated).

### Synthetic Example 14

### Synthesis of Compound (314)

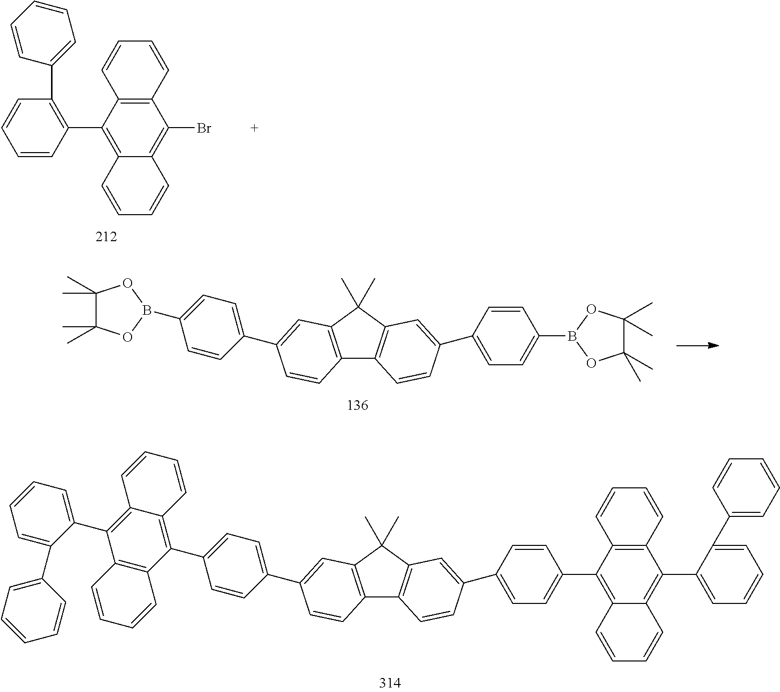

A reaction vessel was charged with Compound (212) (10.2 g, 24.9 mmol), Compound (136) (5 g, 8.3 mmol), tetrakis(triphenylphosphine)palladium (Pd(PPh₃)₄) (1.0 g, 0.8 mmol), aqueous 2.0 M potassium carbonate solution (24 mL), Aliquat 336 (0.5 mL, 0.8 mmol) and toluene (80 mL), and the mixture was stirred at 100° C. for 5 hours. The reaction mixture was cooled to ambient temperature, and extracted with dichloromethane (300 mL). The extract was washed with distilled water (100 mL), and dried over magnesium sulfate.

After distillation of dichloromethane under reduced pressure, the residue was recrystallized from methanol (100 mL). The solid was added to acetone (30 mL), and the mixture was boiled and then filtered. The procedure was further repeated twice to obtain Compound (314) (4.75 g, 4.73 mmol, yield: 57%) as white powder.

¹H NMR (CDCl₃, 200 MHz): δ=1.65 (s, 6H), 7.22 (t, 2H), 7.27-7.29 (m, 4H), 7.31-7.34 (m, 12H), 7.48 (dd, 4H), 7.52-7.57 (m, 12H), 7.6 (dd, 2H), 7.67-7.70 (m, 8H), 7.75 (dd, 2H), 7.90 (dd, 2H)

MS/FAB: 1002.42 (found), 1003.27 (calculated).

### Synthetic Example 15

### Synthesis of Compound (315)

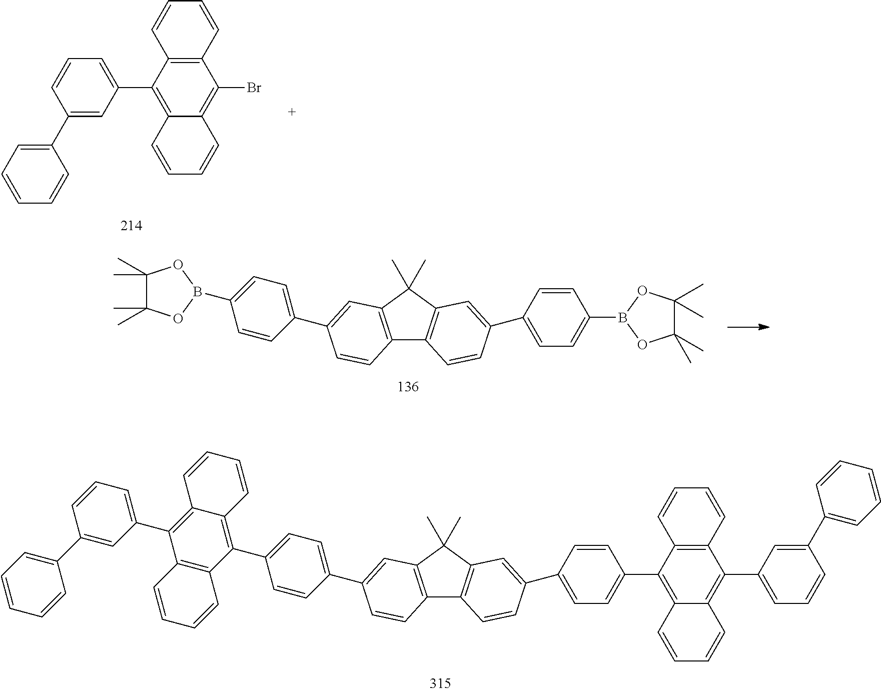

A reaction vessel was charged with Compound (214) (10.2 g, 24.9 mmol), Compound (136) (5 g, 8.3 mmol), tetrakis(triphenylphosphine)palladium (Pd(PPh₃)₄) (1.0 g, 0.83 mmol), aqueous 2.0 M potassium carbonate solution (24 mL), Aliquat 336 (0.46 mL, 0.8 mmol) and toluene (80 mL), and the mixture was stirred at 100° C. for 5 hours. The reaction mixture was cooled to ambient temperature, and extracted with dichloromethane (300 mL). The extract was washed with distilled water (100 mL), and dried over magnesium sulfate.

After distillation of dichloromethane under reduced pressure, the residue was recrystallized from methanol (100 mL). The solid was added to acetone (30 mL), and the mixture was boiled and then filtered. The procedure was further repeated twice to obtain Compound (315) (4.9 g, 4.89 mmol, yield: 59%) as white powder.

¹H NMR (CDCl₃, 200 MHz): δ=1.65 (s, 6H), 7.22 (t, 2H), 7.32 (m, 12H), 7.38 (t, 2H), 7.44 (m, 4H), 7.48 (m, 4H), 7.54 (dd, 8H), 7.67 (m, 8H), 7.60 (dd, 2H), 7.67 (m, 8H), 7.77 (dd, 2H), 7.70 (m, 2H), 7.90 (dd, 2H)

MS/FAB: 1004.42 (found), 1003.27 (calculated).

### Synthetic Example 16

### Synthesis of Compound (316)

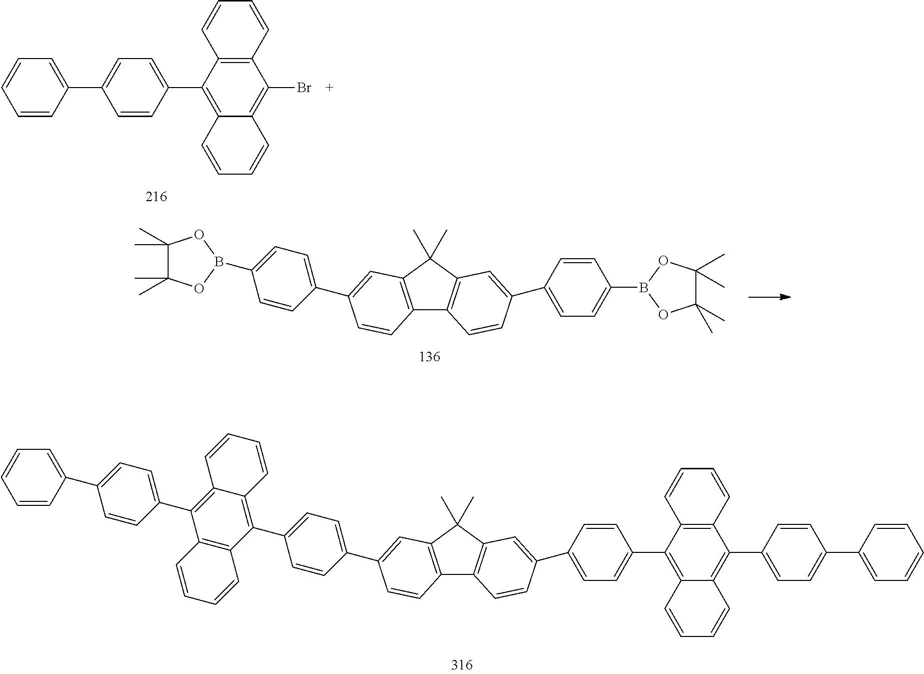

A reaction vessel was charged with Compound (216) (10.2 g, 24.9 mmol), Compound (136) (5 g, 8.3 mmol), tetrakis(triphenylphosphine)palladium (Pd(PPh₃)₄) (1.0 g, 0.8 mmol), aqueous 2.0 M potassium carbonate solution (24 mL), Aliquat 336 (0.5 mL, 0.8 mmol) and toluene (80 mL), and the mixture was stirred at 100° C. for 5 hours. The reaction mixture was cooled to ambient temperature, and extracted with dichloromethane (500 mL). The extract was washed with distilled water (200 mL), and dried over magnesium sulfate.

After distillation of dichloromethane under reduced pressure, the residue was recrystallized from methanol (100 mL). The solid was added to acetone (30 mL), and the mixture was boiled and then filtered under reduced pressure. The procedure was further repeated twice to obtain Compound (316) (4.9 g, 4.57 mmol, yield: 55%) as white powder.

¹H NMR (CDCl₃, 200 MHz): δ=1.65 (s, 6H), 7.2 (t, 2H), 7.29-7.35 (m, 12H), 7.46-7.48 (m, 4H), 7.53 (dd, 16H), 7.60 (dd, 2H), 7.65-7.67 (m, 8H), 7.65-7.67 (m, 8H), 7.75 (dd, 2H), 7.90 (dd, 2H)

MS/FAB: 1004.42 (found), 1003.27 (calculated).

### Synthetic Example 17

### Synthesis of Compound (317)

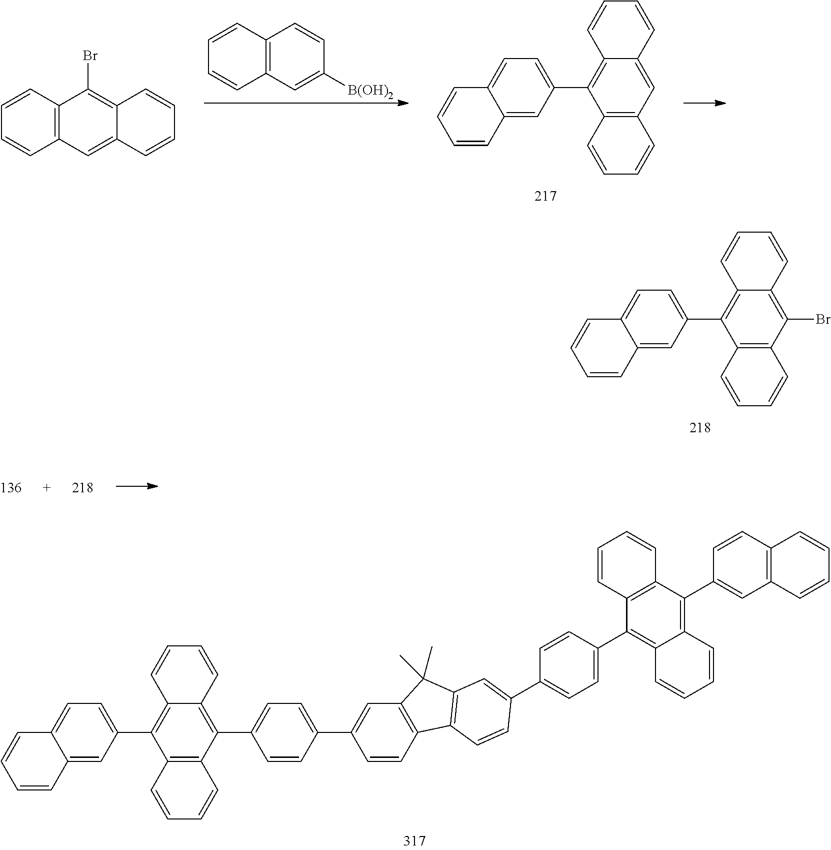

A reaction vessel was charged with 9-bromoanthracene (15 g, 58.3 mmol), 2-naphthaleneboronic acid (13.9 g, 75.8 mmol), tetrakis(triphenylphosphine)palladium (Pd(PPh₃)₄) (6.7 g, 5.83 mmol), aqueous 2.0 M sodium carbonate solution (380 mL), toluene (400 mL) and ethanol (200 mL), and the mixture was stirred under reflux for 12 hours. The reaction mixture was worked up according to the same procedure for Compound (201), to obtain Compound (217) (16.0 g, 52.6 mmol).

Compound (217) (16.0 g, 52.6 mmol) and N-bromosuccinimide (NBS) (9.3 g, 52.0 mmol) were dissolved in dichloromethane (500 mL). After stirring the solution at ambient temperature for 12 hours, dichloromethane was distilled off under reduced pressure to obtain solid. Washing the solid with methanol (200 mL) and drying gave compound (218) (17.0 g, 44.4 mmol).

A reaction vessel was charged with Compound (218) (9.5 g, 24.9 mmol), Compound (136) (5 g, 8.3 mmol), tetrakis(triphenylphosphine)palladium (Pd(PPh₃)₄) (0.96 g, 0.83 mmol), aqueous 2.0 M potassium carbonate solution (24 mL), Aliquat 336 (0.46 mL, 0.8 mmol) and toluene (80 mL), and the mixture was stirred at 100° C. for 5 hours. The reaction mixture was cooled to ambient temperature, and extracted with dichloromethane (300 mL). The extract was washed with distilled water (200 mL), and dried over magnesium sulfate.

After distillation of dichloromethane under reduced pressure, the residue was recrystallized from methanol (100 mL). The solid was added to acetone (30 mL), and the mixture was boiled and then filtered under reduced pressure. The procedure was further repeated twice to obtain Compound (317) (4.8 g, 5.1 mmol, yield: 67%) as white powder.

¹H NMR (CDCl₃, 200 MHz): δ=1.65 (s, 6H), 7.31-7.33 (m, 12H), 7.53-7.55 (m, 10H), 7.60 (d, 2H), 7.62-7.67 (m, 12H), 7.73 (dd, 2H), 7.77 (dd, 2H), 7.89 (t, 2H) 7.90 (dd, 2H)

MS/FAB: 952.40 (found), 951.2 (calculated).

### Synthetic Example 18

### Synthesis of Compound (318)

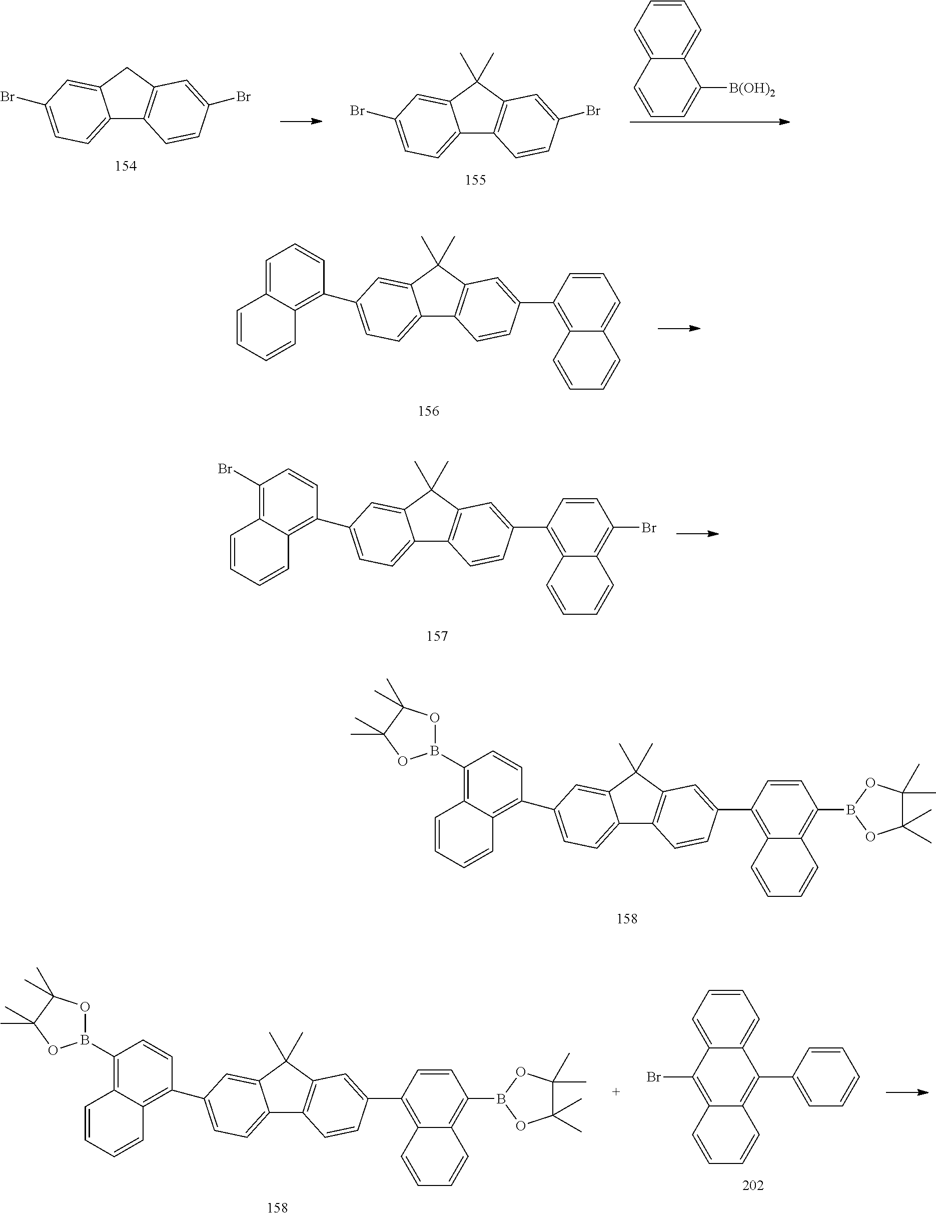

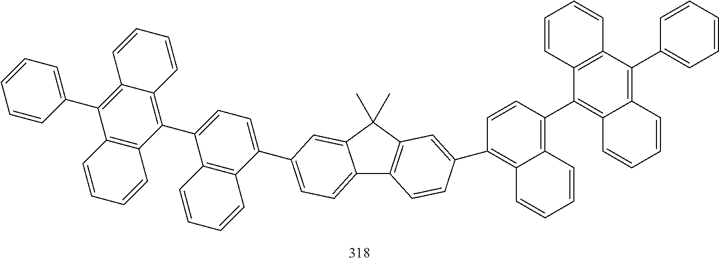

In dimethylsulfoxide (DMSO) (150 mL), added were 2,7-dibromofluorene (15.0 g, 46.3 mmol) and potassium hydroxide (KOH) (15.6 g, 277.7 mmol), and iodomethane (10.08 mL, 162.0 mmol) was added thereto at 10° C. After stirring at 30° C. for 12 hours, the reaction mixture was added to distilled water (300 mL). The solid produced was filtered under reduced pressure, and washed with methanol (100 mL) and hexane (50 mL) to obtain Compound (155) (15.2 g, 43.2 mmol).

A reaction vessel was charged with Compound (155) (15.2 g, 43.2 mmol), naphthaleneboronic acid (18.6 g, 10.8 mmol), PdCl₂(PPh₃)₂ (3.0 g, 4.31 mmol), sodium carbonate (22.9 g, 215.8 mmol, aqueous 2 M solution), toluene (300 mL) and ethanol (100 mL). After stirring the mixture at 100° C. for 12 hours, the mixture was cooled to ambient temperature. The reaction mixture was extracted with dichloromethane (1500 mL), and the extract was washed with distilled water (700 mL).

After drying over magnesium sulfate, and distillation under reduced pressure, the solid obtained was recrystallized from methanol (300 mL) and n-hexane (300 mL) to obtain Compound (156) (11.5 g, 25.8 mmol).

Compound (156) (11.5 g, 25.8 mmol) was dissolved in dichloromethane (100 mL), and solution of bromine (2.9 mL, 56.7 mmol) dissolved in dichloromethane (30 mL) was slowly added dropwise thereto at −5° C. The mixture was stirred at 0° C. for 2 hours, and then at 25° C. for 12 hours. After neutralization by using aqueous potassium hydroxide (KOH) solution (40 mL), the organic layer was extracted with dichloromethane (1500 mL). The extract was dried over magnesium sulfate and distilled under reduced pressure. Washing with n-hexane (300 mL) gave Compound (157) (10.2 g, 16.9 mmol).

Compound (157) (10.2 g, 16.9 mmol) was dissolved in tetrahydrofuran (140 mL), and n-BuLi (1.6 M in hexane) (26 mL, 42.2 mmol) was slowly added thereto at −78° C. After stirring for 30 minutes, 2-isopropoxy-4,4,5,5-tetramethyl-1,3,2 dioxyborolane (10.3 mL, 50.6 mmol) was added to the mixture at −78° C. The resultant mixture was stirred at ambient temperature for 18 hours, after slowly raising the temperature.

The organic layer was extracted with dichloromethane (2000 mL), washed with distilled water (800 mL), dried over magnesium sulfate and distilled under reduced pressure. The solid obtained was washed with methanol (200 mL) and hexane (200 mL) to provide Compound (158) (6.0 g, 8.6 mmol).

Compound (158) (3.0 g, 4.3 mmol), Compound (202) (3.57 g, 10.7 mmol), tetrakis(triphenylphosphine)palladium (Pd(PPh₃)₄) (0.5 g, 0.4 mmol), aqueous 1.0 M potassium carbonate solution (22 mL), Aliquat 336 (0.5 mL, 0.9 mmol) and toluene (60 mL) were suspended, and the suspension was stirred at 100° C. for 6 hours and cooled to ambient temperature. The organic layer was extracted with dichloromethane (2000 mL), and the extract was washed with distilled water (1000 mL). Drying over magnesium sulfate and distillation under reduced pressure gave solid, which was then recrystallized from acetone (100 mL), ethyl acetate (100 mL) and tetrahydrofuran (50 mL) to obtain Compound (318) (1.4 g, 1.5 mmol, yield: 34%).

¹H NMR (CDCl₃, 200 MHz): δ=1.65 (s, 6H), 7.21 (t, 2H), 7.30-7.32 (m, 16H), 7.48 (d, 4H), 7.58-7.60 (m, 6H), 7.67-7.68 (m, 12H) , , , 7.78 (s, 2H), 7.90 (d, 2H)

MS/FAB: 950.39 (found), 951.2 (calculated).

### Synthetic Example 19

### Synthesis of Compound (319)

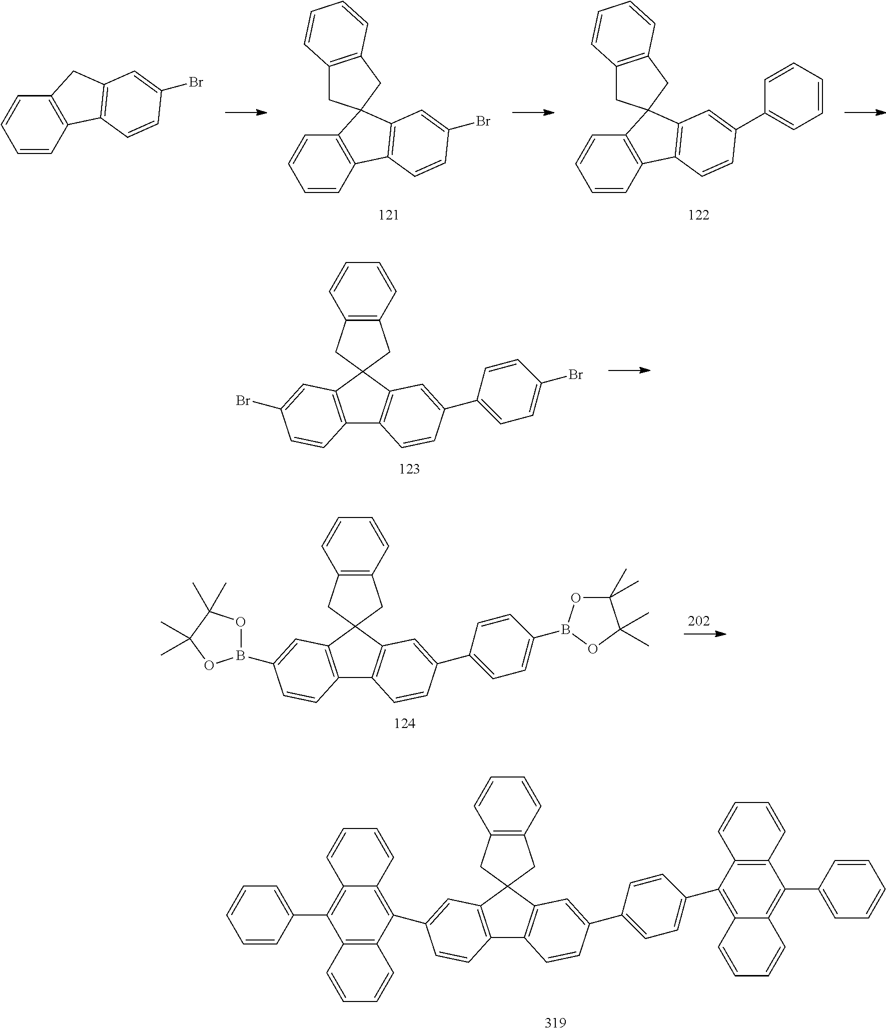

Potassium t-butoxide (K-t-BuO) (9 g, 0.5 mol) was dissolved in tetrahydrofuran (500 mL), and a solution of 2-bromofluorene (46.6 g, 0.2 mol) and 1,2-bis(bromomethyl)benzene (50.2 g, 0.2 mol) dissolved in tetrahydrofuran (300 mL) was added thereto at 0° C. After stirring at 25° C. for 2 hours, distilled water was added thereto.

The reaction mixture was extracted from dichloromethane (400 mL), and the extract was washed with distilled water (200 mL) and dried over magnesium sulfate. Distillation under reduced pressure and purification via silica column chromatography (n-hexane: dichloromethane=15:1) gave Compound (121) (20.0 g, 57 mmol).

A reaction vessel was charged with Compound (121) (20.0 g, 57 mmol), phenylboronic acid (9.1 g, 78 mmol), PdCl₂(PPh₃)₂ (4 g, 5.7 mmol), aqueous 2 M sodium carbonate solution (150 mL), toluene (300 mL) and ethanol (100 mL), and the mixture was stirred at 100° C. for 12 hours. The reaction mixture was worked up according to the same procedure for synthesis of Compound (102) to obtain Compound (122) (15 g, 43 mmol).

Compound (122) (15 g, 95 mmol) was dissolved in dichloromethane (100 mL), and solution of bromine (4.9 mL, 95 mmol) dissolved in dichloromethane (35 mL) was slowly added thereto at −5° C. The mixture was stirred at 0° C. for 2 hours, and then at 25° C. for 12 hours. After neutralization by using aqueous potassium hydroxide (KOH) solution, the organic layer was extracted with dichloromethane (200 mL). The extract was dried over magnesium sulfate and distilled under reduced pressure. Washing the solid obtained with methanol (40 mL) and n-hexane (50 mL), and purification via silica column chromatography (n-hexane: dichloromethane=25:1) gave Compound (123) (11 g, 22 mmol).

Compound (123) (11 g, 22 mmol) was dissolved in tetrahydrofuran (100 mL), and n-BuLi (1.6 M in n-hexane) (34.2 mL, 54 mmol) was slowly added dropwise thereto at −78° C. After stirring for 30 minutes, 2-isopropoxy-4,4,5,5-tetramethyl-1,3,2-dioxyborolane (10.8 mL, 53 mmol) was added to the mixture at −78° C. The resultant mixture was stirred at 25° C. for 24 hours, after slowly raising the temperature. The reaction was quenched by adding distilled water (100 mL), and the organic layer was extracted with dichloromethane (500 mL), washed with distilled water (200 mL), dried over magnesium sulfate and distilled under reduced pressure. The solid obtained was washed with methanol (45 mL) and n-hexane (37 mL), filtered under reduced pressure, and dried under reduced pressure to provide Compound (124) (4.6 g, 7 mmol).

Compound (124) (3.0 g, 5 mmol), Compound (202) (4.2 g, 12.6 mmol), tetrakis(triphenylphosphine)palladium (Pd(PPh₃)₄) (0.6 g, 0.5 mmol), aqueous 1.0 M potassium carbonate solution (25 mL), Aliquat 336 (0.6 mL, 1.1 mmol) and toluene (60 mL) were mixed, and the mixture was stirred at 100° C. for 6 hours and then cooled to 25° C. The organic layer was extracted with dichloromethane (400 mL), and the extract was washed with distilled water (300 mL). Drying over magnesium sulfate and distillation under reduced pressure gave solid, which was then recrystallized from acetone (28 mL), ethyl acetate (45 mL) and tetrahydrofuran (60 mL) to obtain Compound (319) (1.1 g, 1.3 mmol, yield: 26%).

¹H NMR (200 MHz, CDCl₃): δ=3.37 (d, 2H), 3.62 (d, 2H), 7.20-7.23 (m, 6H), 7.30-7.36 (m, 12H), 7.46-7.49 (m, 4H), 7.53-7.55 (m, 4H), 7.59-7.61 (m, 2H), 7.65-7.69 (m, 8H), 7.77 (d, 2H), 7.90-7.92 (d, 2H)

MS/FAB: 848 (found), 849.06 (calculated).

### Synthetic Example 20

### Synthesis of Compound (320)

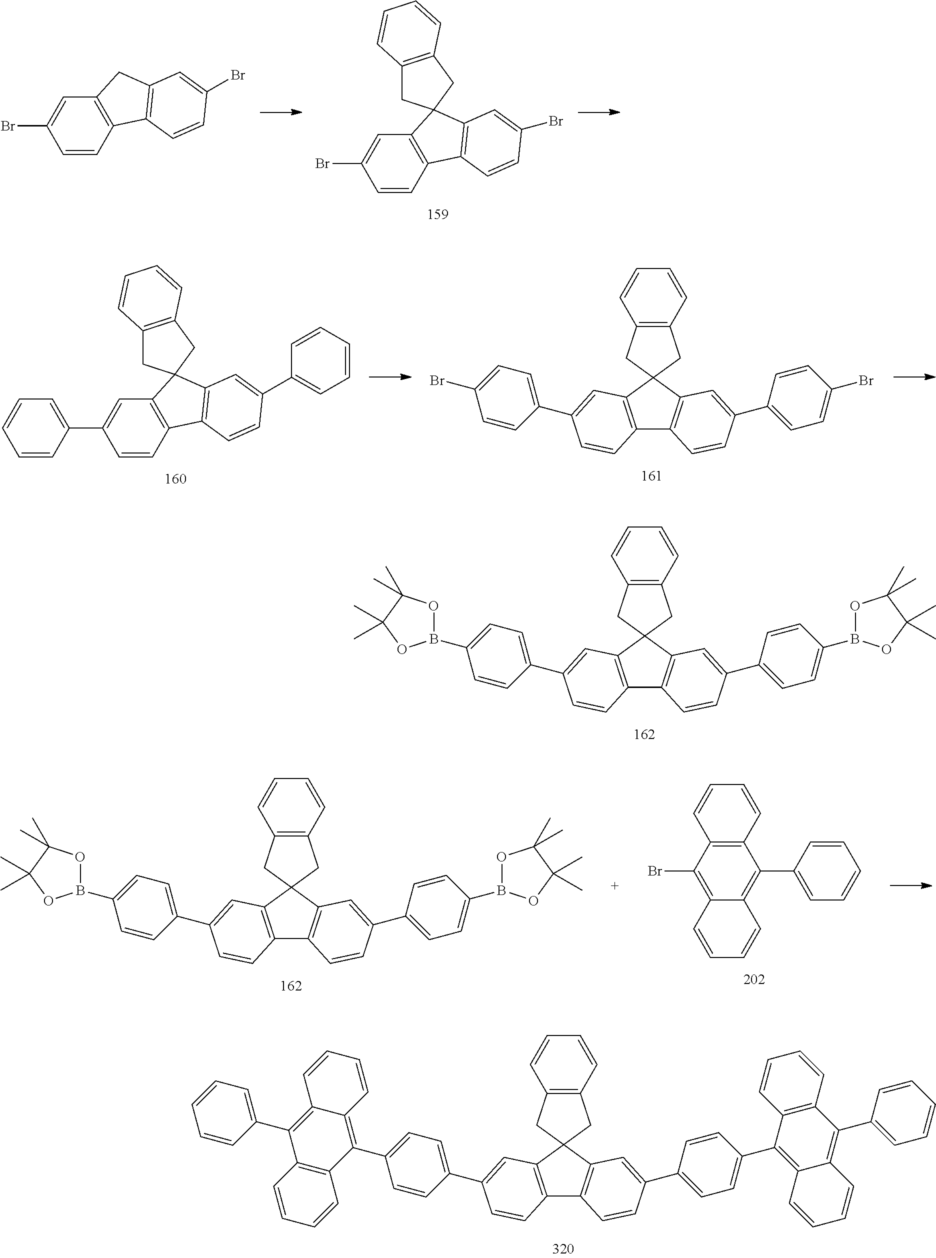

Potassium t-butoxide (K^{t}Obu) (53.3 g, 500 mmol) was dissolved in tetrahydrofuran (500 mL), and a solution of 2,7-dibromofluorene (61.5 g, 200 mmol) and 1,2-bis(bromomethyl)benzene (50.2 g, 190 mmol) dissolved in tetrahydrofuran (400 mL) was added thereto at 0° C. After stirring at ambient temperature for 2 hours, distilled water (100 mL) was added thereto. The reaction mixture was extracted from dichloromethane (2000 mL), and the extract was washed with distilled water (1000 mL) and dried over magnesium sulfate. Distillation under reduced pressure and purification via silica column chromatography (ethyl acetate: n-hexane=1:30) gave Compound (159) (34.0 g, 79 mmol).

A reaction vessel was charged with Compound (159) (34.0 g, 79 mmol), phenylboronic acid (24.1 g, 197 mmol), PdCl₂(PPh₃)₂ (5.5 g, 7.9 mmol), aqueous 2 M sodium carbonate solution (4000 mL), toluene (500 mL) and ethanol (100 mL), and the mixture was stirred at 100° C. for 12 hours. The reaction mixture was worked up according to the same procedure for synthesis of Compound (102) to obtain Compound (160) (27 g, 64 mmol).

Compound (160) (27 g, 64 mmol) was dissolved in dichloromethane (150 mL), and solution of bromine (6.6 mL, 128 mmol) dissolved in dichloromethane (50 mL) was slowly added thereto at −5° C. The mixture was stirred at 0° C. for 2 hours, and then at 25° C. for 12 hours. After neutralization by using aqueous potassium hydroxide (KOH) solution, the organic layer was extracted with dichloromethane (2000 mL). The extract was washed with distilled water (2000 mL), dried over magnesium sulfate and distilled under reduced pressure. Washing the solid obtained with methanol (200 mL) and n-hexane (200 mL), and purification via silica gel column chromatography (dichloromethane: hexane=1:15) gave Compound (161) (13.6 g, 23 mmol).

Compound (161) (13.6 g, 23 mmol) was dissolved in tetrahydrofuran (100 mL), and n-BuLi (1.6 M in hexane) (36.7 mL, 58 mmol) was slowly added thereto at −78′ After stirring for 30 minutes, 2-isopropoxy-4,4,5,5-tetramethyl-1,3,2-dioxyborolane (14.4 mL, 70 mmol) was added to the mixture at −78° C. The resultant mixture was stirred at ambient temperature for 19 hours, after slowly raising the temperature. The reaction was quenched by adding distilled water (50 mL), and the organic layer was extracted with dichloromethane (1500 mL), washed with distilled water (1000 mL), dried over magnesium sulfate and distilled under reduced pressure. The solid obtained was washed with methanol (300 mL) and n-hexane (300 mL) to provide Compound (162) (6.5 g, 9 mmol).

Compound (162) (3.0 g, 4.5 mmol), Compound (202) (4.2 g, 11.2 mmol), tetrakis(triphenylphosphine)palladium (Pd(PPh₃)₄) (0.51 g, 0.4 mmol), aqueous 1.0 M potassium carbonate solution (22 mL), Aliquat 336 (0.5 mL, 0.9 mmol) and toluene (60 mL) were mixed, and the mixture was stirred at 100° C. for 6 hours and cooled to ambient temperature. The organic layer was extracted with dichloromethane (1000 mL), and the extract was washed with distilled water (500 mL). Drying over magnesium sulfate and distillation under reduced pressure gave solid, which was then recrystallized from acetone (100 mL), ethyl acetate (100 mL) and tetrahydrofuran (50 mL) to obtain Compound (320) (1.0 g, 1.1 mmol, yield: 24%).

¹H NMR (CDCl₃, 200 MHz): δ=3.45 (s, 4H), 7.20-3.22 (m, 6H), 7.32 (m, 12H), 7.46 (d, 4H), 7.55 (d, 8H), 7.60 (d, 2H), 7.68 (d, 8H), 7.78 (s, 2H), 7.90 (d, 2H)

MS/FAB: 924.38 (found), 925.16 (calculated).

### Synthetic Example 21

### Synthesis of Compound (321)

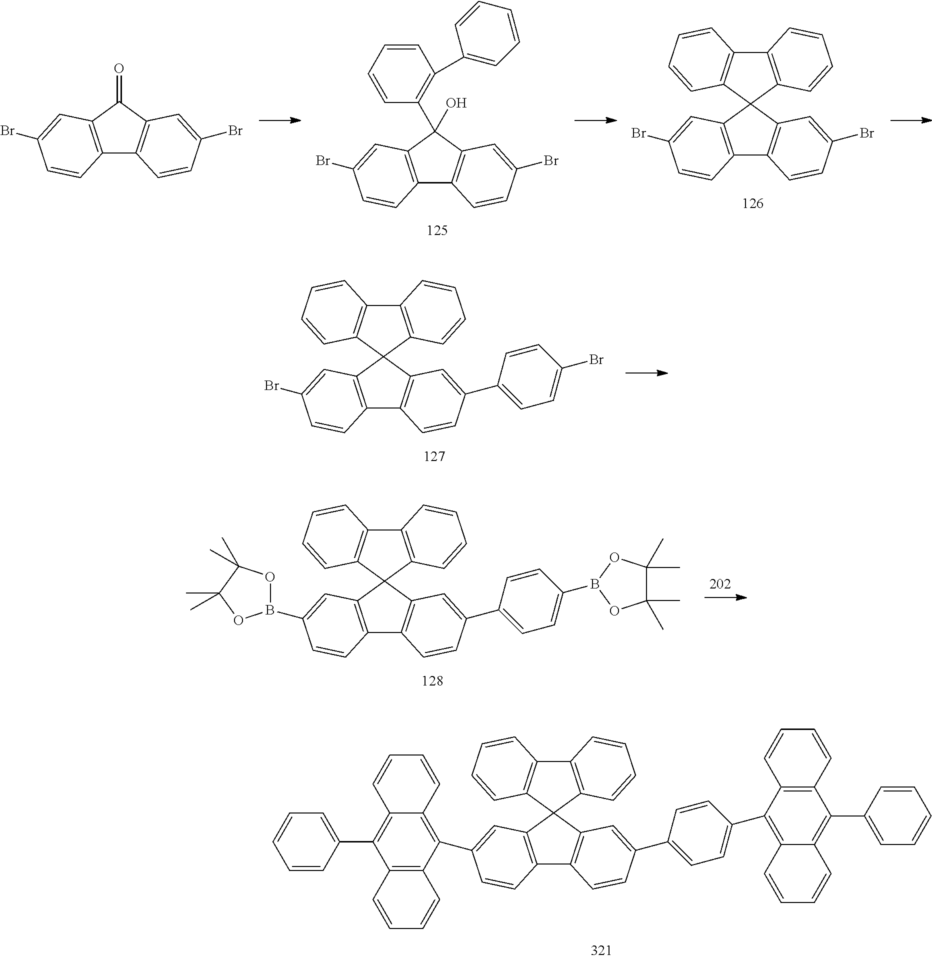

Diethyl ether (10 mL) was added to magnesium (1.9 g, 25.6 mmol), and 2-bromobiphenyl (5 g, 21.6 mmol) diluted in diethyl ether (20 mL) was slowly added dropwise, and the mixture was stirred under reflux for 3 hours. In diethyl ether (40 mL), dissolved was 2,7-dibromofluorenone (6.7 g, 20 mmol), and the solution was added to the mixture previously prepared. The resultant mixture was stirred under reflux for 12 hours, and cooled to ambient temperature. The precipitate produced was filtered under reduced pressure, and dissolved in acetic acid (40 mL). While heating the solution under reflux, concentrated hydrochloric acid was slowly added dropwise thereto. After four hours, the reaction was completed to give Compound (126) (5.2 g, 10.9 mmol).

Compound (126) (10 g, 21.08 mmol), 4-bromophenylboronic acid (4.23 g, 21.1 mmol), tetrakis(triphenylphosphine)palladium (Pd(PPh₃)₄) (2.43 g, 21.1 mmol), aqueous 1.0 M potassium carbonate solution (105 mL) and diethyleneglycol (DME) (100 mL) were mixed, and the mixture was stirred at 80° C. under reflux for 12 hours. After cooling to ambient temperature, the organic layer was extracted with dichloromethane (200 mL), and the extract was washed with distilled water (200 mL), dried over magnesium sulfate, and distilled under reduced pressure. Purification via silica gel column chromatography (n-hexane: dichloromethane=7:1) gave Compound (127) (2.4 g, 4.4 mmol).

Compound (127) (2.4 g, 4.4 mmol) was dissolved in tetrahydrofuran (50 mL), and n-BuLi (1.6 M in hexane) (6.8 mL, 10.1 mmol) was slowly added thereto at −78° C. After stirring for 30 minutes, 2-isopropoxy-4,4,5,5-tetramethyl-1,3,2 dioxyborolane (2.66 mL, 13.1 mmol) was added to the mixture at −78° C. The resultant mixture was stirred at ambient temperature for one day, after slowly raising the temperature. The reaction was quenched by adding distilled water (30 mL), and the organic layer was extracted with dichloromethane (200 mL).

The extract was washed with distilled water (200 mL), dried over magnesium sulfate and distilled under reduced pressure. The solid obtained was washed with methanol (100 mL) and n-hexane (100 mL), filtered under reduced pressure and dried under reduced pressure to provide Compound (128) (2.0 g, 3.1 mmol).

Compound (128) (2.0 g, 3.1 mmol), Compound (202) (2.6 g, 7.8 mmol), tetrakis(triphenylphosphine)palladium (Pd(PPh₃)₄) (0.4 g, 0.3 mmol), aqueous 1.0 M potassium carbonate solution (16 mL), Aliquat 336 (0.34 mL, 0.6 mmol) and toluene (40 mL) were mixed together, and the mixture was stirred at 100° C. for 6 hours. After cooling to ambient temperature, the organic layer was extracted with dichloromethane (250 mL), and the extract was washed with distilled water (200 mL). Drying over magnesium sulfate and distillation under reduced pressure gave solid, which was then recrystallized from acetone (30 mL), ethyl acetate (30 mL), and tetrahydrofuran (20 mL) to obtain Compound (321) (0.8 g, 0.9 mmol, yield: 29%).

¹H NMR (200 MHz, CDCl₃): δ=7.16-7.22 (m, 6H), 7.31-7.36 (m, 14H), 7.46-7.50 (m, 4H), 7.53-7.55 (m, 4H), 7.59-7.61 (m, 2H), 7.65-7.69 (m, 8H), 7.71-7.73 (m, 2H), 7.77 (d, 2H), 7.90-7.92 (d, 2H)

MS/FAB: 896 (found), 897.10 (calculated).

### Synthetic Example 22

### Synthesis of Compound (322)

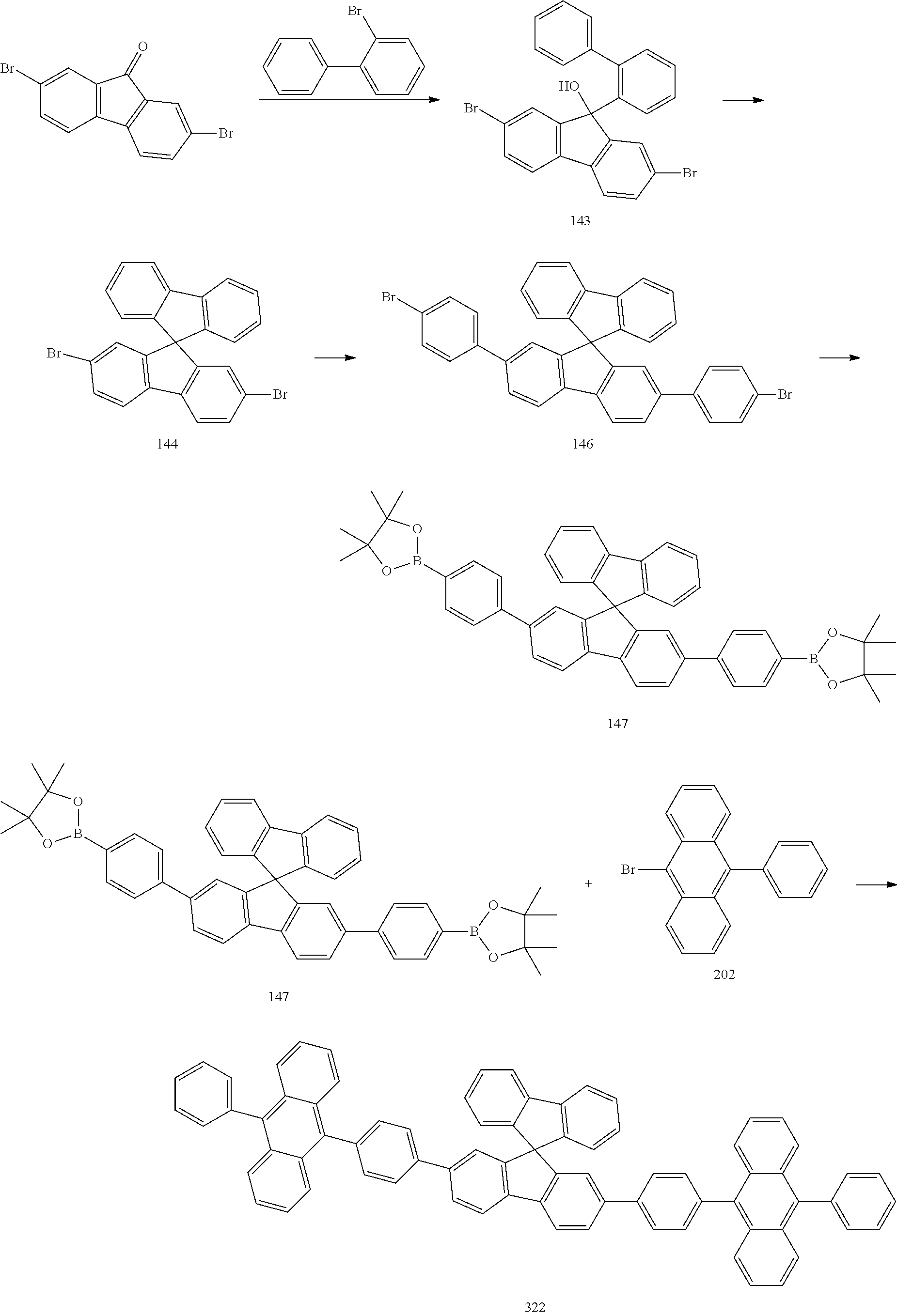

Diethyl ether (10 mL) was added to magnesium (1.9 g, 25.6 mmol), and 2-bromobiphenyl (5 g, 21.6 mmol) diluted in diethyl ether (20 mL) was slowly added dropwise, and the mixture was stirred under reflux for 3 hours. In diethyl ether (40 mL), dissolved was 2,7-dibromofluorenone (6.7 g, 20 mmol), and the solution was added to the mixture previously prepared. The resultant mixture was stirred under reflux for 12 hours, and cooled to ambient temperature. The precipitate produced was filtered under reduced pressure, and dissolved in acetic acid (40 mL). While heating the solution under reflux, concentrated hydrochloric acid was slowly added dropwise thereto. After four hours, the reaction was completed to give Compound (144) (5.2 g, 10.9 mmol).

Compound (144) (10 g, 21.1 mmol), 4-bromophenylboronic acid (4.2 g, 42.2 mmol), tetrakis(triphenylphosphine)palladium 1.0 (Pd(PPh₃)₄) (2.4 g, 2.1 mmol), aqueous 2.0 M potassium carbonate solution (105 mL) and diethyleneglycol (100 mL) were suspended, and the suspension was stirred at 80° C. under reflux for 12 hours. After cooling to ambient temperature, the organic layer was extracted with dichloromethane (700 mL), and the extract was washed with distilled water (400 mL), dried over magnesium sulfate, and distilled under reduced pressure. Purification via silica column chromatography (n-hexane:dichloromethane=7:1) gave Compound (146) (2.7 g, 4.4 mmol).

Compound (146) (2.7 g, 4.4 mmol) was dissolved in tetrahydrofuran (50 mL), and n-BuLi (1.6 M in hexane) (6.8 mL, 10.1 mmol) was slowly added thereto at −78° C. After stirring for 30 minutes, 2-isopropoxy-4,4,5,5-tetramethyl-1,3,2-dioxyborolane (2.66 mL, 13.1 mmol) was added to the mixture at −78° C. The resultant mixture was stirred at ambient temperature for one day, after slowly raising the temperature. The reaction was quenched by adding distilled water (20 mL), and the organic layer was extracted with dichloromethane (500 mL).

The extract was washed with distilled water (200 mL), dried over magnesium sulfate and distilled under reduced pressure. The solid obtained was washed with methanol (100 mL) and n-hexane (100 mL) to provide Compound (147) (2.2 g, 3.1 mmol).

Compound (147) (2.2 g, 3.1 mmol), Compound (202) (2.6 g, 7.8 mmol), tetrakis(triphenylphosphine)palladium (Pd(PPh₃)₄) (0.35 g, 0.3 mmol), aqueous 1.0 M potassium carbonate solution (16 mL), Aliquat 336 (0.3 mL, 0.6 mmol) and toluene (40 mL) were mixed together, and the mixture was stirred at 100° C. for 6 hours. After cooling to ambient temperature, the organic layer was extracted with dichloromethane (500 mL), and the extract was washed with distilled water (300 mL). Drying over magnesium sulfate and distillation under reduced pressure gave solid, which was then recrystallized from acetone (50 mL), ethyl acetate (50 mL), and tetrahydrofuran (30 mL) to obtain Compound (322) (0.9 g, 1.0 mmol, yield: 32%).

¹H NMR (CDCl₃, 200 MHz): δ 7.04-7.08 (m, 6H), 7.15 (t, 4H), 7.20 (t, 2H), 7.30 (t, 12H), 7.45-7.55 (m, 12H), 7.60-7.69 (m, 10H), 7.79 (d, 2H), 7.89 (d, 2H)

MS/FAB: 974.39 (found), 975.22 (calculated).

### Synthetic Example 23

### Synthesis of Compound (323)

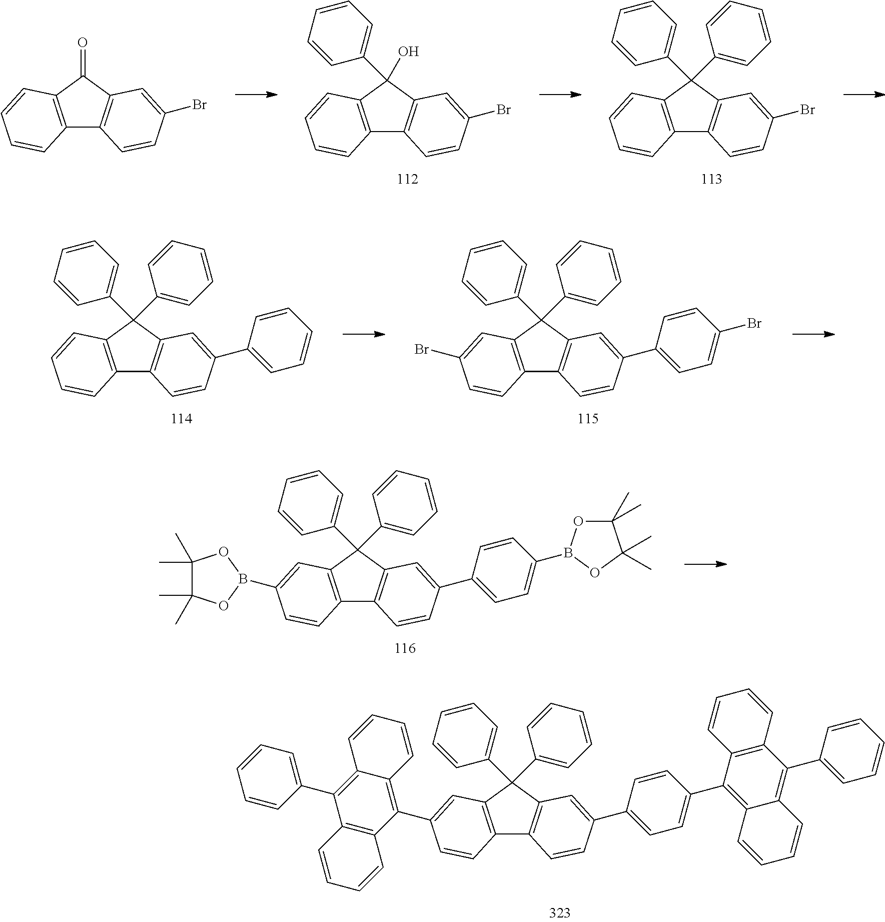

Diethyl ether (50 mL) was added to magnesium (4.9 g, 200 mmol), and bromobenzene (31.4 g, 200 mmol) diluted in diethyl ether (150 mL) was slowly added dropwise thereto, and the mixture was stirred under reflux for 4 hours. In diethyl ether (40 mL), dissolved was 2-bromofluorenone (25.9 g, 100 mmol), and the solution was added to the Grignard solution previously prepared. The resultant mixture was stirred under reflux for hours. The precipitate produced was filtered to obtain Compound (112) (15 g, 36 mmol), which was then dissolved in benzene (145 mL). While heating the solution, trifluoromethanesulfonic acid (6.6 mL, 72 mmol) was slowly added dropwise. After 30 minutes, the reaction mixture was added to cold saturated aqueous sodium carbonate solution (400 mL). The organic layer was extracted with ethyl acetate (370 mL), and the extract was washed with distilled water (350 mL), dried over magnesium sulfate, and distilled under reduced pressure to obtain Compound (113) (15.3 g, 38.5 mmol).

A vessel was charged with Compound (113) (23.0 g, 58 mmol), phenylboronic acid (10.6 g, 87 mmol), PdCl₂(PPh₃)₂ (4.1 g, 5.8 mmol), aqueous 2 M sodium carbonate solution (150 mL), toluene (300 mL) and ethanol (100 mL), and the mixture was stirred at 100° C. for 12 hours. The reaction mixture was worked up according to the same procedure for synthesis of Compound (102) to obtain Compound (114) (11 g, 32 mmol).

Compound (114) (4.7 g, 12 mmol) was dissolved in dichloromethane (60 mL), and solution of bromine (1.4 mL, 27 mmol) dissolved in dichloromethane (15 mL) was slowly added thereto at −5° C. The mixture was stirred at 0° C. for 2 hours, and then at 25° C. for 12 hours. After neutralization by using aqueous potassium hydroxide (KOH) solution (30 mL), the organic layer was extracted with dichloromethane (240 mL). The extract was dried over magnesium sulfate and distilled under reduced pressure. Washing the residual solid with methanol (50 mL) and n-hexane (50 mL), and purification via silica column chromatography (n-hexane: dichloromethane=5:1) gave Compound (115) (5.5 g, 10 mmol).

Compound (115) (10.9 g, 19.8 mmol) was dissolved in tetrahydrofuran (100 mL), and n-BuLi (1.6 M in hexane) (32.3 mL, 51.6 mmol) was slowly added thereto at −78° C. After stirring for 30 minutes, 2-isopropoxy-4,4,5,5-tetramethyl-1,3,2-dioxyborolane (12.2 mL, 59 mmol) was added to the mixture at −78° C. The resultant mixture was stirred at 25° C. for 18 hours, after slowly raising the temperature. The reaction was quenched by adding distilled water (50 mL), and the organic layer was extracted with dichloromethane (300 mL), washed with distilled water (300 mL), dried over magnesium sulfate and distilled under reduced pressure. The solid obtained was washed with methanol (200 mL) and n-hexane (200 mL) and dried under reduced pressure to provide Compound (116) (6.9 g, 10 mmol).

Compound (116) (3.3 g, 5.2 mmol), Compound (202) (5.2 g, 15.5 mmol), tetrakis(triphenylphosphine)palladium (Pd(PPh₃)₄) (0.6 g, 0.5 mmol), aqueous 1.0 M potassium carbonate solution (26 mL), Aliquat 336 (0.6 mL, 1 mmol) and toluene (80 mL) were mixed together, and the mixture was stirred at 100° C. for 4 hours and cooled to 25° C. The organic layer was extracted with dichloromethane (300 mL), and the extract was washed with distilled water (300 mL). Drying over magnesium sulfate and distillation under reduced pressure gave solid, which was then recrystallized from acetone (300 mL), ethyl acetate (300 mL) and tetrahydrofuran (270 mL) to obtain Compound (323) (2.4 g, 2.7 mmol, yield: 52°).

¹H NMR (200 MHz, CDCl₃): δ=7.04-7.15 (m, 10H), 7.21-7.23 (m, 2H), 7.30-7.36 (m, 12H), 7.46-7.49 (m, 4H), 7.53-7.55 (m, 4H), 7.59-7.61 (m, 2H), 7.65-7.69 (m, 8H), 7.77 (d, 2H), 7.90-7.92 (d, 2H)

MS/FAB: 899.67 (found), 899.12 (calculated).

### Synthetic Example 24

### Synthesis of Compound (324)

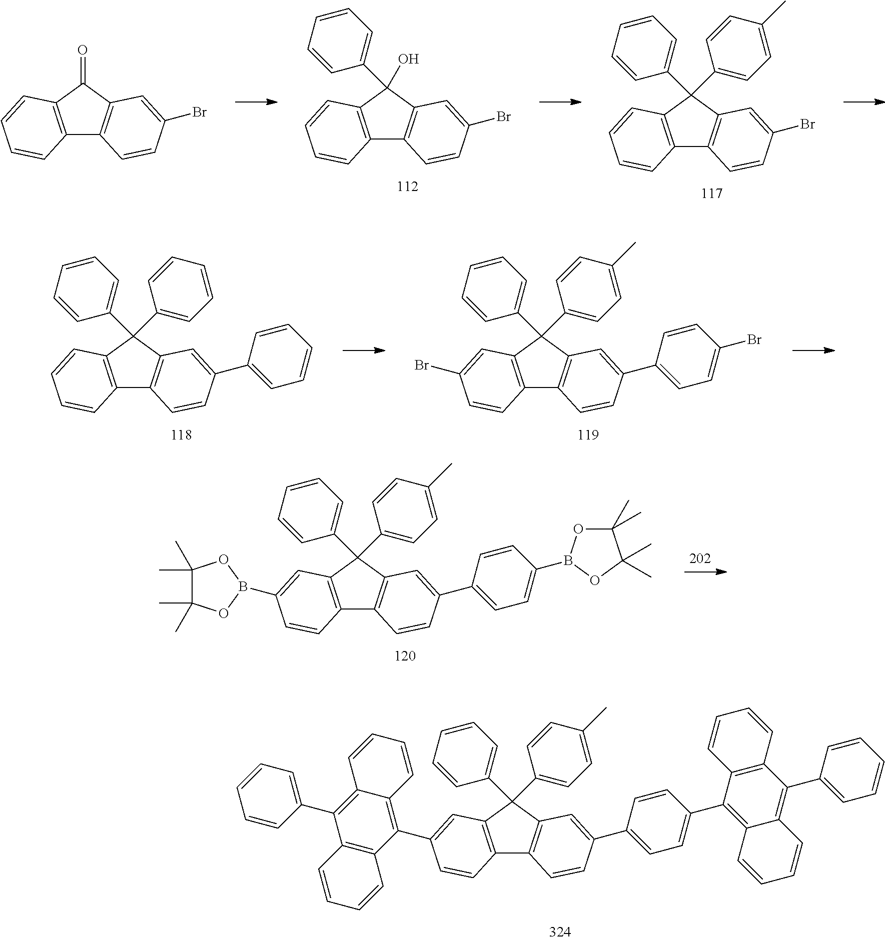

Diethyl ether (50 mL) was added to magnesium (4.9 g, 200 mmol), and bromobenzene (31.4 g, 200 mmol) diluted in diethyl ether (150 mL) was slowly added dropwise thereto, and the mixture was stirred under reflux for 3 hours. In diethyl ether (40 mL), dissolved was 2-bromofluorenone (25.9 g, 100 mmol), and the solution was added to the Grignard solution previously prepared. The resultant mixture was stirred under reflux for 12 hours. The precipitate produced was filtered to obtain Compound (112) (15 g, 36 mmol), which was then dissolved in toluene solvent (145 mL). While heating the solution, trifluoromethanesulfonic acid (6.6 mL, 72 mmol) was slowly added dropwise. After 30 minutes, the reaction mixture was added to cold saturated aqueous sodium carbonate solution (40 mL). The organic layer was extracted with ethyl acetate (350 mL), and the extract was washed with distilled water (400 mL), dried over magnesium sulfate, and distilled under reduced pressure to obtain Compound (117) (14.5 g, 35.25 mmol).

A vessel was charged with Compound (117) (23.0 g, 580 mmol), phenylboronic acid (10.6 g, 870 mmol), PdCl₂(PPh₃)₂ (4.1 g, 58 mmol), aqueous 2 M sodium carbonate solution (150 mL), toluene (300 mL) and ethanol (100 mL), and the mixture was stirred at 100° C. for 12 hours. The reaction mixture was worked up according to the same procedure for synthesis of Compound) (102) to obtain Compound (118) (17.5 g, 42 mmol).

Compound (118) (10 g, 24 mmol) was dissolved in dichloromethane (80 mL), and solution of bromine (2.8 mL, 53 mmol) dissolved in dichloromethane (25 mL) was slowly added thereto at −5° C. The mixture was stirred at 0° C. for 2 hours, and then at 25° C. for 12 hours. After neutralization by using aqueous potassium hydroxide (KOH) solution (30 mL), the organic layer was extracted with dichloromethane (300 mL). The extract was dried over magnesium sulfate and distilled under reduced pressure. Washing the residual solid with methanol (100 mL) and n-hexane (100 mL), and purification via silica gel column chromatography (n-hexane: dichloromethane=7:1) gave Compound (119) (12.4 g, 22 mmol).

Compound (119) (10 g, 17 mmol) was dissolved in tetrahydrofuran (100 mL), and n-BuLi (1.6 M in n-hexane) (27.6 mL, 44 mmol) was slowly added thereto at −781: After stirring for 30 minutes, 2-isopropoxy-4,4,5,5-tetramethyl-1,3,2-dioxyborolane (10.8 mL, 53 mmol) was added to the mixture at −78° C. The resultant mixture was stirred at 25° C. for 24 hours, after slowly raising the temperature. The reaction mixture was extracted with dichloromethane (200 mL), and the extract was washed with distilled water (200 mL), dried over magnesium sulfate and distilled under reduced pressure. The solid obtained was washed with methanol (200 mL) and n-hexane (200 mL) to provide Compound (120) (5.9 g, 9 mmol).

Compound (120) (3.0 g, 4.5 mmol), Compound (202) (3.8 g, 11.4 mmol), tetrakis(triphenylphosphine)palladium (Pd(PPh₃)₄) (0.5 g, 0.5 mmol), aqueous 1.0 M potassium carbonate solution (22 mL), Aliquat 336 (0.5 mL, 0.9 mmol) and toluene (60 mL) were mixed together, and the mixture was stirred at 100° C. for 6 hours and cooled to 25° C. The organic layer was extracted with dichloromethane (200 mL), and the extract was washed with distilled water (200 mL). Drying over magnesium sulfate and distillation under reduced pressure gave solid, which was then recrystallized from acetone (50 mL), ethyl acetate (50 mL) and tetrahydrofuran (20 mL) to obtain Compound (324) (1.5 g, 1.6 mmol, yield: 36%).

¹H NMR (200 MHz, CDCl₃): δ=2.35 (s, 3H), 6.92-6.94 (d, 4H), 7.07-7.14 (m, 5H), 7.21-7.23 (m, 2H), 7.30-7.36 (m, 12H), 7.46-7.49 (m, 4H), 7.53-7.55 (m, 4H), 7.59-7.61 (m, 2H), 7.65-7.69 (m, 8H), 7.77 (d, 2H), 7.90-7.92 (d, 2H)

MS/FAB: 913.2 (found), 913.15 (calculated).

### Synthetic Example 25

### Synthesis of Compound (325)

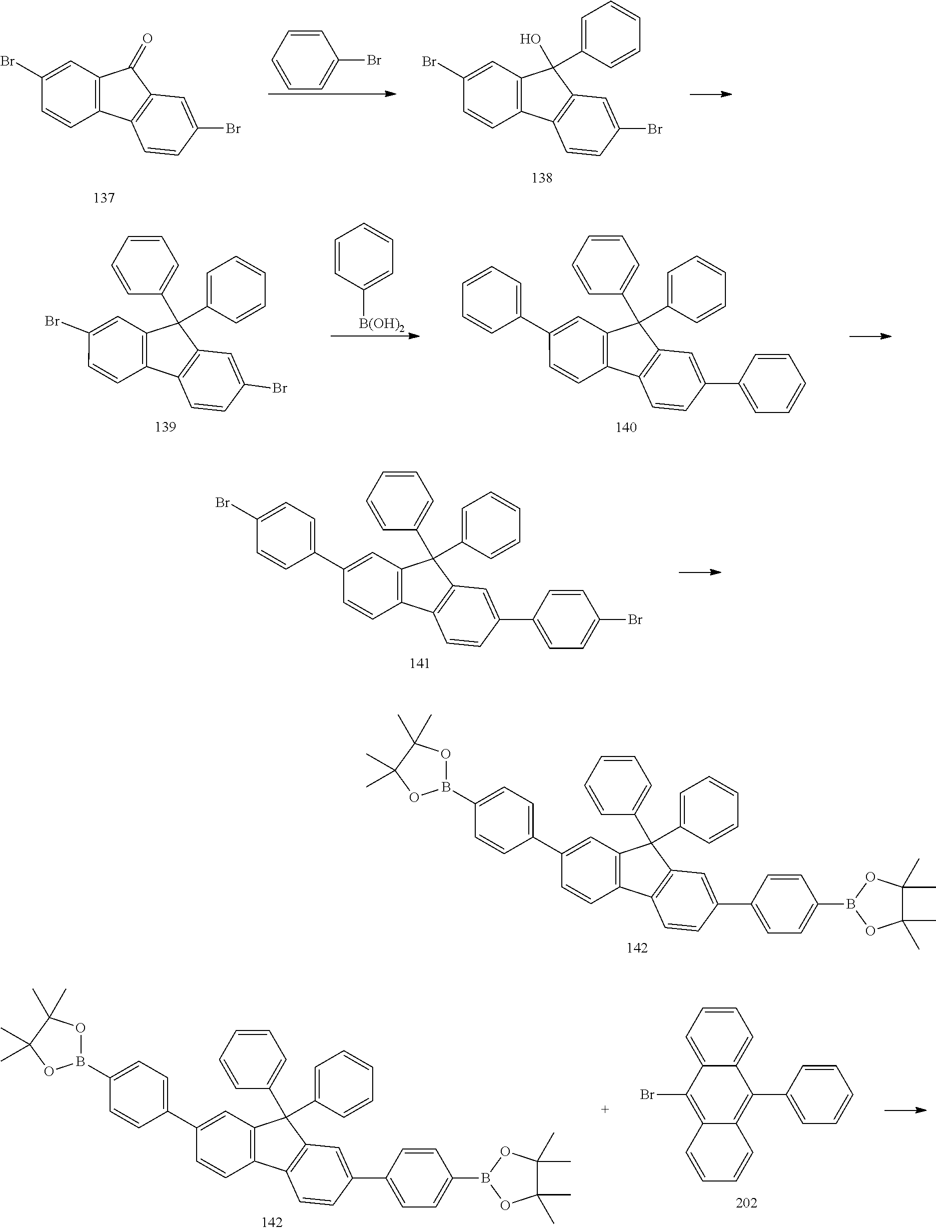

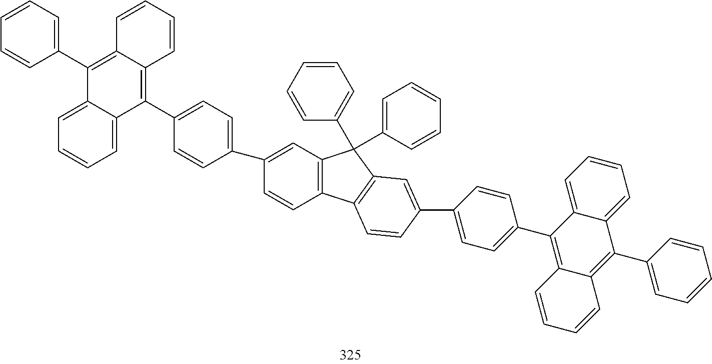

Diethyl ether (50 mL) was added to magnesium (4.9 g, 200 mmol), and bromobenzene (31.4 g, 200 mmol) diluted in diethyl ether (150 mL) was slowly added dropwise thereto, and the mixture was stirred under reflux for 3 hours. In diethyl ether (40 mL), dissolved was 2,7-dibromofluorenone (33.8 g, 100 mmol), and the solution was added dropwise to the reaction mixture previously prepared. The resultant mixture was stirred under reflux for 12 hours. The precipitate produced was filtered to obtain Compound (138) (15 g, 36 mmol), which was then dissolved in benzene (145 mL). While heating the solution, trifluoromethanesulfonic acid (6.6 mL, 72 mmol) was slowly added dropwise thereto. After 30 minutes, the reaction mixture was added to cold saturated aqueous sodium carbonate solution (400 mL). The organic layer was extracted with ethyl acetate (800 mL), washed with distilled water (600 mL), dried over magnesium sulfate, and distilled under reduced pressure to obtain Compound (139) (18.3 g, 38.5 mmol).

A vessel was charged with Compound (139) (27.6 g, 58 mmol), phenylboronic acid (21.2 g, 174 mmol), PdCl₂(PPh₃)₂ (4.1 g, 5.8 mmol), aqueous 2 M sodium carbonate solution (300 mL), toluene (500 mL) and ethanol (200 mL), and the mixture was stirred at 100° C. for 12 hours. The reaction mixture was worked up according to the same procedure for synthesis of Compound (134) to obtain Compound (140) (15.5 g, 32 mmol).

Compound (140) (5.6 g, 12 mmol) was dissolved in dichloromethane (60 mL), and solution of bromine (1.42 mL, 27 mmol) dissolved in dichloromethane (15 mL) was slowly added thereto at −5° C. The mixture was stirred at 0° C. for 2 hours, and then at 25° C. for 12 hours. After neutralization by using aqueous potassium hydroxide (KOH) solution (70 mL), the mixture was extracted with dichloromethane (700 mL). The extract was dried over magnesium sulfate and distilled under reduced pressure. Washing the residual solid with methanol) (300 mL) and n-hexane (300 mL), and purification via silica column chromatography (n-hexane: dichloromethane=8:1) gave Compound (141) (6.3 g, 10 mmol).

Compound (141) (12.4 g, 19.8 mmol) was dissolved in tetrahydrofuran (100 mL), and n-BuLi (1.6 M in hexane) (32.3 mL, 51.6 mmol) was slowly added thereto at −78° C. After stirring for 30 minutes, 2-isopropoxy-4,4,5,5-tetramethyl-1,3,2-dioxyborolane (12.2 mL, 59 mmol) was added to the mixture at −78° C. The resultant mixture was stirred at ambient temperature for one day, after slowly raising the temperature.

The reaction mixture was extracted with dichloromethane (1500 mL), and the extract was washed with distilled water (500 mL), dried over magnesium sulfate and distilled under reduced pressure. The solid obtained was washed with methanol (500 mL) and n-hexane (500 mL) to provide Compound (142) (7.2 g, 10 mmol).

Compound (142) (3.7 g, 5.2 mmol), Compound (202) (5.2 g, 15.5 mmol), tetrakis(triphenylphosphine)palladium (Pd(PPh₃)₄) (0.6 g, 0.5 mmol), aqueous 1.0 M potassium carbonate solution (26 mL), Aliquat 336 (0.6 mL, 1.0 mmol) and toluene (80 mL) were mixed together, and the mixture was stirred at 100° C. for 4 hours and cooled to ambient temperature. The reaction mixture was extracted with dichloromethane (700 mL), and the extract was washed with distilled water (500 mL). Drying over) magnesium sulfate and distillation under reduced pressure gave solid, which was then recrystallized from acetone (100 mL), ethyl acetate (50 mL) and tetrahydrofuran (30 mL) to obtain Compound (325) (2.7 g, 2.8 mmol, yield: 54%).

¹H NMR (CDCl₃, 200 MHz): δ=7.04-7.08 (m, 6H), 7.15 (t, 4H), 7.20 (t, 2H), 7.30 (t, 12H), 7.45-7.55 (m, 12H), 7.60-7.69 (m, 10H), 7.79 (d, 2H), 7.89 (d, 2H)

MS/FAB: 974.39 (found), 975.22 (calculated).

### Synthetic Example 26

### Synthesis of Compound (326)

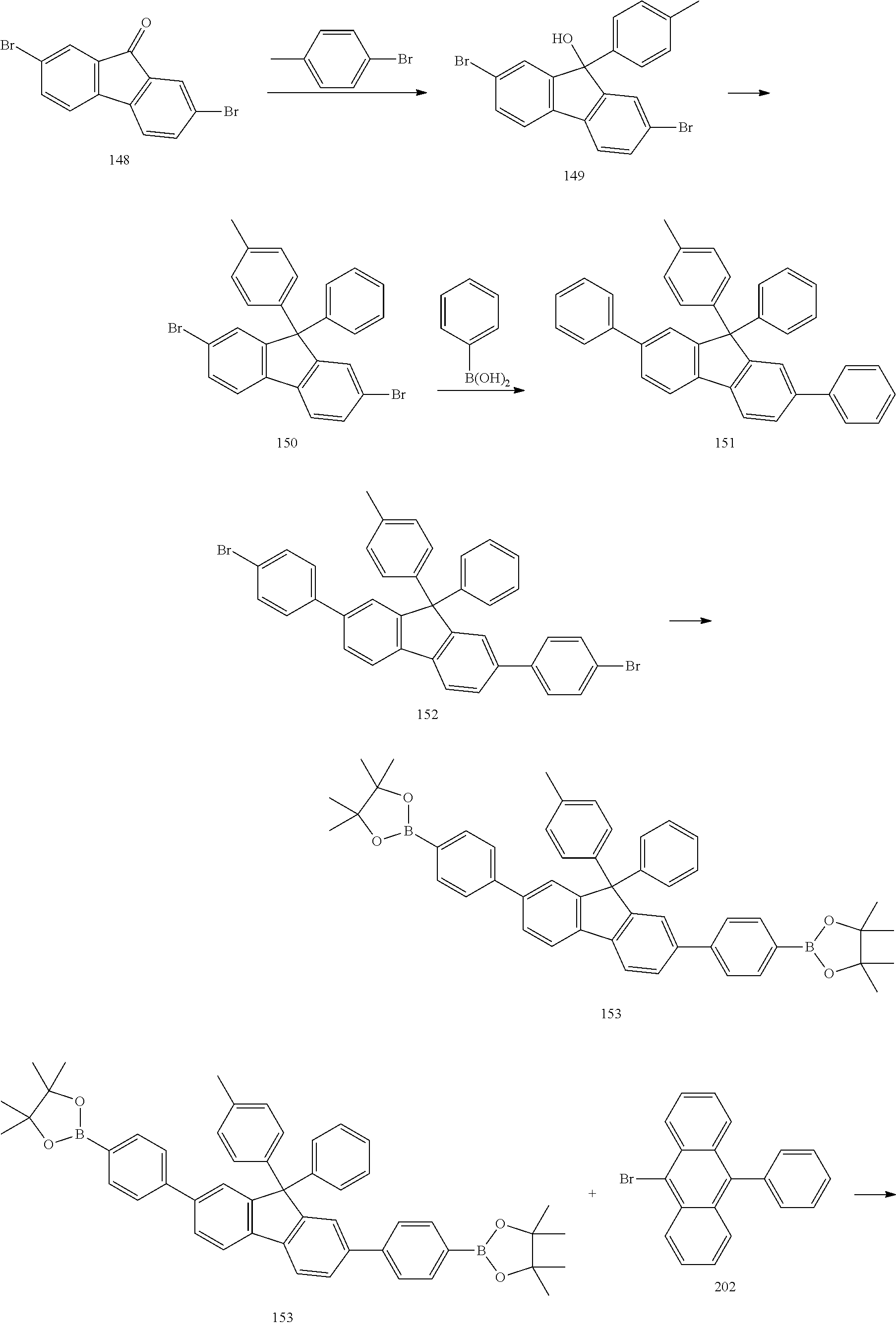

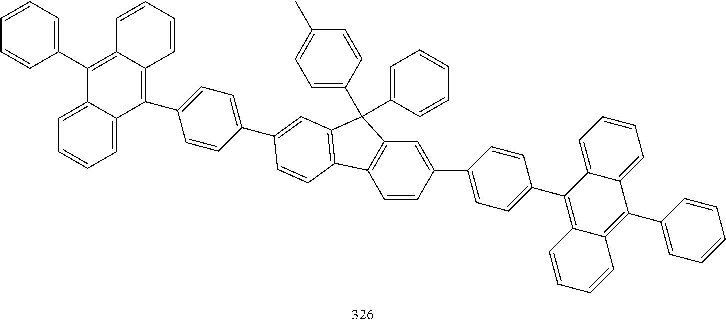

Diethyl ether (50 mL) was added to magnesium (4.9 g, 200 mmol), and 1-bromo-4-methylbenzene (34.2 g, 200 mmol) diluted in diethyl ether (150 mL) was slowly added dropwise thereto, and the mixture was stirred under reflux for 3 hours. In diethyl ether (40 mL), dissolved was 2,7-dibromofluorenone (33.8 g, 100 mmol), and the solution was added dropwise to the reaction mixture previously prepared. The resultant mixture was stirred under reflux for 12 hours. The precipitate produced was filtered to obtain Compound (149) (15 g, 35 mmol), which was then dissolved in toluene (145 mL). While heating the solution, trifluoromethanesulfonic acid (6.6 mL, 72 mmol) was slowly added dropwise thereto. After 30 minutes, the reaction mixture was added to cold saturated aqueous sodium carbonate solution (400 mL). The organic layer was extracted with ethyl acetate (700 mL), and the extract was washed with distilled water (500 mL), dried over magnesium sulfate, and distilled under reduced pressure to obtain Compound (150) (14.5 g, 30.6 mmol).

A vessel was charged with Compound (150) (23.0 g, 47 mmol), phenylboronic acid (10.6 g, 87 mmol), PdCl₂(PPh₃)₂ (4.11 g, 5.8 mmol), aqueous 2 M sodium carbonate solution (15 mL), toluene (300 mL) and ethanol (100 mL), and the mixture was stirred at 100° C. for 12 hours. The reaction mixture was worked up according to the same procedure for synthesis of Compound (102) to obtain Compound (151) (17.5 g, 36 mmol).

Compound (151) (11.6 g, 24 mmol) was dissolved in dichloromethane (80 mL), and solution of bromine (2.76 mL, 53 mmol) dissolved in dichloromethane (25 mL) was slowly added thereto at −5° C. The mixture was stirred at 0° C. for 2 hours, and then at 25° C. for 12 hours. After neutralization by using aqueous potassium hydroxide (KOH) solution, the mixture was extracted with dichloromethane (800 mL). The extract was dried over magnesium sulfate and distilled under reduced pressure,

Washing the residual solid with methanol (100 mL) and n-hexane (100 mL), and purification via silica gel column chromatography (n-hexane: dichloromethane=7:1) gave Compound (152) (12.4 g, 19 mmol).

Compound (152) (11 g, 17 mmol) was dissolved in tetrahydrofuran (100 mL), and n-BuLi (1.6 M in hexane) (27.6 mL, 44 mmol) was slowly added thereto at −78° C. After stirring for 30 minutes, 2-isopropoxy-4,4,5,5-tetramethyl-1,3,2-dioxyborolane (10.8 mL, 53 mmol) was added to the mixture at −78° C. The resultant mixture was stirred at ambient temperature for one day, after slowly raising the temperature. The reaction mixture was extracted with dichloromethane (1000 mL), and the extract was washed with distilled water (500 mL), dried over magnesium sulfate and distilled under reduced pressure. The solid obtained was washed with methanol (300 mL) and n-hexane (200 mL) to provide Compound (153) (5.9 g, 8 mmol).

Compound (153) (3.3 g, 4.5 mmol), Compound (202) (3.8 g, 11.4 mmol), tetrakis(triphenylphosphine)palladium (Pd(PPh₃)₄) (0.5 g, 0.5 mmol), aqueous 1.0 M potassium carbonate solution (22 mL), Aliquat 336 (0.5 mL, 0.9 mmol) and toluene (60 mL) were stirred at 100° C. for 6 hours and cooled to ambient temperature. The organic layer was extracted with dichloromethane (800 mL), and the extract was washed with distilled water (400 mL). Drying over magnesium sulfate and distillation under reduced pressure gave solid, which was then recrystallized from acetone (100 mL), ethyl acetate (100 mL) and tetrahydrofuran (50 mL) to obtain Compound (326) (1.5 g, 1.5 mmol, yield: 33%).

¹H NMR (CDCl₃, 200 MHz): δ=7.15-7.19 (m, 4H), 7.21 (d 2H), 7.32-7.36 (m, 14H), 7.48-7.56 (m, 12H), 7.60-7.68 (m, 10H), 7.72-7.78 (m, 4H), 7.90 (d, 2H)

MS/FAB: 972.38 (found), 973.21 (calculated).

### Example 1

### Manufacture of an OLED Using the Compound According to the Invention

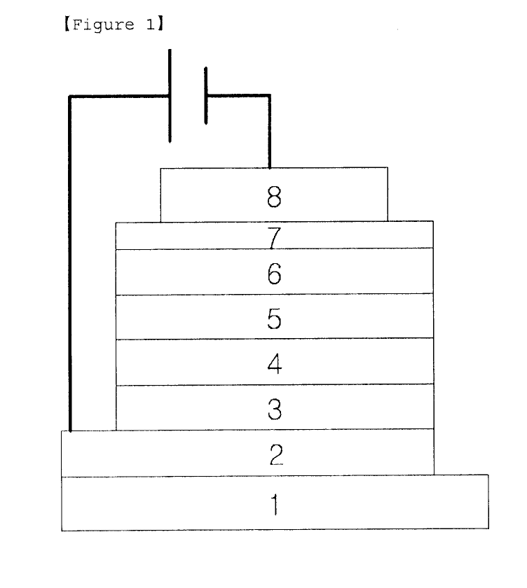

An OLED was manufactured as illustrated in FIG. 1 by using an EL material according to the invention as host material.

First, a transparent electrode ITO thin film (2) (15Ω/58 ) obtained from glass (1) for OLED was subjected to ultrasonic washing with trichloroethylene, acetone, ethanol and distilled) water, subsequently, and stored in isopronanol before use.

Then, an ITO substrate was equipped in a substrate folder of a vacuum vapor-deposition device, and 4,4′,4″-tris(N,N-(2-naphthyl)-phenylamino)triphenylamine (2-TNATA, having the structure shown below) was placed in a cell of the vacuum vapor-deposition device, which was then vented to reach 10⁻⁶ torr of vacuum in the chamber. Electric current was applied to the cell to evaporate 2-TNATA to vapor-deposit a hole injection layer (3) with 60 nm of thickness on the ITO substrate.

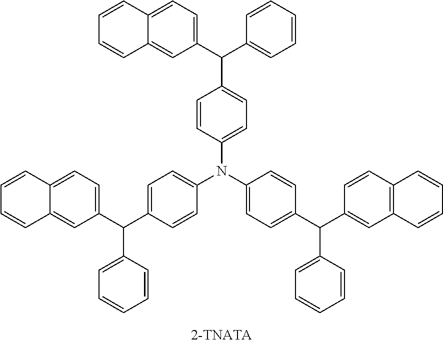

Then, another cell of the vacuum vapor-deposition device was charged with N,N′-bis(α-naphthyl)-N,N′-diphenyl-4,4′-diamine (NPB) (having the structure shown below), and electric current was applied to the cell to evaporate NPB to vapor-deposit a hole transportation layer (4) with 20 nm of thickness on the hole injection layer.

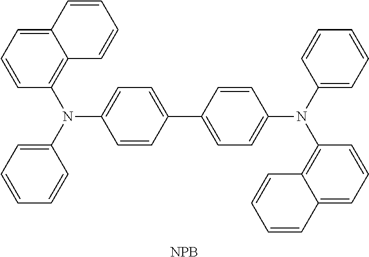

After formation of the hole injection layer and hole transportation layer, an EL layer (5) was vapor-deposited as follows. One cell of the vacuum deposition device was charged with a compound according to the invention (e.g. Compound 325) as an EL material, while another cell of said device was charged with perylene having the structure shown below, respectively. With the vapor-deposition rate of 100:1, an EL layer was vapor-deposited with a thickness of 30 nm on the hole transportation layer.

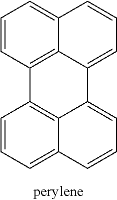

Then, tris(8-hydroxyquinoline)-aluminum (III) (Alq) (having the structure shown below) was vapor-deposited with a thickness of 20 nm, as an electron transportation layer (6), followed by lithium quinolate (Liq) with a thickness of from 1 to 2 nm as an electron injection layer (7). Thereafter, an Al cathode (8) was vapor-deposited with a thickness of 150 nm by using another vacuum vapor-deposition device to manufacture an OLED.

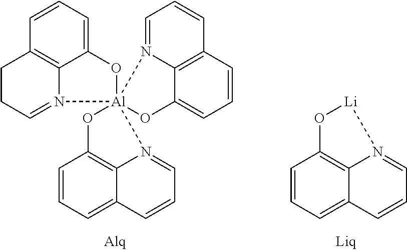

Individual EL materials used for the OLED devices were purified by vacuum sublimation under 10⁻⁶ torr.

### Comparative Example 1

### Manufacture of an OLED Using Conventional EL Material

A hole injection layer (3) and hole transportation layer (4) were formed according to the same procedure as described in Example 1, and dinaphthylanthracene (DNA) as a blue electroluminescent material was charged in one cell of said vapor-deposition device, while perylene in another cell as another blue electroluminescent material. Then, an electroluminescent layer with 30 nm thickness was vapor-deposited on said hole transportation layer with vapor-deposition rate of 100:1.

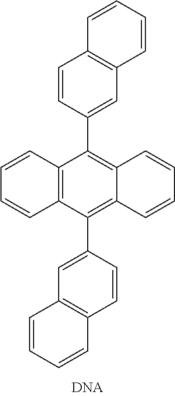

Then, an electron transportation layer (6) and an electron injection layer (7) were vapor-deposited according to the same procedure as described in Example 1, and an Al cathode (8) was vapor-deposited by using another vacuum vapor-deposition device with a thickness of 150 nm, to manufacture an OLED.

### Example 2

### Electroluminescent Properties of the OLED Manufactured

Electroluminescent efficiencies of OLED's comprising the organic electroluminescent compound according to the invention prepared from Example 1 and the conventional electroluminescent compound prepared from Comparative Example 1 were measured at 500 cd/m² and 2,000 cd/m², respectively, of which the results are shown in Table 1. Since the luminescent properties in the range of low luminance and those applied on a panel are very important in case of a blue electroluminescent material, in particular, the data of luminance of about 2,000 cd/m² was established as the standard in order to reflect those properties.

TABLE 1

| | | | | Luminous | | | | |
|---|---|---|---|---|---|---|---|---|
| | | | | efficiency | | Color | | |
| | EL | EL | EL peak | (cd/A) | | coordinate | | Luminous |
| No. | Material 1 | Material 2 | (nm) | @500 cd/m² | @2,000 cd/m² | X | Y | efficiency/Y |
| 1 | 301 | Perylene | 456,484 | 4.8 | 3.9 | 0.161 | 0.198 | 24.2 |
| 2 | 302 | Perylene | 455,484 | 4.7 | 3.4 | 0.160 | 0.195 | 24.1 |
| 4 | 306 | Perylene | 458,484 | 4.9 | 5.0 | 0.165 | 0.210 | 23.3 |
| 5 | 307 | Perylene | 455,483 | 4.7 | 4.5 | 0.158 | 0.190 | 24.7 |
| 6 | 309 | Perylene | 450,481 | 3.9 | 3.5 | 0.154 | 0.168 | 23.2 |
| 7 | 310 | Perylene | 457,482 | 4.9 | 4.3 | 0.158 | 0.203 | 23.6 |
| 8 | 311 | Perylene | 456,484 | 4.7 | 4.2 | 0.159 | 0.200 | 23.5 |
| 9 | 313 | Perylene | 458,484 | 5.0 | 4.4 | 0.158 | 0.208 | 24.0 |
| 10 | 314 | Perylene | 456,484 | 5.0 | 4.2 | 0.155 | 0.190 | 26.3 |
| 11 | 315 | Perylene | 458,482 | 4.8 | 4.2 | 0.155 | 0.205 | 23.4 |
| 12 | 316 | Perylene | 459,482 | 5.3 | 4.6 | 0.158 | 0.207 | 25.6 |
| 13 | 318 | Perylene | 448,476 | 3.4 | 2.8 | 0.149 | 0.159 | 21.4 |
| 14 | 319 | Perylene | 452,483 | 3.3 | 2.9 | 0.155 | 0.173 | 18.5 |
| 15 | 320 | Perylene | 452,482 | 3.0 | 2.8 | 0.153 | 0.172 | 17.4 |
| 16 | 322 | Perylene | 456,482 | 4.7 | 4.2 | 0.156 | 0.186 | 25.3 |
| 17 | 323 | Perylene | 456,484 | 5.1 | 4.9 | 0.163 | 0.196 | 26.0 |
| 18 | 324 | Perylene | 456,485 | 5.3 | 5.2 | 0.159 | 0.191 | 27.7 |
| 19 | 325 | Perylene | 456,482 | 5.2 | 5.3 | 0.159 | 0.188 | 27.6 |
| 20 | 326 | Perylene | 454,482 | 5.5 | 5.1 | 0.158 | 0.179 | 30.7 |
| Comp. 1 | DNA | Perylene | 456,484 | 4.4 | 3.6 | 0.160 | 0.200 | 22.3 |

As can be seen from Table 1, the OLED device employing the organic electroluminescent compounds according to the invention as the electroluminescent material was compared to the OLED device of Comparative Example which employs widely known DNA:perylene as a conventional electroluminescent material, on the basis of “luminous efficiency/Y” value which shows similar tendency to quantum efficiency. As the result, the OLED device employing the organic electroluminescent compound according to the present invention showed higher “luminous efficiency/Y” value than that of Comparative Example.

With the fact that the organic EL compounds according to the invention exhibit higher “luminous efficiency/Y” value, it is found that the organic EL compounds of the invention is a material of high quantum efficiency. In addition, it is found that the organic EL compounds according to the invention is able to realize higher efficiency while they have better color coordinate than conventional EL compounds.

On the basis of the results described above and the fact that conventional EL compounds containing a fluorene or indenofluorene structure disclosed by U.S. Pat. No. 6,479,172 showed luminous efficiency of 350˜414 cd/m² at 25 mA/cm², it is found that the luminous efficiency of the compounds according to the invention has been enhanced by incorporating anthracenyl group or an aryl group with anthracenyl substituent to the aryl ring of fluorene or indenofluorene. It is also confirmed that the compounds show superior property closer to pure blue from the aspect of the luminescent color. Further, Table 1 shows that the compounds of the invention provide less lowering of the efficiency at high current density.

Thus, the organic EL compounds according to the present invention can be employed as a high efficient blue EL material, including prominent advantages in terms of luminance and power consumption as compared to conventional full-colored OLED's.

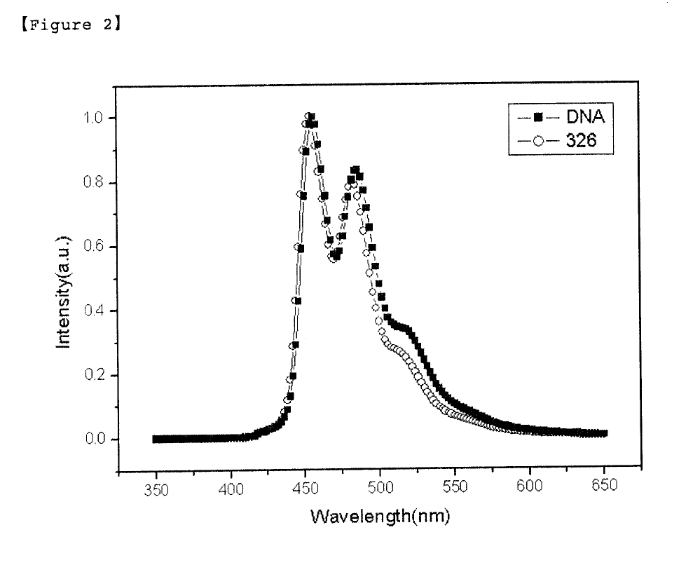

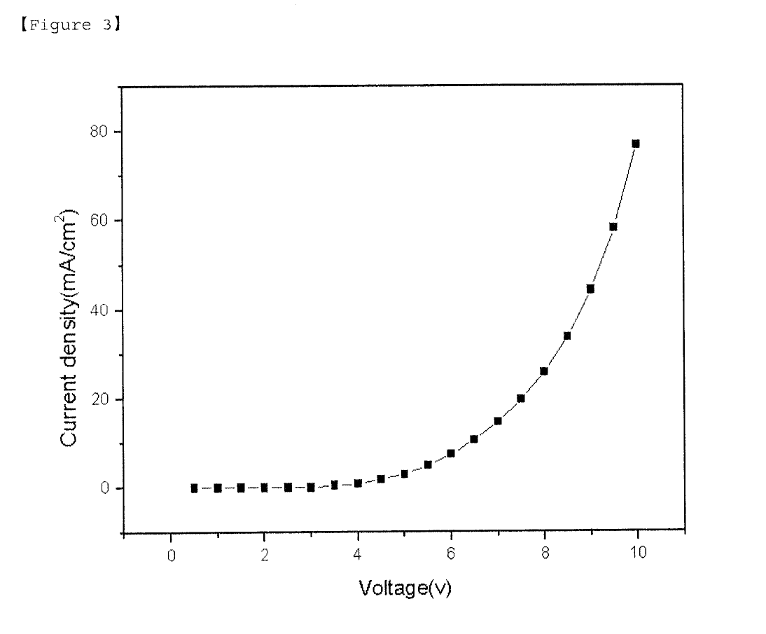

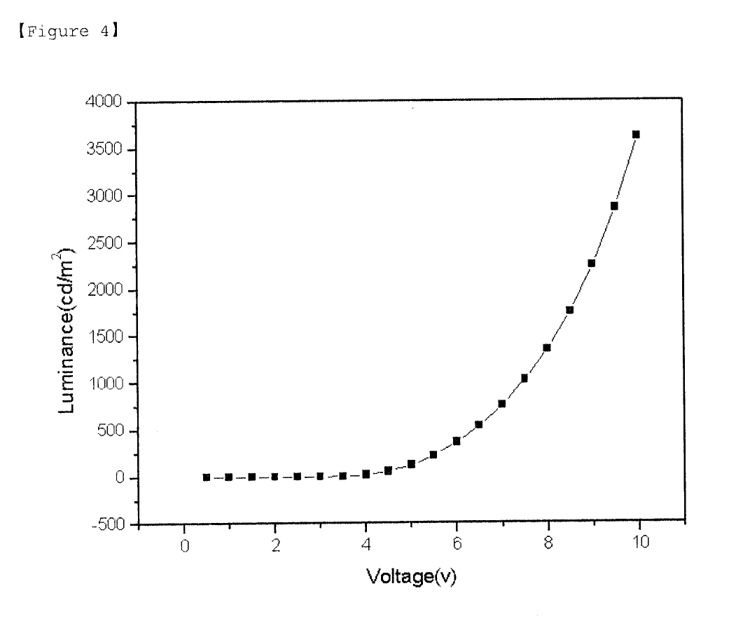

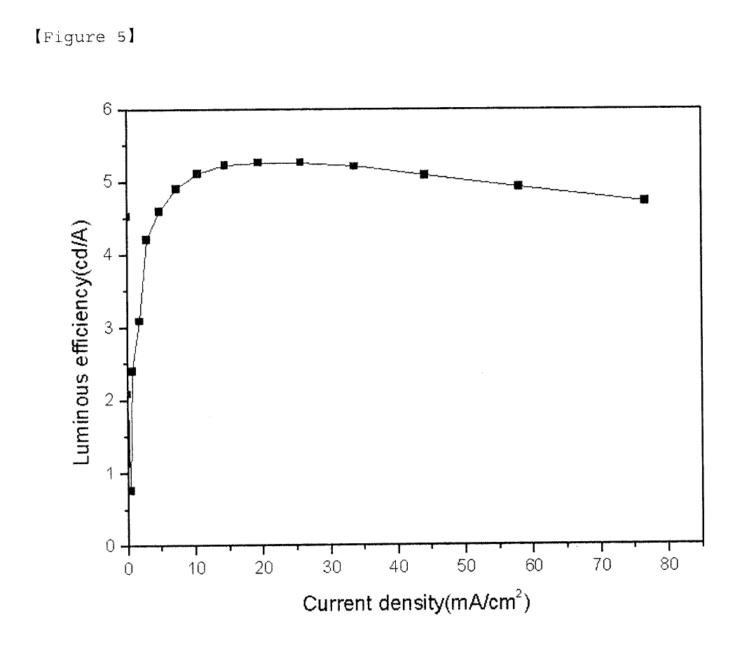

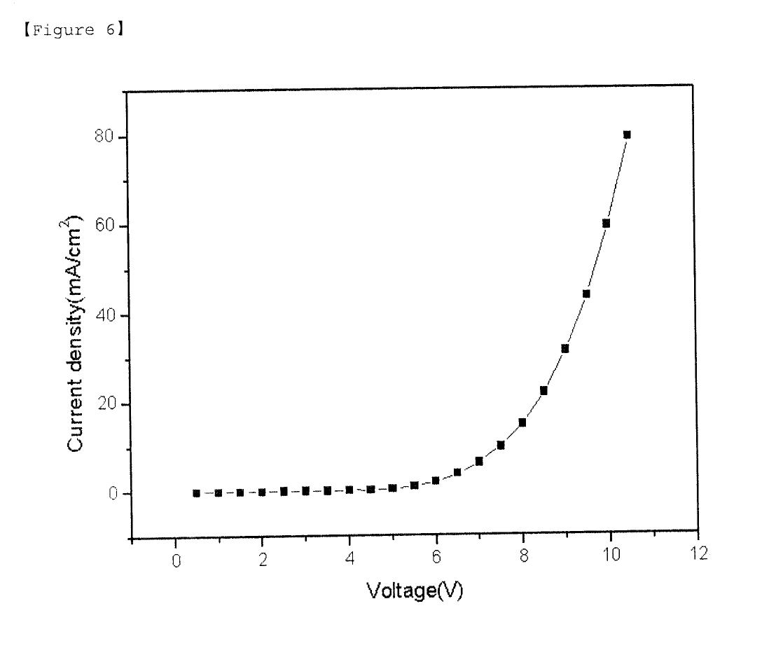

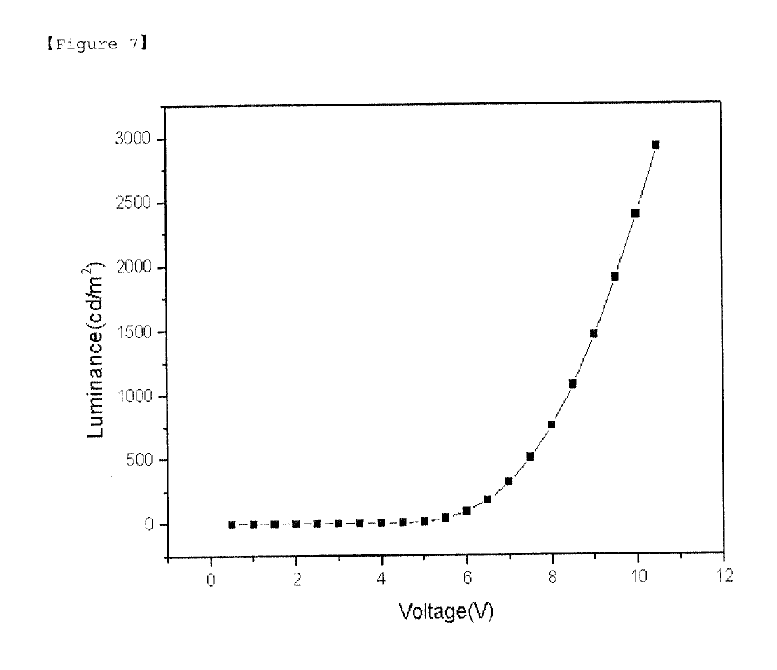

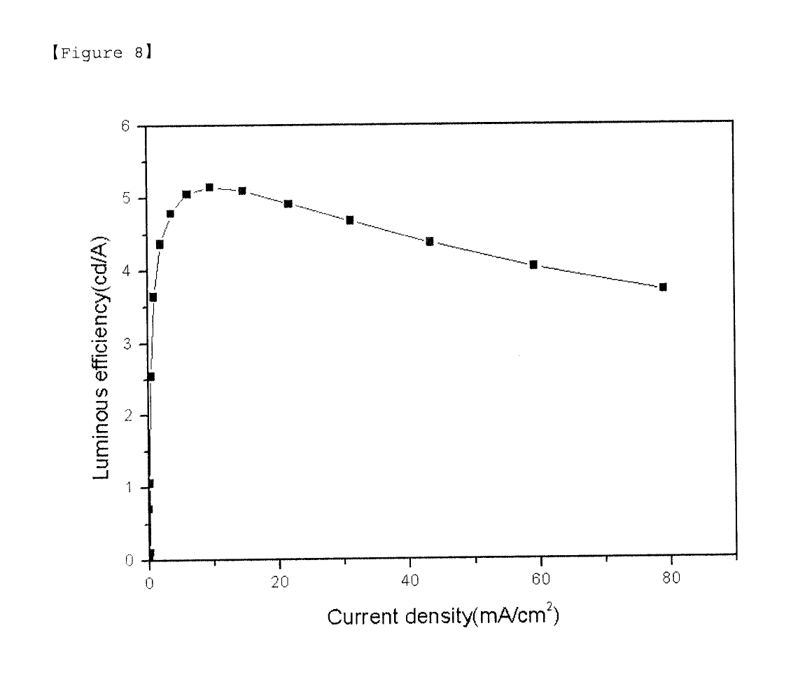

FIG. 2 illustrates EL spectrums of the EL material (326) according to the invention and that of Comparative Example 1; FIGS. 3 to 5 show current density-voltage property, luminance-voltage property, and luminous efficiency-current density property of an OLED comprising the EL material (326) according to the invention; FIGS. 6 to 8 show current density-voltage property, luminance-voltage property, and luminous efficiency-current density property of an OLED comprising the EL material (314) according to the invention.

### INDUSTRIAL APPLICABILITY

The organic EL compounds according to the invention provide good luminous efficiency and excellent life property, and thus enable to manufacture OLED devices with very good operation lifetime.

1. An organic electroluminescent compound represented by Chemical Formula (1); 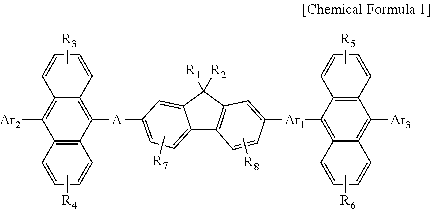
wherein, Ar₁ represents phenylene or naphthylene, Ar₂ and Ar₃ independently represent an aryl group; A represents a chemical bond or arylene; R₁ and R₂ independently represent hydrogen, C₁₋₂₀ alkyl, or an aryl; or R₁ and R₂ may form a spiro-ring by being connected as C₄₋₆ alkylene or C₄₋₆ alkylene having an aryl group fused; R₃ through R₈ independently represent hydrogen, C₁₋₂₀ alkyl, C₁₋₂₀ alkoxy, aryl, halogen, C₁₋₂₀ alkylsilyl or dicyanoethylene group; and said Ar₁ through Ar₃, A, or R₁ through R₈ may be further substituted by one or more group selected from C₁₋₂₀ alkyl, aryl and halogen.

2. An organic electroluminescent compound according to claim 1, wherein Ar₁ is 1,4-phenylene, 1,4-naphthylene or 1,5-naphthylene.

3. An organic electroluminescent compound according to claim 1, wherein A is a chemical bond, 1,4-phenylene, 1,4-naphthylene or 1,5-naphthylene.

4. An organic electroluminescent compound according to claim 1, wherein Ar₂ and Ar₃ independently represent phenyl, tolyl, biphenyl, halophenyl, naphthyl, methylnaphthyl or anthryl.

5. An organic electroluminescent compound according to claim 1, wherein R₁ and R₂ independently represent hydrogen, methyl, ethyl, i-propyl or t-butyl.

6. An organic electroluminescent compound according to claim 1, wherein R₁ and R₂ independently represent phenyl, tolyl, biphenyl, halophenyl or naphthyl.

7. An organic electroluminescent compound according to claim 1, which is selected from the compounds represented by one of the following Chemical Formulas:

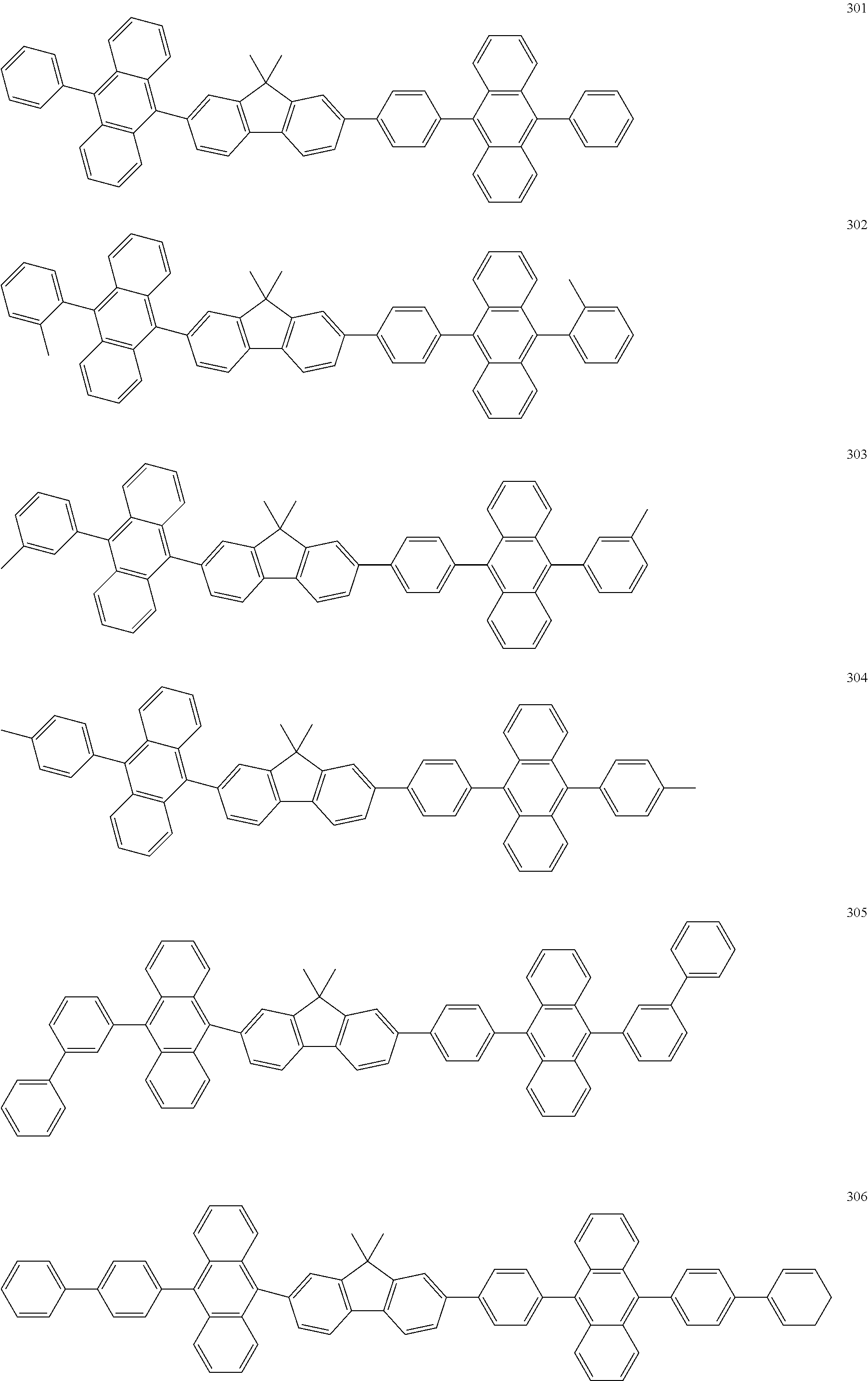

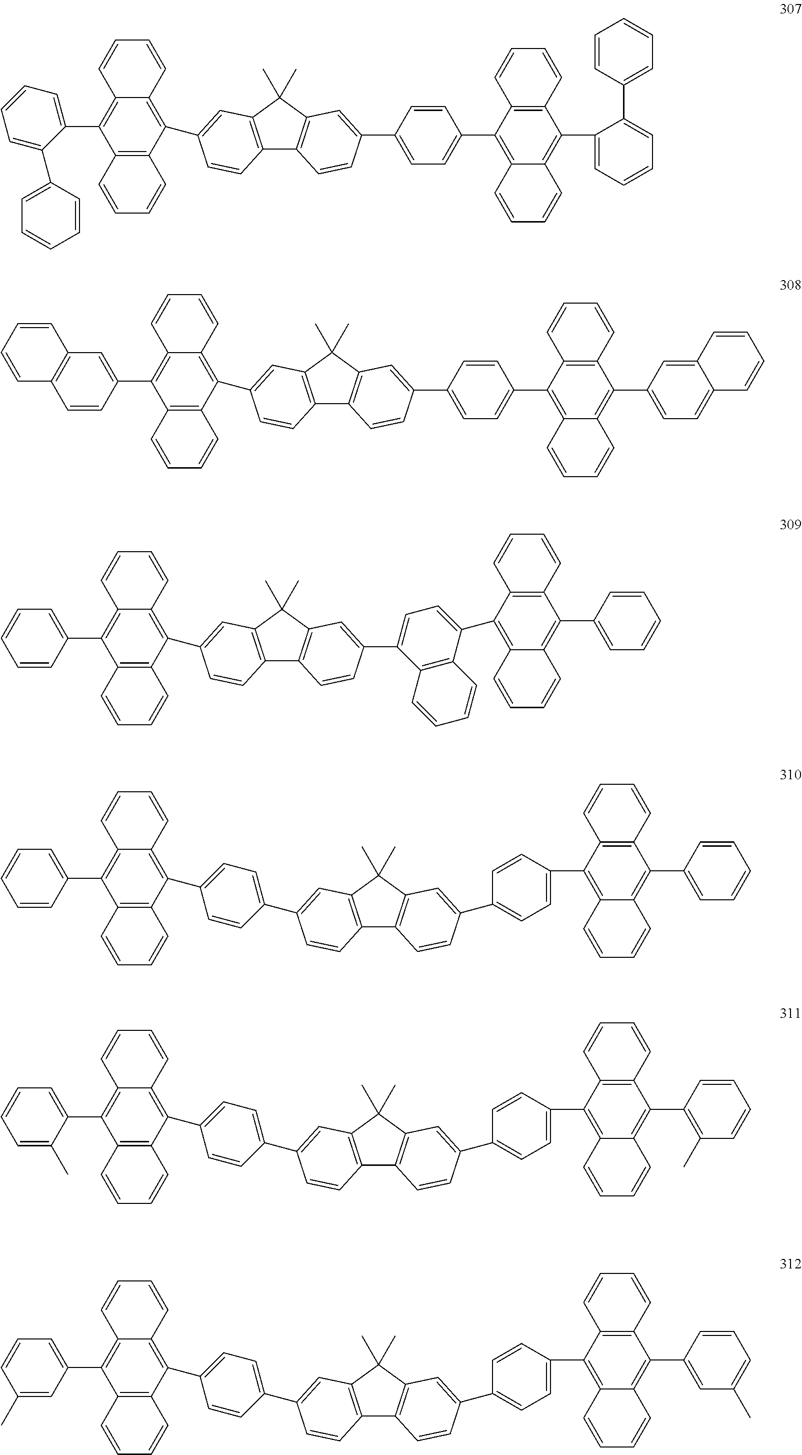

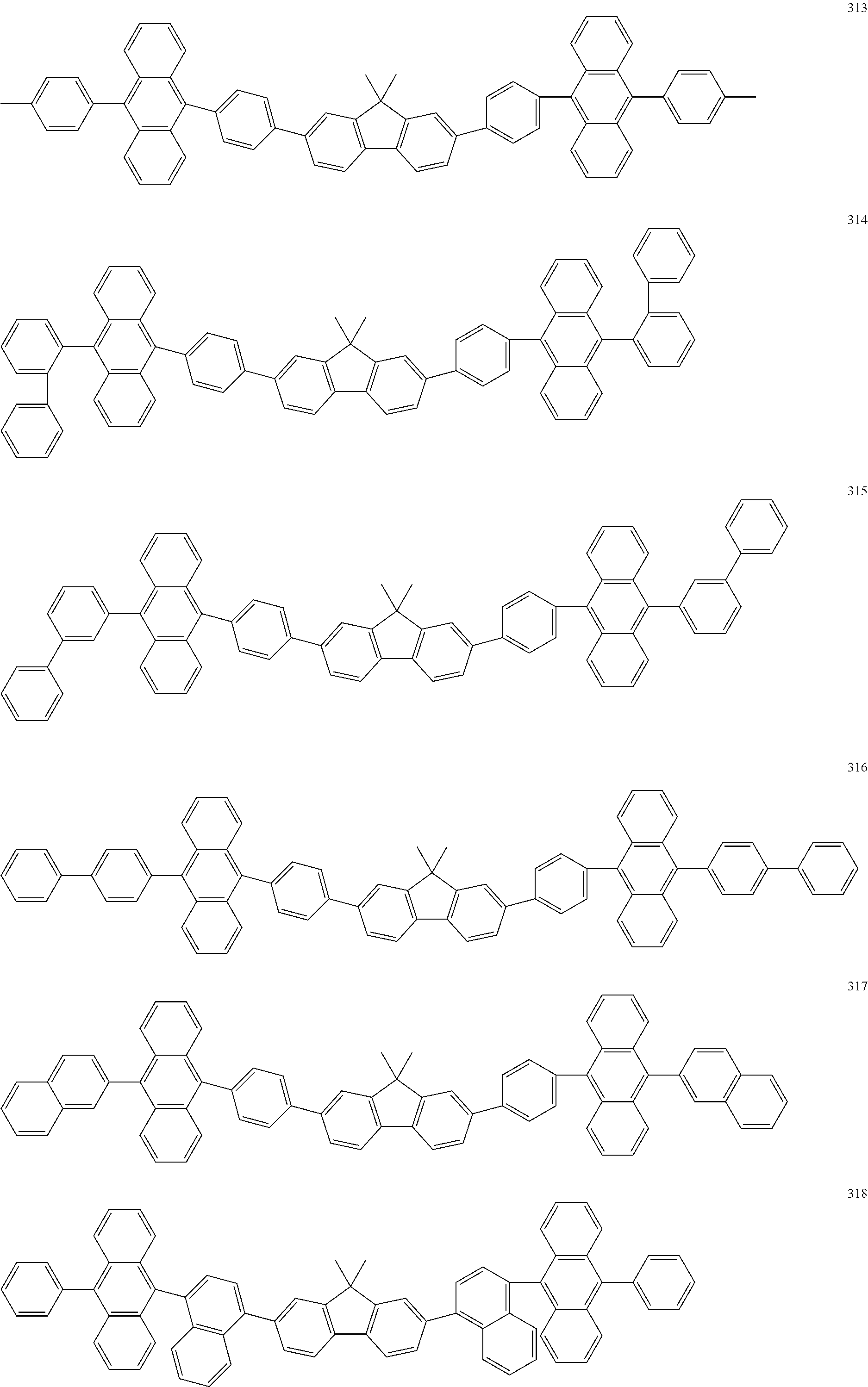

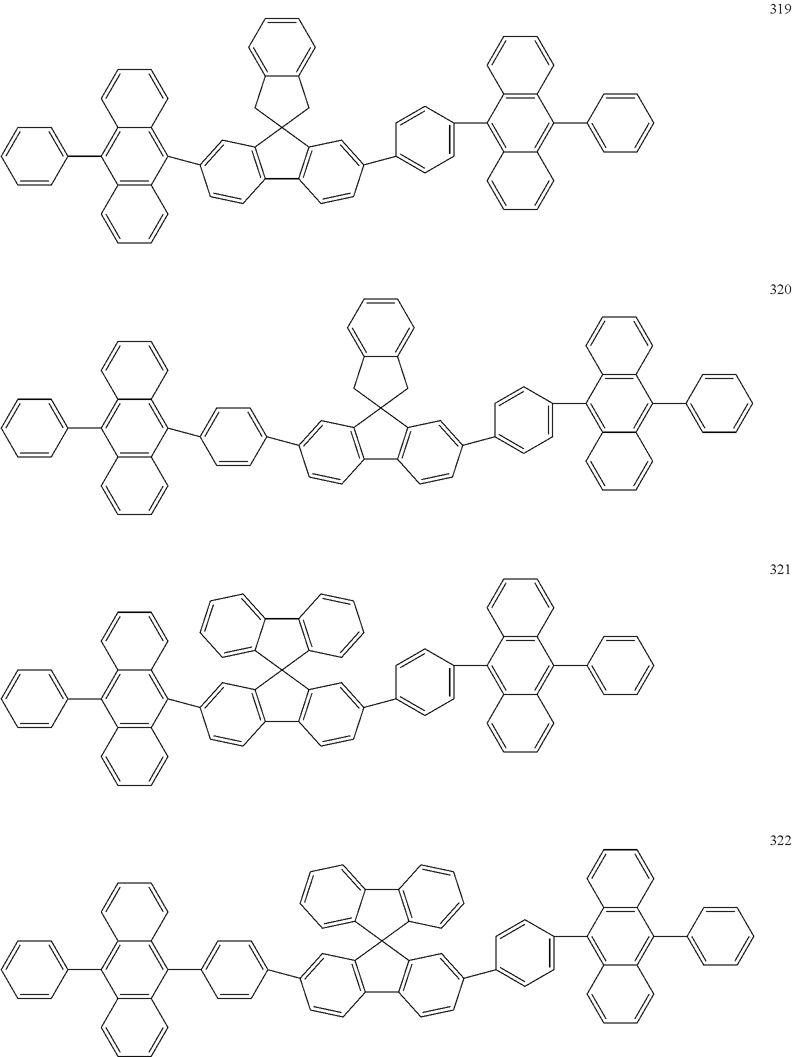

8. An organic electroluminescent compound according to claim 6, which is selected from the compounds represented by one of the following Chemical Formulas:

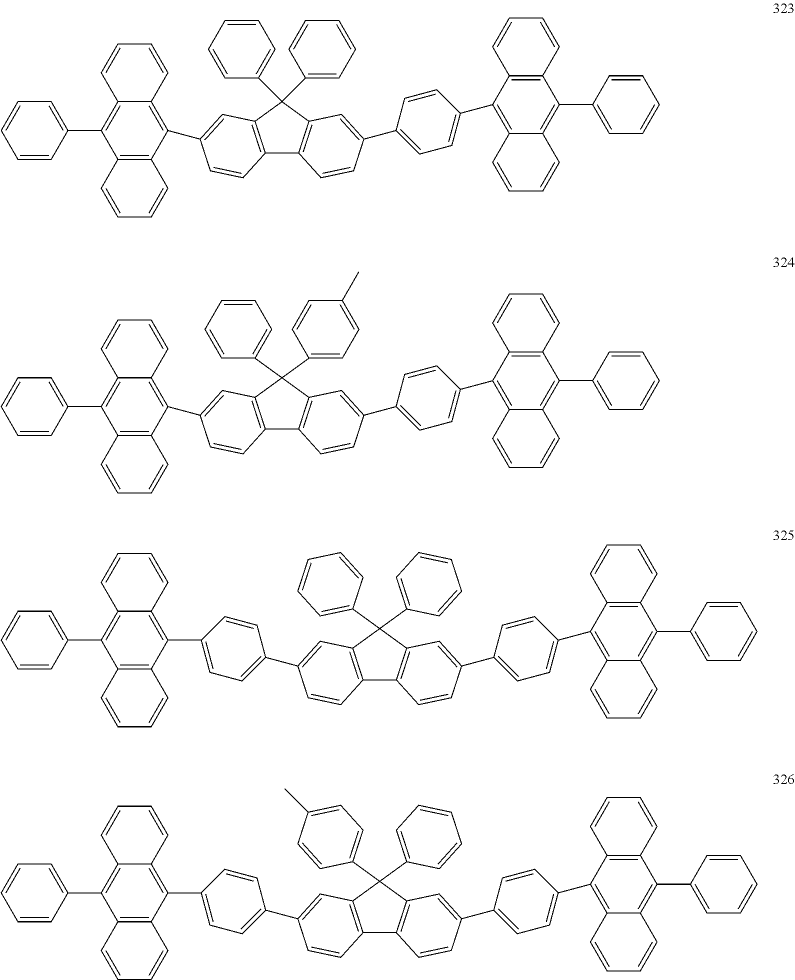

9. An electroluminescent device which comprises an organic electroluminescent compound according to any one of claims 1 to 8.
